(19) United States
(12) Patent Application Publication
(10) Pub. No.: US 2024/0424923 A1
(43) Pub. Date: Dec. 26, 2024

(54) Charging dock for a towing vehicle

(71) Applicant: ELECTRANS TECHNOLOGIES LTD., Oakville (CA)

(72) Inventors: Brian Layfield, Oakville (CA); Brian Fan, Oakville (CA); Mitchell Phillips, Oakville (CA); Andrew Constantinescu, Oakville (CA); Anthony Ighomuaye, Oakville (CA); Abhinav Dhar, Oakville (CA)

(21) Appl. No.: 18/696,183

(22) PCT Filed: Sep. 27, 2022
(86) PCT No.: PCT/CA2022/051429

§ 371 Date: Mar. 27, 2024

Related U.S. Application Data
(60) Provisional application No. 63/248,807, filed on Sep. 27, 2021.

(51) Int. Cl. B60L 53/16; B60D 1/01; B60D 1/36; B60L 53/36

(52) U.S. Cl. CPC B60L 53/16; B60D 1/015; B60D 1/36; B60L 53/36; B60L 2200/36

(57) ABSTRACT

Disclosed herein is a charging dock for a towing vehicle. The towing vehicle includes a first adapter counterpart and the dock includes a second adapter counterpart. The towing vehicle includes a robot apparatus and the dock includes a guide. The robot apparatus and the guide are co-operatively configured to align the first and second adapter counterparts, such that the first and second adapter counterparts are connectible, in response to displacement of the first adapter counterpart towards the second adapter counterpart. The connection of the first adapter counterpart with the second adapter counterpart effectuates connection between the energy source of the dock and the energy storage device of the towing vehicle, such that energy is transferrable from the energy source to the energy storage device.

### FIELD

This disclosure relates generally to the road transportation industry. More specifically, the disclosure is directed at an automated connection between a towing vehicle and a charging dock.

### BACKGROUND

Towing vehicles require energy for operation. For example, a towing vehicle requires diesel fuel to operate the engine for driving the vehicle, electrical energy to operate the electrical components of the towing vehicle and a trailer that is being towed by the towing vehicle, hydrogen to operate a hydrogen drive system, natural gas to operate a natural gas motor, and pneumatic gas to operate the pneumatic components of the towing vehicle and the trailer that is being towed by the towing vehicle. The different types of energy are stored on the towing vehicle, for example, in a diesel fuel tank, battery, hydrogen storage tank, natural gas tank, and pneumatic gas tank. As the energy is used, the energy storage device in which the energy is stored has to be replenished. Currently, replenishment of the energy reservoir is done manually, wherein an operator of the towing vehicle exits the vehicle to connect the energy reservoirs on the towing vehicle to a corresponding energy source.

### SUMMARY

In one aspect, there is provided a towing vehicle, comprising: an energy storage device; a towing vehicle-defined connection counterpart; and wherein: the towing vehicle-defined connection counterpart is configured for connection to a dock-defined connection counterpart of a charging dock, the dock further comprising: a guide; and an energy source; the towing vehicle is co-operable with the dock such that: the connection of the towing vehicle-defined connection counterpart with the dock-defined connection counterpart effectuates connection between the energy source and the energy storage device, such that energy is transferrable from the energy source to the energy storage device; while: (i) the towing vehicle-defined connection counterpart and the dock-defined connection counterpart are co-operatively disposed in a misaligned relationship, wherein, in the misaligned relationship, there is an absence of alignment between the towing vehicle-defined connection counterpart and the dock-defined connection counterpart, and (ii) the towing vehicle-defined connection counterpart is disposed in a guiding-effective relationship with the guide: an alignment relationship-obtaining displacement of the towing vehicle-defined connection counterpart, relative to the dock-defined connection counterpart, is guidable, by the guide, wherein the guided displacement is effective for emplacing the towing vehicle-defined connection counterpart in alignment with the dock-defined connection counterpart, such that the towing vehicle-defined connection counterpart and the dock-defined connection counterpart become emplaced in an alignment relationship for establishing connection between the towing vehicle-defined connection counterpart and the dock-defined connection counterpart; in response to the emplacement of the towing vehicle-defined connection counterpart and the dock-defined connection counterpart in the alignment relationship, connection of the towing vehicle-defined connection counterpart and the dock-defined connection counterpart is effectuatable by displacement of the towing vehicle-defined connection counterpart, relative to the dock-defined connection counterpart, in a direction towards the dock-defined connection counterpart.

In another aspect, there is provided a charging dock comprising: a guide; a dock-defined connection counterpart; and an energy source; wherein: the dock-defined connection counterpart is configured for connection to a towing vehicle-defined connection counterpart of a towing vehicle, the towing vehicle further comprising: an energy storage device; the dock is co-operable with the towing vehicle such that: the connection of the towing vehicle-defined connection counterpart with the dock-defined connection counterpart effectuates connection between the energy source and the energy storage device, such that energy is transferrable from the energy source to the energy storage device; while: (i) the towing vehicle-defined connection counterpart and the dock-defined connection counterpart are co-operatively disposed in a misaligned relationship, wherein, in the misaligned relationship, there is an absence of alignment between the towing vehicle-defined connection counterpart and the dock-defined connection counterpart, and (ii) the towing vehicle-defined connection counterpart is disposed in a guiding-effective relationship with the guide: an alignment relationship-obtaining displacement of the towing vehicle-defined connection counterpart, relative to the dock-defined connection counterpart, is guidable, by the guide, wherein the guided displacement is effective for emplacing the towing vehicle-defined connection counterpart in alignment with the dock-defined connection counterpart, such that the towing vehicle-defined connection counterpart and the dock-defined connection counterpart become emplaced in an alignment relationship for establishing connection between the towing vehicle-defined connection counterpart and the dock-defined connection counterpart; in response to the emplacement of the towing vehicle-defined connection counterpart and the dock-defined connection counterpart in the alignment relationship, connection of the towing vehicle-defined connection counterpart and the dock-defined connection counterpart is effectuatable by displacement of the towing vehicle-defined connection counterpart, relative to the dock-defined connection counterpart, in a direction towards the dock-defined connection counterpart.

In another aspect, there is provided a kit for modifying a towing vehicle and a dock, the towing vehicle comprising an energy storage device, the dock comprising an energy source, the kit comprising: towing vehicle adaptor components including: a towing vehicle-defined connection counterpart; and dock adaptor components including: a dock-defined connection counterpart; and a guide; wherein: while: (i) the towing vehicle adaptor components are installed within a towing vehicle, with effect that a modified towing vehicle is established, such that the modified towing vehicle includes the towing vehicle-defined connection counterpart and (ii) the dock adaptor components are installed within a dock with effect that a charging dock is established, such that the charging dock includes the dock-defined connection counterpart, and the guide: the towing vehicle-defined connection counterpart is connectible to the dock-defined connection counterpart; and the modified towing vehicle and the charging dock are co-operatively configured such that: the connection of the towing vehicle-defined connection counterpart with the dock-defined connection counterpart effectuates connection between the energy source and the energy storage device, such that energy is transferrable from the energy source to the energy storage device; while: (i) the towing vehicle-defined connection counterpart and the dock-defined connection counterpart are co-operatively disposed in a misaligned relationship, wherein, in the misaligned relationship, there is an absence of alignment between the towing vehicle-defined connection counterpart and the dock-defined connection counterpart, and (ii) the towing vehicle-defined connection counterpart is disposed in a guiding-effective relationship with the guide: an alignment relationship-obtaining displacement of the towing vehicle-defined connection counterpart, relative to the dock-defined connection counterpart, is guidable, by the guide, wherein the guided displacement is effective for emplacing the towing vehicle-defined connection counterpart in alignment with the dock-defined connection counterpart, such that the towing vehicle-defined connection counterpart and the dock-defined connection counterpart become emplaced in an alignment relationship for establishing connection between the towing vehicle-defined connection counterpart and the dock-defined connection counterpart; in response to emplacement of the towing vehicle-defined connection counterpart and the dock-defined connection counterpart in the alignment relationship, connection of the towing vehicle-defined connection counterpart and the dock-defined connection counterpart is effectuatable by displacement of the towing vehicle-defined connection counterpart, relative to the dock-defined connection counterpart, in a direction towards the dock-defined connection counterpart.

In another aspect, there is provided a system comprising: a towing vehicle including: an energy storage device; a towing vehicle-defined connection counterpart; and a charging dock including: an energy source; a dock-defined connection counterpart; and a guide; wherein: the towing vehicle-defined connection counterpart is connectible to the dock-defined connection counterpart; and the towing vehicle and the dock are co-operatively configured such that: the connection of the towing vehicle-defined connection counterpart with the dock-defined connection counterpart effectuates connection between the energy source and the energy storage device, such that energy is transferrable from the energy source to the energy storage device; while: (i) the towing vehicle-defined connection counterpart and the dock-defined connection counterpart are co-operatively disposed in a misaligned relationship, wherein, in the misaligned relationship, there is an absence of connection between the towing vehicle-defined connection counterpart and the dock-defined connection counterpart, and (ii) the towing vehicle-defined connection counterpart is disposed in a guiding-effective relationship with the guide: an alignment relationship-obtaining displacement of the towing vehicle-defined connection counterpart, relative to the dock-defined connection counterpart, is guidable, by the guide, wherein the guided displacement is effective for emplacing the towing vehicle-defined connection counterpart in alignment with the dock-defined connection counterpart, such that the towing vehicle-defined connection counterpart and the dock-defined connection counterpart become emplaced in an alignment relationship for establishing connection between the towing vehicle-defined connection counterpart and the dock-defined connection counterpart; in response to emplacement of the towing vehicle-defined connection counterpart and the dock-defined connection counterpart in the alignment relationship, connection of the towing vehicle-defined connection counterpart and the dock-defined connection counterpart is effectuatable by displacement of the towing vehicle-defined connection counterpart, relative to the dock-defined connection counterpart, in a direction towards the dock-defined connection counterpart.

Other aspects will be apparent from the description and drawings provided herein.

### BRIEF DESCRIPTION OF DRAWINGS

In the figures, which illustrate example embodiments,

FIG. 1 is a perspective view of towing vehicles coupled to charging docks;

FIG. 1A is a perspective view of a first adapter counterpart of an adapter;

FIG. 1B is a perspective view of a second adapter counterpart of an adapter;

FIG. 1C is a perspective view of the first and second adapter counterparts of FIG. 1A and FIG. 1B;

FIG. 2 is a block diagram of an example embodiment of an apparatus for connecting a first adapter counterpart of a towing vehicle to a second adapter counterpart of a charging dock;

FIG. 3 is a perspective view of the first adapter counterpart and the second adapter counterpart of the adapter, the first adapter counterpart connected to an apparatus for connecting the first adapter counterpart to the second adapter counterpart;

FIG. 4 is a perspective view of a charging dock;

FIG. 5 is a perspective view of the apparatus of FIG. 3, with an object manipulator in the actuation-ineffective position;

FIG. 6 is the perspective view of the apparatus of FIG. 5, with the object manipulator in the actuation-ready position;

FIG. 7 is a perspective view of the apparatus of FIG. 6, with the first adapter counterpart connected to the second adapter counterpart;

FIG. 8 is an elevation view of the apparatus of FIG. 7, with the first adapter counterpart connected to the second adapter counterpart;

FIG. 9 is a perspective view of a towing vehicle and dock of FIG. 1, with the first adapter counterpart connected to the second adapter counterpart via the apparatus of FIG. 5;

FIG. 10 is an elevation view of the apparatus of FIG. 7 without the housing, with the first adapter counterpart connected to the second adapter counterpart, and the first adapter counterpart decoupled from a coupler of the apparatus;

FIG. 11 is a perspective view of the apparatus of FIG. 5, with the first adapter counterpart connected to the second adapter counterpart, and the object manipulator retracted to the actuation-ineffective position;

FIG. 12 is a perspective view of an embodiment of the dock;

FIG. 13 is an elevation view of the dock of FIG. 12;

FIG. 14 is a side view of an alternate embodiment of the apparatus of FIG. 5;

FIG. 15 is a perspective view of the apparatus of FIG. 14;

FIG. 16 is a perspective view of the ball joint assembly of the apparatus of FIG. 14;

FIG. 17 is a perspective view of the apparatus of FIG. 14, with the housing pivoted to the left;

FIG. 18 is a perspective view of the apparatus of FIG. 14, with the housing pivoted to the further to the left;

FIG. 19 is a perspective view of the apparatus of FIG. 5 for connecting a first adapter counterpart to a second adapter counterpart that is mounted to a charging dock, the charging dock including guide beams, with the object manipulator in the actuation-ineffective position;

FIG. 20 is a cross-sectional view of apparatus and charging dock of FIG. 19, with the object manipulator in the actuation-ready position.

FIG. 21 is a top elevation view of a towing vehicle, including the apparatus of FIG. 5, connected to a trailer, depicting the swing radius of the trailer.

### DETAILED DESCRIPTION

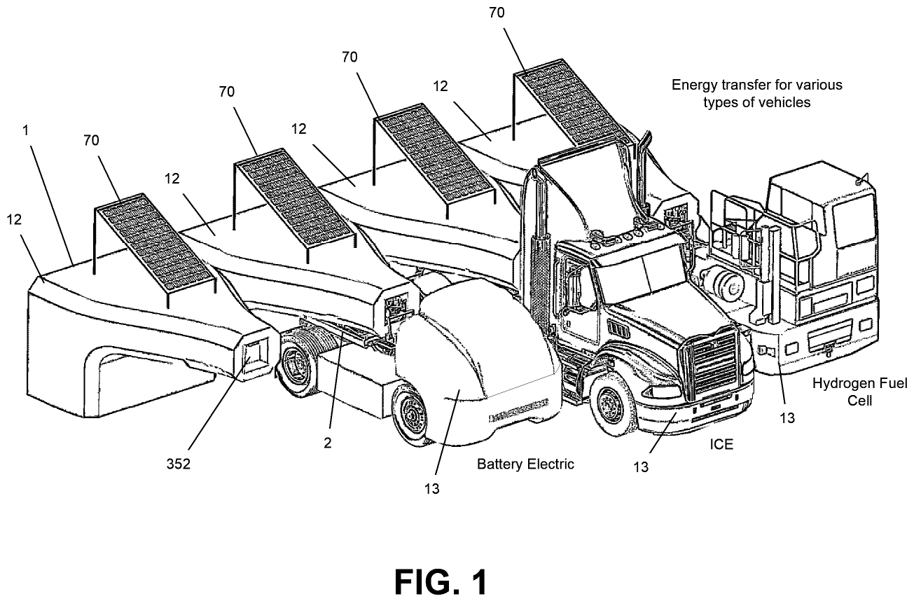

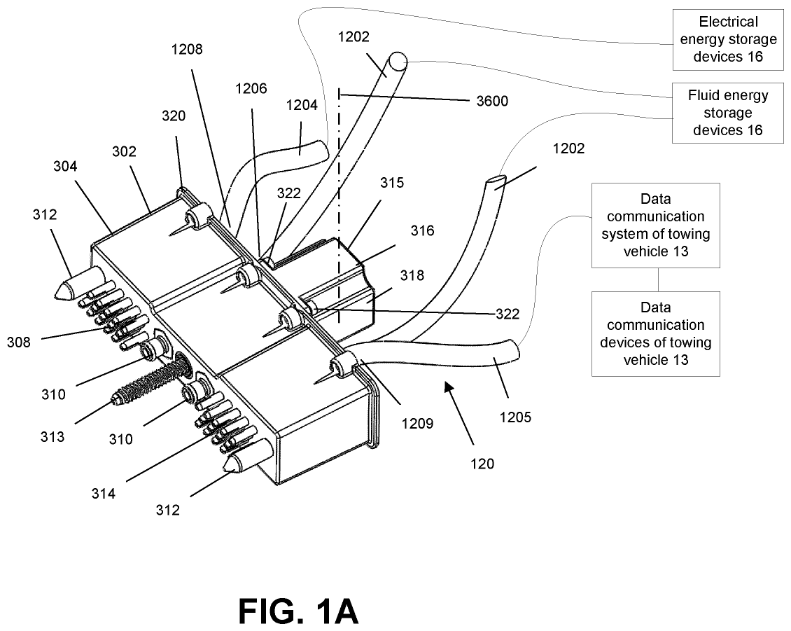

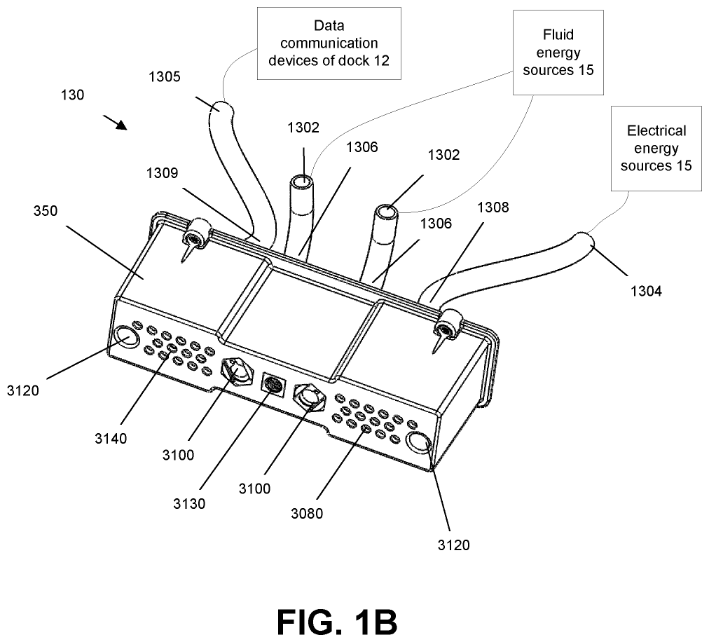

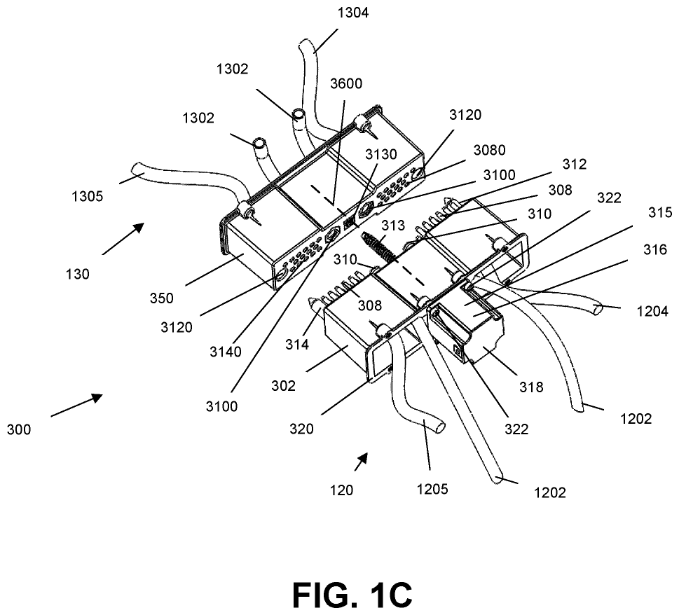

FIG. 1 depicts three towing vehicles 13, each one of the three towing vehicles 13, independently, coupled to a respective charging dock 12. The towing vehicle 13 is configured to be coupled to the dock 12 for replenishing one or more energy storage devices or reservoirs 16 of the towing vehicle 13 (e.g. battery, fuel tank, pneumatic gas tank, hydrogen fuel cell, natural gas tank, etc.) by an energy source 15 of the dock 12 (e.g. source of electrical energy, fuel such as diesel, pneumatic gas, hydrogen, natural gas, etc.). In some embodiments, for example, the towing vehicle 13 is an autonomous vehicle, such as an autonomous tractor, a yard shifter, or a converter dolly. In some embodiments, for example, the towing vehicle 13 includes a fifth wheel coupling 2, configured for receiving and coupling with a corresponding fifth wheel guiding counterpart or locking pin 14, or kingpin, that extends from underneath the dock 12 which is received within a corresponding slot formed in the coupling plate of the fifth wheel coupling 2. The coupling of the locking pin 14 of the dock 12 and the coupling plate of the fifth wheel coupling 2 of the towing vehicle 13 is substantially similar to the coupling of the locking pin 14 of a trailer and the coupling plate of the fifth wheel coupling 2 of the towing vehicle 13. While a fifth wheel coupling 2 has been described in connection with the coupling of the dock 12 to the towing vehicle 13, it will be understood that various other couplings may be used provided the coupling between the towing vehicle 13 and the dock 12 is such that while the fifth wheel guiding counterpart 14 is received by the fifth wheel 2, the towing vehicle 13 and the dock 12 become disposed in an interaction-effective configuration, such that respective adapter counterparts 302 and 350 of the towing vehicle 13 and the dock 12 are connectible via a connection apparatus 100, as described in greater detail herein. In some embodiments, for example, while the towing vehicle 13 and the dock 12 are decoupled, the towing vehicle 13 and the dock 12 become disposed in an interaction-ineffective configuration, such that respective adapter counterparts 302 and 350 of the towing vehicle 13 and the dock 12 are not connectible via the connection apparatus 100.

In some embodiments, for example, connection or operable communication (e.g. electrical communication, fluid communication or fluid pressure communication or flow communication, data communication, etc.) is established between the towing vehicle 13 and the dock 12 via connection of the first and second adapter counterparts 302 and 350, such that energy is transferrable from the energy source 15 of the dock 12 to the energy storage device 16 of the towing vehicle 13, to replenish the energy storage device 16.

In some embodiments, for example, as depicted in FIG. 1A to FIG. 1C, the towing vehicle 13 includes a towing vehicle-defined communicator or dock communicator 120, and the dock 12 includes a dock-defined communicator or towing vehicle communicator 130. In some embodiments, for example, the dock communicator 120 is compliant with an ISO 13044-2 standard. In some embodiments, for example, the dock communicator 120 includes one or more flexible cables. In some embodiments, for example, the towing vehicle communicator 130 is compliant with an ISO 13044-2 standard. In some embodiments, for example, the towing vehicle communicator 130 includes one or more flexible cables.

In some embodiments, for example, the dock communicator 120 includes a dock communicator-defined connector counterpart, and the towing vehicle communicator 130 includes a towing vehicle communicator-defined connector counterpart. In some embodiments, for example, the dock communicator-defined connector counterpart and the towing vehicle communicator-defined connector counterpart are co-operatively configured to effect the coupling of the dock communicator 120 and the towing vehicle communicator 130 such that the dock communicator 120 becomes disposed in the coupled relationship with the towing vehicle communicator 130. In some embodiments, for example, the dock communicator-defined connector counterpart and the towing vehicle communicator-defined connector counterpart are co-operatively configured to effect the coupling of the dock communicator 120 and the towing vehicle communicator 130 such that the dock communicator 120 becomes disposed in operable communication, for example, fluid pressure communication, electrical communication, and data communication, with the towing vehicle communicator 130.

In some embodiments, for example, the dock communicator 120 includes a towing vehicle defined fluid communication counterpart or a dock communicator-defined fluid communication counterpart 1206, and the towing vehicle communicator 130 includes a dock-defined fluid communication counterpart or a towing vehicle communicator-defined fluid communication counterpart 1306. In some embodiments, for example, the dock communicator-defined fluid communication counterpart 1206 and the towing vehicle communicator-defined fluid communication counterpart 1306 are co-operatively configured to effect fluid communication between the dock communicator 120 and the towing vehicle communicator 130 such that while the dock communicator-defined fluid communication counterpart 1206 and the towing vehicle communicator-defined fluid communication counterpart 1306 are disposed in fluid communication, the dock communicator 120 and the towing vehicle communicator 130 are disposed in fluid communication.

In some embodiments, for example, the dock communicator 120 includes a towing vehicle-defined fluid conductor or a dock communicator-defined fluid conductor 1202 that is disposed in fluid communication with the dock communicator-defined fluid communication counterpart 1206, and the towing vehicle communicator 130 includes a dock-defined fluid conductor or a towing vehicle communicator-defined fluid conductor 1302 that is disposed in fluid communication with the towing vehicle communicator-defined fluid communication counterpart 1306. In some embodiments, for example, the dock communicator-defined fluid communication counterpart 1206, the towing vehicle communicator-defined fluid communication counterpart 1306, the dock communicator-defined fluid conductor 1202, and the towing vehicle communicator-defined fluid conductor 1302 are co operatively configured such that while the dock communicator-defined fluid communication counterpart 1206 and the towing vehicle communicator-defined fluid communication counterpart 1306 are disposed in fluid communication, the dock communicator-defined fluid conductor 1202 and the towing vehicle communicator-defined fluid conductor 1302 are disposed in fluid communication.

In some embodiments, for example, the dock communicator-defined fluid conductor 1202 and the towing vehicle communicator-defined fluid conductor 1302 are pneumatic gas conductors, and the dock communicator-defined fluid communication counterpart and the towing vehicle communicator-defined fluid communication counterpart are glad hands. In some embodiments, for example, the dock communicator-defined fluid conductor 1202 and the towing vehicle communicator-defined fluid conductor 1302 are configured for conducting diesel and the dock communicator-defined fluid communication counterpart 1206 and the towing vehicle communicator-defined fluid communication counterpart 1306 are configured to connect the dock communicator-defined fluid conductor 1202 and the towing vehicle communicator-defined fluid conductor 1302 for conducting diesel. In some embodiments, for example, the dock communicator-defined fluid conductor 1202 and the towing vehicle communicator-defined fluid conductor 1302 are configured for conducting hydrogen, and the dock communicator-defined fluid communication counterpart 1206 and the towing vehicle communicator-defined fluid communication counterpart 1306 are configured to connect the dock communicator-defined fluid conductor 1202 and the towing vehicle communicator-defined fluid conductor 1302 for conducting hydrogen. In some embodiments, for example, the dock communicator-defined fluid conductor 1202 and the towing vehicle communicator-defined fluid conductor 1302 are configured for conducting natural gas, and the dock communicator-defined fluid communication counterpart 1206 and the towing vehicle communicator-defined fluid communication counterpart 1306 are configured to connect the dock communicator-defined fluid conductor 1202 and the towing vehicle communicator-defined fluid conductor 1302 for conducting natural gas.

In some embodiments, for example, the dock communicator 120 includes a towing vehicle defined electrical communication counterpart or a dock communicator-defined electrical communication counterpart 1208, and the towing vehicle communicator 130 includes a dock defined electrical communication counterpart or a towing vehicle communicator-defined electrical communication counterpart 1308. In some embodiments, for example, the dock communicator-defined electrical communication counterpart 1208 and the towing vehicle communicator-defined electrical communication counterpart 1308 are co-operatively configured to effect electrical communication between the dock communicator 120 and the towing vehicle communicator 130, such that while the dock communicator-defined electrical communication counterpart 1208 and the towing vehicle communicator-defined electrical communication counterpart 1308 are disposed in electrical communication, the dock communicator 120 and the towing vehicle communicator 130 are disposed in electrical communication.

In some embodiments, for example, the dock communicator 120 includes a towing vehicle-defined electrical conductor or a dock communicator-defined electrical conductor 1204 that is disposed in electrical communication with the dock communicator-defined electrical communication counterpart 1208, and the towing vehicle communicator 130 includes a dock-defined electrical conductor or a towing vehicle communicator-defined electrical conductor 1304 that is disposed in electrical communication with the towing vehicle communicator-defined electrical communication counterpart 1308. In some embodiments, for example, the dock communicator-defined electrical communication counterpart 1208, the towing vehicle communicator-defined electrical communication counterpart 1308, the dock communicator-defined electrical conductor 1204, and the towing vehicle communicator-defined electrical conductor 1304 are co operatively configured such that while the dock communicator-defined electrical communication counterpart 1208 and the towing vehicle communicator-defined electrical communication counterpart 1308 are disposed in electrical communication, the dock communicator-defined electrical conductor 1204 and the towing vehicle communicator-defined electrical conductor 1304 are disposed in electrical communication.

In some embodiments, for example, the dock communicator-defined electrical conductor 1204 and the towing vehicle communicator-defined electrical conductor 1304 include electrical conductors (e.g. electrical cables), and the dock communicator-defined electrical communication counterpart 1208 and the towing vehicle communicator-defined electrical communication counterpart 1308 are electrical connectors.

In some embodiments, for example, the dock communicator 120 includes a towing vehicle defined data communication counterpart or a dock communicator-defined data communication counterpart 1209, and the towing vehicle communicator 130 includes a dock defined data communication counterpart or a towing vehicle communicator-defined data communication counterpart 1309. In some embodiments, for example, the dock communicator-defined data communication counterpart 1209 and the towing vehicle communicator-defined data communication counterpart 1309 are co-operatively configured to effect data communication between the dock communicator 120 and the towing vehicle communicator 130, such that while the dock communicator-defined data communication counterpart 1209 and the towing vehicle communicator-defined data communication counterpart 1309 are disposed in data communication, the dock communicator 120 and the towing vehicle communicator 130 are disposed in data communication.

In some embodiments, for example, the dock communicator 120 includes a towing vehicle-defined data conductor or a dock communicator-defined data conductor 1205 that is disposed in data communication with the dock communicator-defined data communication counterpart 1209, and the towing vehicle communicator 130 includes a dock-defined data conductor or a towing vehicle communicator-defined data conductor 1305 that is disposed in data communication with the towing vehicle communicator-defined data communication counterpart 1309. In some embodiments, for example, the dock communicator-defined data communication counterpart 1209, the towing vehicle communicator-defined data communication counterpart 1309, the dock communicator-defined data conductor 1205, and the towing vehicle communicator-defined data conductor 1305 are co operatively configured such that while the dock communicator-defined data communication counterpart 1209 and the towing vehicle communicator-defined data communication counterpart 1309 are disposed in data communication, the dock communicator-defined data conductor 1205 and the towing vehicle communicator-defined data conductor 1305 are disposed in data communication.

In some embodiments, for example, the dock communicator-defined data conductor 1205 and the towing vehicle communicator-defined data conductor 1305 include data conductors (e.g. data cables), and the dock communicator-defined data communication counterpart 1209 and the towing vehicle communicator-defined data communication counterpart 1309 are data connectors.

In some embodiments, for example, as depicted in FIG. 1A, the dock communicator 120 includes the dock communicator-defined fluid conductor 1202, the dock communicator-defined electrical conductor 1204, and the dock communicator-defined data conductor 1205, and the dock communicator 120 is defined as separate communicators, in particular, the dock communicator-defined fluid conductor 1202, the dock communicator-defined electrical conductor 1204, and the dock communicator-defined data conductor 1205 are separate conductors. In some embodiments, for example, the dock communicator 120 includes the dock communicator-defined fluid conductor 1202, the dock communicator-defined electrical conductor 1204, and the dock communicator-defined data conductor 1205, and the dock communicator 120 is defined as a single communicator, for example, as a single cable, wherein the dock communicator-defined fluid conductor 1202, the dock communicator-defined electrical conductor 1204, and the dock communicator-defined data conductor 1205 are disposed in the communicator.

In some embodiments, for example, the dock communicator-defined fluid conductor 1202 is disposed in fluid communication with a fluid energy storage device of the towing vehicle 13, such that the dock communicator-defined fluid communication counterpart 1206 is disposed in fluid communication with the fluid energy storage device (e.g. diesel, natural gas, hydrogen, pneumatic gas, etc.) of the towing vehicle 13 via the dock communicator-defined fluid conductor 1202.

In some embodiments, for example, the dock communicator-defined electrical conductor 1204 is disposed in electrical communication with the electrical energy storage device of the towing vehicle 13, such that the dock communicator-defined electrical communication counterpart 1208 is disposed in electrical communication with the electrical energy storage device (e.g. battery) of the towing vehicle 13 via the dock communicator-defined electrical conductor 1204.

In some embodiments, for example, the dock communicator-defined data conductor 1205 is disposed in data communication with a data communication system, for example, a databus, of the towing vehicle 13, such that the dock communicator-defined data communication counterpart 1209 is disposed in data communication with the databus of the towing vehicle 13 via the dock communicator-defined data conductor 1205. The data communication system supports data communication between the data communication devices (e.g. sensors, valves, switches, controllers including the controller 102, pumps, actuators, energy storage devices, engine, etc.) of the towing vehicle 13. Example communication protocols supported by the data communication system include Controller Area Network (CAN), RS485, Automotive Ethernet, Gigabit Multimedia Serial Link (GMSL). In some embodiments, for example, wherein the towing vehicle 13 does not include a data communication system such as a databus, the dock communicator-defined data conductor 1205 functions as a data communication system, such as a databus, and is configured for disposition in data communication with data communication devices of the towing vehicle 13, such that the data communication devices of the towing vehicle 13 are disposed in data communication via the dock communicator-defined data conductor 1205.

In some embodiments, for example, the towing vehicle 13 includes more than one dock communicator-defined fluid conductor 1202, for example, a plurality of dock communicator-defined fluid conductors 1202 that are each, independently, disposed in fluid communication with the fluid energy storage device of the towing vehicle 13.

In some embodiments, for example, the towing vehicle 13 includes more than one dock communicator-defined fluid conductor 1202, for example, a plurality of dock communicator-defined fluid conductors 1202 that are each, independently, disposed in fluid communication with a respective one of a plurality of fluid energy storage devices (e.g. energy storage devices for diesel, natural gas, hydrogen, pneumatic gas, etc.) of the towing vehicle 13. In such embodiments, for example, each of a plurality of dock communicator-defined fluid communication counterparts 1206, independently, is disposed in fluid communication with a respective fluid energy storage device of the towing vehicle 13 via a respective dock communicator-defined fluid conductor 1202. For example, as depicted in FIG. 1A, the towing vehicle includes two dock communicator-defined fluid conductors 1202. In some embodiments, for example, a first dock communicator-defined fluid conductor 1202 is disposed in fluid communication with a pneumatic gas storage device of the towing vehicle 13, and a second dock communicator-defined fluid conductor 1202 is disposed in fluid communication with a diesel fuel storage device of the towing vehicle 13.

In some embodiments, for example, the towing vehicle 13 includes more than one dock communicator-defined fluid conductor 1202, for example, a dock communicator-defined fluid conductor 1202 for each fluid energy storage device of the towing vehicle 13 to be replenished. In some embodiments, for example, the towing vehicle 13 includes a dock communicator-defined fluid conductor 1202 for each of a diesel storage device, natural gas storage device, hydrogen storage device, or pneumatic gas storage device.

In some embodiments, for example, the towing vehicle 13 includes more than one dock communicator-defined electrical conductor 1204, for example, a plurality of dock communicator-defined electrical conductors 1204 that are each, independently, disposed in electrical communication with the electrical energy storage device of the towing vehicle 13.

In some embodiments, for example, the towing vehicle 13 includes more than one dock communicator-defined electrical conductor 1204, for example, a plurality of dock communicator-defined electrical conductors 1204 that are each, independently, disposed in electrical communication with a respective one of a plurality of electrical energy storage devices of the towing vehicle 13. In such embodiments, for example, each of a plurality of dock communicator-defined electrical communication counterparts 1208, independently, is disposed in electrical communication with a respective electrical energy storage device of the towing vehicle 13 via a respective dock communicator-defined electrical conductor 1204. For example, the towing vehicle 13 includes two dock communicator-defined electrical conductors 1204. A first dock communicator-defined electrical conductor 1204 is disposed in electrical communication with a first electrical energy storage of the towing vehicle 13, and a second dock communicator-defined electrical conductor 1204 is disposed in electrical communication with a second electrical energy storage device of the towing vehicle 13.

In some embodiments, for example, the towing vehicle 13 includes more than one dock communicator-defined electrical conductor 1204, for example, a dock communicator-defined electrical conductor 1204 for each electrical energy storage device of the towing vehicle 13 to be replenished.

In some embodiments, for example, the towing vehicle 13 includes more than one dock communicator-defined data conductor 1205, for example, a plurality of dock communicator-defined data conductors 1205 that are each, independently, disposed in data communication with the data communication devices of the towing vehicle 13, for example, via the data communication system of the towing vehicle 13.

In some embodiments, for example, the towing vehicle 13 includes more than one dock communicator-defined data conductor 1205, for example, a plurality of dock communicator-defined data conductors 1205 that are each, independently, disposed in data communication with one or more data communication devices of the towing vehicle 13. In such embodiments, for example, each of a plurality of dock communicator-defined data communication counterparts 1209, independently, is disposed in data communication with a respective one or more data communication devices of the towing vehicle 13 via a respective dock communicator-defined data conductor 1205.

In some embodiments, for example, the towing vehicle 13 includes more than one dock communicator-defined data conductor 1205, for example, a plurality of dock communicator-defined data conductors 1205 for the data communication devices of the towing vehicle 13.

In some embodiments, for example, as depicted in FIG. 1B, the towing vehicle communicator 130 includes the towing vehicle communicator-defined fluid conductor 1302, the towing vehicle communicator-defined electrical conductor 1304, and the towing vehicle communicator-defined data conductor 1305, and the towing vehicle communication 130 is defined as separate communicators, in particular, the towing vehicle communicator-defined fluid conductor 1302, the towing vehicle communicator-defined electrical conductor 1304, and the towing vehicle communicator-defined data conductor 1305 are separate conductors. In some embodiments, for example, the towing vehicle communicator 130 includes the towing vehicle communicator-defined fluid conductor 1302, the towing vehicle communicator-defined electrical conductor 1304, and the towing vehicle communicator-defined data conductor 1305, and the towing vehicle communicator 130 is defined as a single communicator, for example, as a single cable, wherein the towing vehicle communicator-defined fluid conductor 1302, the towing vehicle communicator-defined electrical conductor 1304, and the towing vehicle communicator-defined data conductor 1305 are disposed in the communicator.

In some embodiments, for example, the towing vehicle communicator-defined fluid conductor 1302 is disposed in fluid communication with the fluid energy source 15 of the dock 12, such that the towing vehicle communicator-defined fluid communication counterpart 1306 is disposed in fluid communication with the fluid energy source 15 (e.g. source of diesel, natural gas, hydrogen, pneumatic gas, etc.) of the dock 12 via the towing vehicle communicator-defined fluid conductor 1302.

In some embodiments, for example, the towing vehicle communicator-defined electrical conductor 1304 is disposed in electrical communication with the electrical energy source 15 (e.g. battery) of the dock 12, such that the towing vehicle communicator-defined electrical communication counterpart 1308 is disposed in electrical communication with the electrical energy source 15 of the dock 12 via the towing vehicle communicator-defined electrical conductor 1304.

In some embodiments, for example, the towing vehicle communicator-defined data conductor 1305 is disposed in data communication with a data communication system, for example, a databus, of the dock 12, such that the towing vehicle communicator-defined data communication counterpart 1309 is disposed in data communication with the databus of the dock 12 via the towing vehicle communicator-defined data conductor 1305. The data communication system supports data communication between the data communication devices (e.g. sensors, valves, switches, controllers, pumps, actuators, energy sources, etc.) of the dock 12. Example communication protocols supported by the data communication system include Controller Area Network (CAN), RS485, Automotive Ethernet, Gigabit Multimedia Serial Link (GMSL). In some embodiments, for example, wherein the dock 12 does not include a data communication system such as a databus, the towing vehicle communicator-defined data conductor 1305 functions as a data communication system, such as a databus, and is configured for disposition in data communication with data communication devices of the dock 12, such that the data communication devices of the dock 12 are disposed in data communication via the towing vehicle communicator-defined data conductor 1305.

In some embodiments, for example, the dock 12 includes more than one towing vehicle communicator-defined fluid conductor 1302, for example, a plurality of towing vehicle communicator-defined fluid conductors 1302 that are each, independently, disposed in fluid communication with the fluid energy source of the dock 12.

As depicted, in some embodiments, for example, the dock 12 includes more than one towing vehicle communicator-defined fluid conductor 1302, for example, a plurality of towing vehicle communicator-defined fluid conductors 1302 that are each, independently, disposed in fluid communication with a respective one of a plurality of fluid energy sources 15 (e.g. diesel tank, natural gas tank, hydrogen storage tank, or pneumatic gas tank, etc.) of the dock 12. In such embodiments, for example, each of a plurality of towing vehicle communicator-defined fluid communication counterparts 1306, independently, is disposed in fluid communication with a respective fluid energy source of the dock 12 via a respective towing vehicle communicator-defined fluid conductor 1302. For example, as depicted in FIG. 1B, the dock 12 includes two towing vehicle communicator-defined fluid conductors 1302. In some embodiments, for example, a first towing vehicle communicator-defined fluid conductor 1302 is disposed in fluid communication with a pneumatic gas source of the dock 12, and a second towing vehicle communicator-defined fluid conductor 1302 is disposed in fluid communication with a diesel fuel source of the dock 12.

In some embodiments, for example, the dock 12 includes more than one towing vehicle communicator-defined electrical conductor 1304, for example, a plurality of towing vehicle communicator-defined electrical conductors 1304 that are each, independently, disposed in electrical communication with the electrical energy source of the dock 12.

In some embodiments, for example, the dock 12 includes more than one towing vehicle communicator-defined electrical conductor 1304, for example, a plurality of towing vehicle communicator-defined electrical conductors 1304 that are each, independently, disposed in electrical communication with a respective one of a plurality of electrical energy sources of the dock 12. In such embodiments, for example, each of a plurality of towing vehicle communicator-defined electrical communication counterparts 1308, independently, is disposed in electrical communication with a respective electrical energy source (e.g. battery, generator, etc.) of the dock 12 via a respective towing vehicle communicator-defined electrical conductor 1304. For example, the dock 12 includes two towing vehicle communicator-defined electrical conductors 1304. A first towing vehicle communicator-defined electrical conductor 1304 is disposed in electrical communication with a first electrical energy source of the dock 12, and a second towing vehicle communicator-defined electrical conductor 1304 is disposed in electrical communication with a second electrical energy source of the dock 12.

In some embodiments, for example, the dock 12 includes more than one towing vehicle communicator-defined electrical conductor 1304, for example, a towing vehicle communicator-defined electrical conductor 1304 for each electrical energy source of the dock 12.

In some embodiments, for example, the dock 12 includes more than one towing vehicle communicator-defined data conductor 1305, for example, a plurality of towing vehicle communicator-defined data conductors 1305 that are each, independently, disposed in data communication with the data communication devices of the dock 12, for example, via the data communication system of the dock 12.

In some embodiments, for example, the dock 12 includes more than one towing vehicle communicator-defined data conductor 1305, for example, a plurality of towing vehicle communicator-defined data conductors 1305 that are each, independently, disposed in data communication with one or more data communication devices of the dock 12. In such embodiments, for example, each one of a plurality of towing vehicle communicator-defined data communication counterparts 1309, independently, is disposed in data communication with a respective one or more data communication devices of the dock 12 via a respective towing vehicle communicator-defined electrical conductor 1305.

In some embodiments, for example, the dock 12 includes more than one towing vehicle communicator-defined data conductor 1305, for example, a towing vehicle communicator-defined data conductor 1305 for each data communication device of the dock 12.

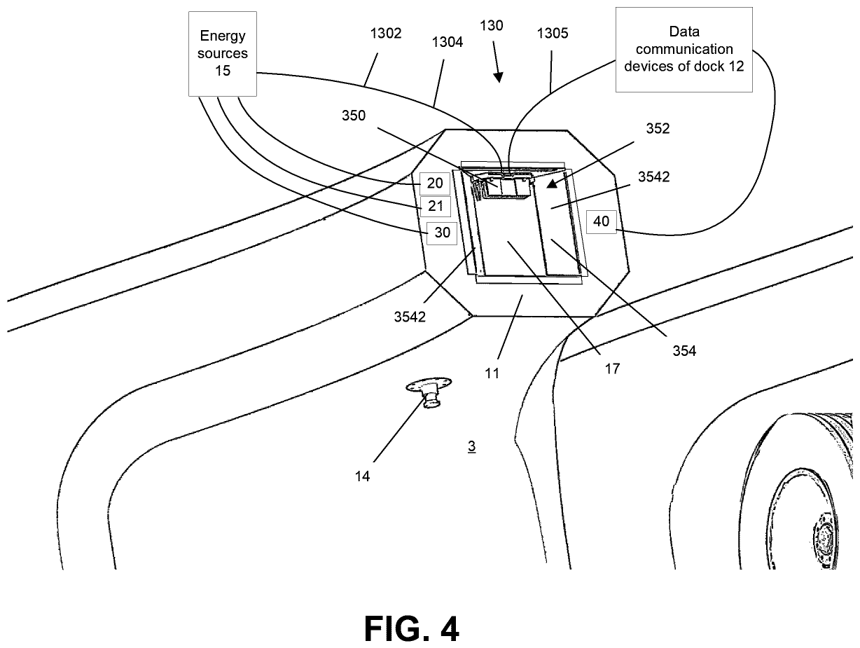

In some embodiments, for example, the towing communicator-defined fluid conductor 1302 is disposed in fluid communication with a fluid connector 20 (e.g. a glad hand) of the dock 12, as depicted in FIG. 4, which is disposed in fluid communication with the fluid energy source of the dock 12 (e.g. natural gas tank, hydrogen storage tank, pneumatic gas tank, etc.), such that the towing vehicle communicator-defined fluid communication counterpart 1306 is disposable in fluid communication with the fluid energy source of the dock 12 via the towing vehicle communicator-defined fluid conductor 1302 and the fluid connector 20.

In some embodiments, for example, the towing communicator-defined fluid conductor 1302 is disposed in fluid communication with a fuel connector 21 of the dock 12, as depicted in FIG. 4, which is disposed in fluid communication with the fuel source of the dock 12 (e.g. diesel fuel tank, etc.), such that the towing vehicle communicator-defined fluid communication counterpart 1306 is disposable in fluid communication with the fuel source of the dock 12 via the towing vehicle communicator-defined fluid conductor 1302 and the fuel connector 21.

In some embodiments, for example, the towing communicator-defined electrical conductor 1304 is disposed in electrical communication with an electrical connector 30 of the dock 12, as depicted in FIG. 4, which is disposed in electrical communication with the electrical energy source of the dock 12 (e.g. battery), such that the towing vehicle communicator-defined electrical communication counterpart 1308 is disposed in electrical communication with the electrical energy source of the dock 12 via the towing vehicle communicator-defined electrical conductor 1304 and the electrical connector.

In some embodiments, for example, the towing communicator-defined data conductor 1305 is disposed in data communication with a data connector 40 of the dock 12, as depicted in FIG. 4, which is disposed in data communication with data communication devices of the dock 12, such that the towing vehicle communicator-defined data communication counterpart 1309 is disposed in data communication with the data communication devices of the dock 12 via the towing vehicle communicator-defined data conductor 1305 and the data connector.

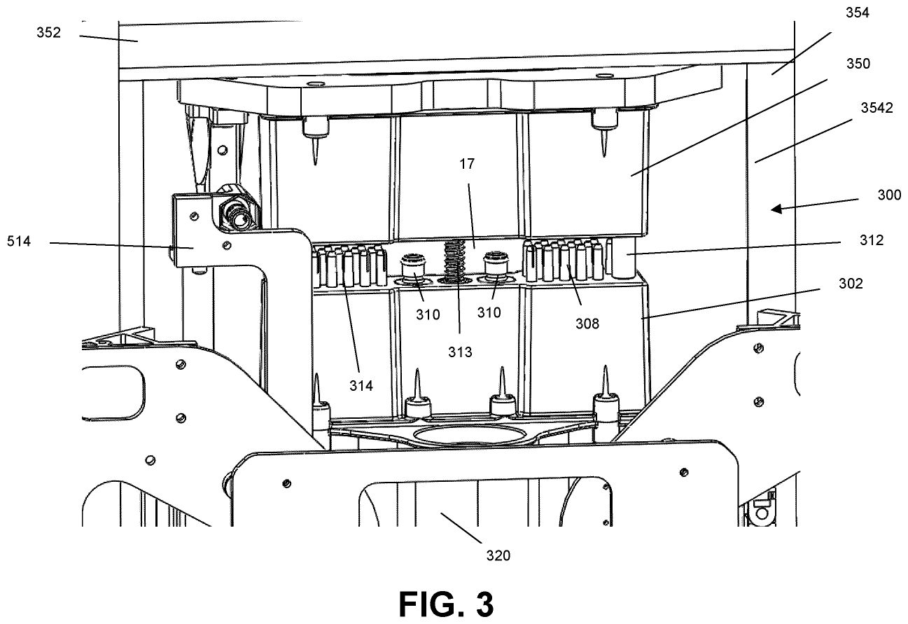

In some embodiments, for example, as depicted in FIG. 1A to FIG. 1C and FIG. 3, the connection between the dock communicator 120 and the towing vehicle communicator 130 is effectible by an adapter 300. The adapter 300 is configured to reduce the complexity of the establishing of operable communication, for example, fluid pressure communication, electrical communication, and data communication, between the dock communicator 120 and the towing vehicle communicator 130. In some embodiments, for example, the adapter 300 is configured to reduce the complexity of the establishing of operable communication between the towing vehicle 13 and the dock 12. The adapter 300 includes a towing vehicle-defined adapter counterpart or a towing vehicle-defined connection counterpart, for example, a first adapter counterpart 302, and a dock-defined adapter counterpart or a dock-defined connection counterpart, for example, a second adapter counterpart 350. The first adapter counterpart 302 is configured for connection, for example, coupling, to the second adapter counterpart 350.

In some embodiments, for example, the connection of the first adapter counterpart 302 and the second adapter counterpart 350 is with effect that operable communication between the energy storage device 16 of the towing vehicle 13 and the energy source 15 of the dock 12 is established, for transfer of energy from the energy source 15 of the dock 12 to the energy storage device 17 of the towing vehicle 13. In some embodiments, for example, the connection of the first adapter counterpart 302 with the second adapter counterpart 350 effectuates connection between the energy source 15 of the dock 12 and the energy storage device 16 of the towing vehicle 13, such that energy is transferrable from the energy source 15 to the energy storage device 16.

In some embodiments, for example, the communication established between the towing vehicle 13 and the dock 12, in response to the connection of the first adapter counterpart 302 and the second adapter counterpart 350, is fluid communication.

In some embodiments, for example, the energy source 15 of the dock 12 is a fluid energy source, the energy storage device 16 of the towing vehicle 13 is a fluid energy storage device, and the connection of the first adapter counterpart 302 and the second adapter counterpart 350 is with effect that the fluid energy source 15 of the dock 12 is disposed in fluid pressure communication with the fluid energy storage device 16 of the towing vehicle 13, for transfer of fluid energy from the fluid energy source 15 of the dock 12 to the fluid energy storage device 16 of the towing vehicle. In some embodiments, for example, the fluid energy includes pneumatic gas. In some embodiments, for example, the fluid energy includes hydrogen. In some embodiments, for example, the fluid energy includes natural gas.

In some embodiments, for example, the energy source 15 of the dock 12 is a fuel source, the energy storage device 16 of the towing vehicle 13 is a fuel storage device, and the connection of the first adapter counterpart 302 and the second adapter counterpart 350 is with effect that the fuel source of the dock 12 is disposed in fluid pressure communication with the fuel storage device 16 of the towing vehicle 13, for transfer of fuel from the fuel source 15 of the dock 12 to the fuel storage device 16 of the towing vehicle. In some embodiments, for example, the fuel includes diesel fuel.

In some embodiments, for example, the communication established between the towing vehicle 13 and the dock 12, in response to the connection of the first adapter counterpart 302 and the second adapter counterpart 350, is electrical communication.

In some embodiments, for example, the energy source 15 of the dock 12 is an electrical energy source, the energy storage device 16 of the towing vehicle 13 is an electrical energy storage device 16, and the connection of the first adapter counterpart 302 and the second adapter counterpart 350 is with effect that the electrical energy source 15 of the dock 12 is disposed in electrical communication with the electrical energy storage device 16 of the towing vehicle 13, for transfer of electrical energy from the electrical energy source of the dock 12 to the electrical energy storage device of the towing vehicle 13.

In some embodiments, for example, the communication established between the towing vehicle 13 and the dock 12, in response to the connection of the first adapter counterpart 302 and the second adapter counterpart 350, is data communication.

In some embodiments, for example, the dock 12 includes one or more data communication devices, the towing vehicle 13 includes a data communication system (e.g. a databus) that is disposed in data communication with data communication devices of the towing vehicle 13, and the connection of the first adapter counterpart 302 and the second adapter counterpart 350 is with effect that the data communication devices of the dock 12 are disposed in data communication with the data communication devices of the towing vehicle 13, for controlling the transfer of energy from the one or more energy sources 15 of the dock 12 to the one or more energy sources 16 of the towing vehicle 13.

In some embodiments, for example, as depicted in FIG. 1A, the first adapter counterpart 302 (e.g. a male counterpart 302) is disposed in operable communication, for example, fluid communication, electrical communication, and data communication, with the dock communicator 120.

In some embodiments, for example, the first adapter counterpart 302 is disposed in fluid communication with the one or more dock communicator-defined fluid conductors 1202, which are disposed in fluid communication with the fluid energy storage devices and fuel storage devices of the towing vehicle 13. In some embodiments, for example, the first adapter counterpart 302 is disposed in fluid communication with the one or more dock communicator-defined fluid conductors 1202 via a respective dock communicator-defined fluid communication counterpart 1206. In this respect, in some embodiments, for example, for each one of the fluid energy storage devices of the towing vehicle 13, the first adapter counterpart 302 and the fluid energy storage device 16 are disposed in fluid communication via a respective dock communicator-defined fluid conductor 1202. In some embodiments, for example, the fluid energy storage devices and fuel storage devices of the towing vehicle 13 are disposed in fluid communication with the first adapter counterpart 302 via the dock communicator-defined fluid conductor 1202 and the dock communicator-defined fluid communication counterpart 1206.

In some embodiments, for example, the first adapter counterpart 302 is disposed in electrical communication with the one or more dock communicator-defined electrical conductors 1204, which are disposed in electrical communication with the electrical energy storage devices of the towing vehicle 13. In some embodiments, for example, the first adapter counterpart 302 is disposed in electrical communication with the one or more dock communicator-defined electrical conductor 1204 via a respective dock communicator-defined electrical communication counterpart 1208. In this respect, in some embodiments, for example, for each one of the electrical energy storage devices of the towing vehicle 13, the first adapter counterpart 302 and the electrical energy storage device are disposed in electrical communication via a respective dock communicator-defined electrical conductor 1204. In some embodiments, for example, the electrical energy storage devices of the towing vehicle 13 are disposed in electrical communication with the first adapter counterpart 302 via the dock communicator-defined electrical conductor 1204 and the dock communicator-defined electrical communication counterpart 1208.

In some embodiments, for example, the first adapter counterpart 302 is disposed in data communication with the one or more dock communicator-defined data conductors 1205, which are disposed in data communication with the data communication devices of the towing vehicle 13. In some embodiments, for example, the first adapter counterpart 302 is disposed in data communication with the one or more dock communicator-defined data conductors 1205 via a respective dock communicator-defined data communication counterpart 1209. In this respect, in some embodiments, for example, for each one of the data communication devices of the towing vehicle 13, the first adapter counterpart 302 and the data communication device are disposed in data communication via a respective dock communicator-defined data conductor 1205. In some embodiments, for example, the data communication devices of the towing vehicle 13 are disposed in data communication with the first adapter counterpart 302 via the data communication system (e.g. databus), the dock communicator-defined data conductor 1205 and the dock communicator-defined data communication counterpart 1209.

In some embodiments, for example, as depicted in FIG. 1B, the second adapter counterpart 350 (e.g. a female counterpart 350) is disposed in operable communication, for example, fluid communication, electrical communication, and data communication, with the towing vehicle communicator 130.

In some embodiments, for example, the second adapter counterpart 350 is disposed in fluid communication with the one or more towing vehicle communicator-defined fluid conductors 1302, which are disposed in fluid communication with the fluid energy sources and fuel sources of the dock 12. In some embodiments, for example, for each of the one or more towing vehicle communicator-defined fluid conductors 1302, the second adapter counterpart 350 is disposed in fluid communication with the towing vehicle communicator-defined fluid conductor 1302 via a respective towing vehicle communicator-defined fluid communication counterpart 1306. In this respect, in some embodiments, for example, for each one of the fluid energy sources 15 of the dock 12, the second adapter counterpart 350 and the fluid energy source 15 are disposed in fluid communication via a respective towing vehicle communicator-defined fluid conductor 1302. In some embodiments, for example, the fluid energy sources and fuel sources of the dock 12 are disposed in fluid communication with the second adapter counterpart 350 via the towing vehicle communicator-defined fluid conductor 1302 and the towing vehicle communicator-defined fluid communication counterpart 1306.

In some embodiments, for example, the second adapter counterpart 350 is disposed in electrical communication with the one or more towing vehicle communicator-defined electrical conductors 1304, which are disposed in electrical communication with the electrical energy sources of the dock 12. In some embodiments, for example, for each of the one or more towing vehicle communicator-defined electrical conductors 1304, the second adapter counterpart 350 is disposed in electrical communication with the towing vehicle communicator-defined electrical conductor 1304 via a respective towing vehicle communicator-defined electrical communication counterpart 1308. In this respect, in some embodiments, for example, for each one of the electrical energy sources 15 of the dock 12, the second adapter counterpart 350 and the electrical energy source 15 are disposed in electrical communication via a respective towing vehicle communicator-defined electrical conductor 1304. In some embodiments, for example, the electrical energy sources of the dock 12 are disposed in electrical communication with the second adapter counterpart 350 via the towing vehicle communicator-defined electrical conductor 1304 and the towing vehicle communicator-defined electrical communication counterpart 1308.

In some embodiments, for example, the second adapter counterpart 350 is disposed in data communication with the one or more towing vehicle communicator-defined data conductors 1305, which are disposed in data communication with the data communication devices of the dock 12. In some embodiments, for example, the second adapter counterpart 350 is disposed in data communication with the one or more towing vehicle communicator-defined data conductors 1305 via a respective towing vehicle communicator-defined data communication counterpart 1309. In this respect, in some embodiments, for example, for each one of the data communication devices of the dock 12, the second adapter counterpart 350 and the data communication device are disposed in data communication via a respective towing vehicle communicator-defined data conductor 1305. In some embodiments, for example, the data communication devices of the dock 12 are disposed in data communication with the second adapter counterpart 350 via the towing vehicle communicator-defined data conductor 1305 and the towing vehicle communicator-defined data communication counterpart 1309.

In some embodiments, for example, the first adapter counterpart 302 and the second adapter counterpart 350 are configured to be disposed in operable communication, for example, fluid communication, electrical communication, and data communication. In some embodiments, for example, the disposition of the first adapter counterpart 302 and the second adapter counterpart 350 in operable communication is effected by connection, for example, coupling, of the first adapter counterpart 302 and the second adapter counterpart 350.

In some embodiments, for example, in response to disposition of the first adapter counterpart 302 and the second adapter counterpart 350 in operable communication via connection of the first adapter counterpart 302 and the second adapter counterpart 350, the dock communicator 120 and the towing vehicle communicator 130 are disposed in operable communication via the adapter 300. In this respect, in some embodiments, for example, in response to disposition of the first adapter counterpart 302 and the second adapter counterpart 350, the towing vehicle 13 and the dock 12 are disposed in operable communication via the adapter 300, the dock communicator 120, and the towing vehicle communicator 130.

In some embodiments, for example, in response to disposition of the first adapter counterpart 302 and the second adapter counterpart 350 in operable communication, for example, fluid communication, via connection of the first adapter counterpart 302 and the second adapter counterpart 350, the one or more dock communicator-defined fluid conductors 1202 and the corresponding one or more towing vehicle communicator-defined fluid conductors 1302 are disposed in fluid communication via the adapter 300. In this respect, in some embodiments, for example, in response to disposition of the first adapter counterpart 302 and the second adapter counterpart 350 in fluid communication, the one or more fluid energy storage devices 16 of the towing vehicle 13 and the corresponding fluid energy source 15 of the dock 12 are disposed in fluid communication via the adapter 300, the one or more dock communicator-defined fluid conductors 1202, and the one or more towing vehicle communicator-defined fluid conductors 1302, such that fluid energy is transferrable from the fluid energy source 15 to the fluid energy storage device 16.

In some embodiments, for example, in response to disposition of the first adapter counterpart 302 and the second adapter counterpart 350 in operable communication, for example, fluid communication, via connection of the first adapter counterpart 302 and the second adapter counterpart 350, the one or more dock communicator-defined fluid conductors 1202 and the corresponding one or more towing vehicle communicator-defined fluid conductors 1302 are disposed in fluid communication via the adapter 300. In this respect, in some embodiments, for example, in response to disposition of the first adapter counterpart 302 and the second adapter counterpart 350 in fluid communication, the one or more fuel storage devices 16 of the towing vehicle 13 and the corresponding fuel energy source 15 of the dock 12 are disposed in fluid communication via the adapter 300, the one or more dock communicator-defined fluid conductors 1202, and the one or more towing vehicle communicator-defined fluid conductors 1302, such that fuel is transferrable from the fuel source 15 to the fuel storage device 16.

In some embodiments, for example, in response to disposition of the first adapter counterpart 302 and the second adapter counterpart 350 in operable communication, for example, electrical communication, via connection of the first adapter counterpart 302 and the second adapter counterpart 350, the dock communicator-defined electrical conductor 1204 and the towing vehicle communicator-defined electrical conductor 1304 are disposed in electrical communication via the adapter 300. In this respect, in some embodiments, for example, in response to disposition of the first adapter counterpart 302 and the second adapter counterpart 350 in electrical communication, the one or more electrical energy storage devices 16 of the towing vehicle 13 and the corresponding electrical energy source 15 of the dock 12 are disposed in electrical communication via the adapter 300, the dock communicator-defined electrical conductor 1204, and the towing vehicle communicator-defined electrical conductor 1304, such that electrical energy is transferrable from the electrical energy source 15 to the electrical energy storage device 16.

In some embodiments, for example, in response to disposition of the first adapter counterpart 302 and the second adapter counterpart 350 in operable communication, for example, data communication, via connection of the first adapter counterpart 302 and the second adapter counterpart 350, the dock communicator-defined data conductor 1205 and the towing vehicle communicator-defined data conductor 1305 are disposed in data communication via the adapter 300. In this respect, in some embodiments, for example, in response to disposition of the first adapter counterpart 302 and the second adapter counterpart 350 in data communication, the data communication devices of the towing vehicle 13 and the data communication devices of the dock 12 are disposed in data communication via the adapter 300, the dock communicator-defined data conductor 1205, and the towing vehicle communicator-defined data conductor 1305. In this respect, in some embodiments, for example, the adapter 300, the dock communicator-defined data conductor 1205, and the towing vehicle communicator-defined data conductor 1305 are configured to support data communication between the towing vehicle 13 and the dock 12, in particular, the data communication devices of the towing vehicle 13 and the data communication devices of the dock 12. Example communication protocols supported by the adapter 300, the dock communicator-defined data conductor 1205, and the towing vehicle communicator-defined data conductor 1305 include Controller Area Network (CAN), RS485, Automotive Ethernet, Gigabit Multimedia Serial Link (GMSL).

As depicted in FIG. 1A to FIG. 1C, the first adapter counterpart 302 includes a housing 304. The first adapter counterpart 302 includes one or more electrical connectors 308, for example, electrical connector pins, one or more fluid connectors 310, for example, fluid connector pins, one or more guide pins 312, one or more data connectors 314, for example, data connector pins, and a screw 313 (e.g. an Acme screw). In some embodiments, for example, the electrical connectors 308, the fluid connectors 310, data connectors 314, guide pins 312 and the screw 313 extend from the housing 304 . . . . In some embodiments, for example, the electrical connectors 308, the fluid connectors 310, the guide pins 312, and the screw 313 are housed in the housing 304. In some embodiments, for example, the first adapter counterpart 302 defines an electro-pneumatic interface, wherein the electro-pneumatic interface includes the one or more electrical connectors 308, the one or more fluid connectors 310, and the one or more data connectors 314. In some embodiments, for example, the electro-pneumatic interface further includes the one or more guide pins 312 and the screw 313. In some embodiments, for example, for each one of the one or more dock communicator-defined fluid conductors 1202, the dock communicator-defined fluid conductors 1202 is disposed in operable communication, for example, fluid communication, with at least one of the one or more fluid connectors 310, for operably communicating fluid energy (e.g. diesel, natural gas, hydrogen, pneumatic gas). In some embodiments, for example, at least one of the one or more fluid connectors 310 are disposed in fluid communication with the dock communicator-defined fluid conductor 1202. As depicted in FIG. 1A, in some embodiments, for example, a first fluid connector 310 is disposed in fluid communication with a first dock communicator-defined fluid conductor 1202, and a second fluid connector 310 is disposed in fluid communication with a second towing communicator-defined fluid conductor 1202 In some embodiments, for example, for each one of the one or more dock communicator-defined electrical conductors 1204, the dock communicator-defined electrical conductor 1204 is disposed in electrical communication with at least one of the one or more electrical connectors 308, for operably communicating electrical energy. In some embodiments, for example, for each one of the one or more dock communicator-defined data conductors 1205, the dock communicator-defined data conductor 1205 is disposed in data communication with at least one of the one or more data connectors 314, for operably communicating data (e.g. data signals).

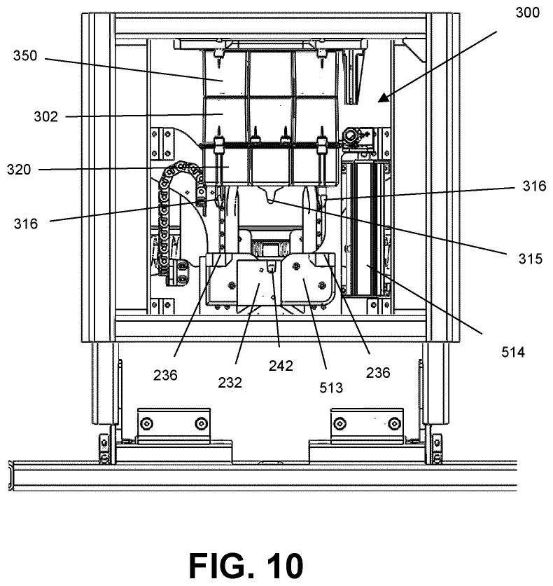

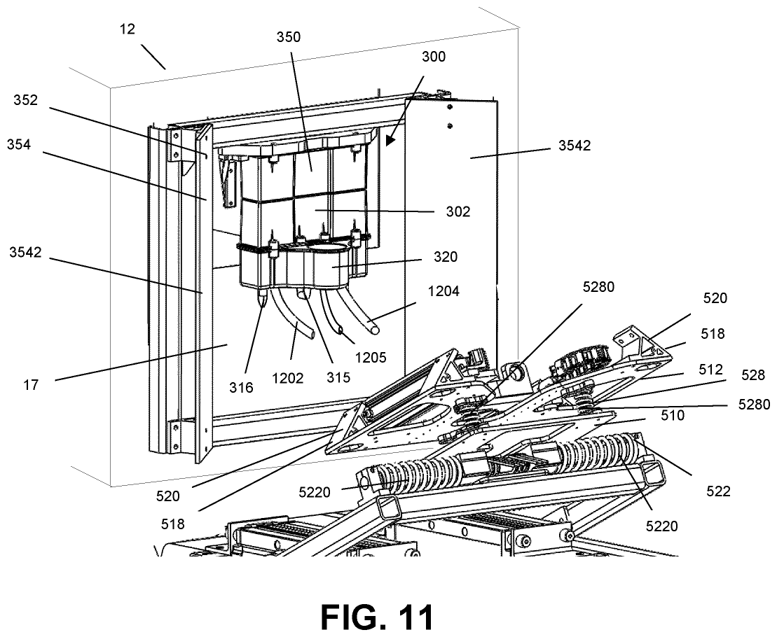

In some embodiments, for example, as depicted in FIG. 1A, FIG. 10, and FIG. 11, the first adapter counterpart 302 includes a bottom connection configuration 320 for coupling the first adapter counterpart 302 to a coupler 513 of a housing 512 of a robotic apparatus that is connected to the towing vehicle 13. In some embodiments, for example, the bottom connection configuration 320 is defined by the first adapter counterpart 302. The first adapter counterpart 302 includes a second connector counterpart 315 that is mounted on the bottom connection configuration 320. The second connector counterpart 315 is configured to co-operate with a first connector counterpart 232 of the coupler 513 of the robotic apparatus for releasably coupling the first adapter counterpart 302 and the coupler 513, and therefore, the housing 512. In some embodiments, for example, the second connector counterpart 315 includes a guide pin 316. The first connector counterpart 232 of the coupler 513 includes receiving ports 236. The guide pins 316 of the second connector counterpart 315 are receivable in the receiving ports 236 of the first connector counterpart 232. The first connector counterpart 232 is configured to releasably couple with second connector counterpart 315. The first connector counterpart 232 and the second connector counterpart 315 are co-operatively configured such that, in response to insertion of the guide pins 316 of the second connector counterpart 315 into the receiving port 236 of the first connector counterpart 232, releasable coupling of the first connector counterpart 232 and the second connector counterpart 315, and therefore, the first adapter counterpart 302 and the coupler 513, is effectible, in response to displacement of the first connector counterpart 232 towards the second connector counterpart 315. In some embodiments, for example, the releasable coupling of the first connector counterpart 232 and the second connector counterpart 315 is effected by a latch, for example, one or more spring-loaded latches. In some embodiments, for example, the spring-loaded latch is disposed in one of the first connector counterpart 232 and the second connector counterpart 315, for example, the first connector counterpart 232. In some embodiments, for example, a spring-loaded latch is disposed in both of the first connector counterpart 232 and the second connector counterpart 315.

In some embodiments, for example, the bottom connection configuration 320 defines one or more guide ports that are configured to receive the one or more prongs of the coupler 513. The one or more guide ports and the one or more prongs are co-operatively configured such that, while the one or more prongs are received in the one or more guide ports, the displacement of the coupler 513, towards the bottom connection configuration 320, is effective for coupling the coupler 513 and the first adapter counterpart 302, for example, via the latch. The one or more guide ports and the one or more prongs are co-operatively configured such that, while the one or more prongs are received in the one or more guide ports, the first adapter counterpart 302 and the coupler 513 are disposed in alignment, for example, along an alignment axis.

In some embodiments, for example, the coupler 513 includes an actuator 242. While the coupler 513 and the first adapter counterpart 302 are releasably coupled via the first connector counterpart 232 and the second connector counterpart 315, the actuator 242 is disposed in operable communication with the latch. While the coupler 513 and the first adapter counterpart 302 are releasably coupled via the first connector counterpart 232 and the second connector counterpart 315, in response to activation of the actuator 242, for example, by the controller 102 or a controller of the towing vehicle 13, the actuator 242 actuates the latch such that the coupling of the first connector counterpart 232 and the second connector counterpart 315 is defeated, such that the coupling of the coupler 513 and the first adapter counterpart 302 is defeated.

In some embodiments, for example, as depicted in FIG. 10 and FIG. 11, the bottom connection configuration 320 is a separate component that is connected to the first adapter counterpart 302, for example, via fasteners, interference fit, friction fit, and the like.

As depicted in FIG. 1B and FIG. 1C, the second adapter counterpart 350 includes a housing 352. In some embodiments, for example, the housing 352 is mounted on the dock 12, for example, the surface 11 of the dock 12 that faces the towing vehicle 13, while the towing vehicle 13 and the dock 12 are coupled. The second adapter counterpart 350 includes one or more electrical ports 3080, one or more fluid ports 3100, one or more data ports 3140, one or more guide ports 3120, and a screw port 3130. In some embodiments, for example, the second adapter counterpart 350 defines an electro-pneumatic interface, wherein the electro-pneumatic interface includes the one or more electrical connector ports 3080, the one or more fluid connector ports 3100, and the one or more data connector ports 3140. In some embodiments, for example, the electro-pneumatic interface further includes the one or more guide ports 3120 and the screw ports 3130. In some embodiments, for example, for each one of the one or more towing vehicle communicator-defined fluid conductors 1302, the towing vehicle communicator-defined fluid conductor 1302 is disposed in operable communication, for example, fluid communication, with at least one of the one or more fluid ports 3100, for operably communicating fluid energy (e.g. diesel, natural gas, hydrogen, pneumatic gas). In some embodiments, for example, at least one of the one or more fluid ports 3100 are disposed in fluid communication with the towing vehicle communicator-defined fluid conductor 1302. As depicted in FIG. 1B, in some embodiments, for example, a first fluid port 3100 is disposed in fluid communication with a first towing vehicle communicator-defined fluid conductor 1302, and a second fluid port 3100 is disposed in fluid communication with a second towing vehicle communicator-defined fluid conductor 1302. In some embodiments, for example, for each one of the one or more towing vehicle communicator-defined electrical conductors 1304, the towing vehicle communicator-defined electrical conductor 1304 is disposed in electrical communication with at least one of the one or more electrical ports 3080, for operably communicating electrical energy. In some embodiments, for example, for each one of the one or more towing vehicle communicator-defined data conductors 1305, the towing vehicle communicator-defined data conductor 1305 is disposed in data communication with at least one of the one or more data ports 3140, for operably communicating data.

As depicted, in some embodiments, for example, while the second adapter counterpart 350 is mounted on the dock 12, the electrical ports 3080, fluid ports 3100, data ports 3140, guide ports 3120, and the screw port 3130 are facing a direction that is perpendicular to the normal axis defined by the surface 11. In some embodiments, for example, while the second adapter counterpart 350 is mounted on the dock 12, the electrical ports 3080, fluid ports 3100, data ports 3140, guide ports 3120, and the screw port 3130 are facing downwards.

The electrical connectors 308 of the first adapter counterpart 302 and the electrical ports 3080 of the second adapter counterpart 350 are co-operatively configured such that, in response to insertion of the electrical connectors 308 into the electrical ports 3080, the first adapter counterpart 302 and the second adapter counterpart 350 become disposed in electrical communication, with effect that, for each one of the one or more dock communicator-defined electrical conductors 1204, the dock communicator-defined electrical conductor 1204 and a corresponding towing vehicle communicator-defined electrical conductor 1304 become disposed in electrical communication. In this respect, in response to insertion of the electrical connectors 308 into the electrical ports 3080, for each one of the one or more electrical energy storage devices 16 of the towing vehicle 13, the electrical energy storage device 16 becomes disposed in electrical communication with a corresponding electrical energy source 15 of the dock 12 via the adapter 300, the respective dock communicator-defined electrical conductor 1204, and the respective towing vehicle communicator-defined electrical conductor 1304, such that electrical energy is transferrable from the electrical energy source 15 to the electrical energy storage device 16.

The fluid connectors 310 of the first adapter counterpart 302 and the fluid ports 3100 of the second adapter counterpart 350 are co-operatively configured such that, in response to insertion of the fluid connectors 310 into the fluid ports 3100, the first adapter counterpart 302 and the second adapter counterpart 350 become disposed in fluid communication, with effect that, for each one of the one or more dock communicator-defined fluid conductors 1202, the dock communicator-defined fluid conductors 1202 and a corresponding towing vehicle communicator-defined fluid conductor 1302 become disposed in fluid communication. In this respect, in response to insertion of the fluid connectors 310 into the fluid ports 3100, for each of the one or more fluid energy storage devices 16 of the towing vehicle 13, the fluid energy storage device 16 becomes disposed in fluid communication with a corresponding fluid energy source 15 of the dock 12 via the adapter 300, the respective dock communicator-defined fluid conductor 1202, and the respective towing vehicle communicator-defined fluid conductor 1302, such that fluid energy is transferrable from the fluid energy source 15 to the fluid energy storage device 16.

The data connectors 314 of the first adapter counterpart 302 and the data ports 3140 of the second adapter counterpart 350 are co-operatively configured such that, in response to insertion of the data connectors 314 into the data ports 3140, the first adapter counterpart 302 and the second adapter counterpart 350 become disposed in data communication, with effect that, for each one of the one or more dock communicator-defined data conductors 1205, the dock communicator-defined data conductor 1205 and a corresponding towing vehicle communicator-defined data conductor 1305 become disposed in data communication. In this respect, in response to insertion of the data connectors 314 into the data ports 3140, for each one of the one or more data communication devices of the towing vehicle 13, the data communication device becomes disposed in data communication with one or more of the data communication devices of the dock 12 via the adapter 300, the respective dock communicator-defined data conductor 1205, and the respective towing vehicle communicator-defined data conductor 1305, for controlling the transfer of energy from the energy source 15 to the energy storage device 16.

In some embodiments, for example, connection of the first adapter counterpart 302 and the second adapter counterpart 350, for disposition of the first adapter counterpart 302 and the second adapter counterpart 350 in operable communication, is effected by establishment of: (i) electrical communication between the electrical connectors 308 and the electrical ports 3080, (ii) fluid communication between the fluid connectors 310 and the fluid ports 3100, and (iii) data communication between the data connectors 314 and the data ports 3140. In some embodiments, for example, establishment of electrical communication between the electrical connectors 308 and the electrical ports 3080 is effected by insertion of the electrical connectors 308 into the electrical ports 3080. In some embodiments, for example, establishment of fluid communication between the fluid connectors 310 and the fluid ports 3100 is effected by insertion of the fluid connectors 310 into the fluid ports 3100. In some embodiments, for example, establishment of data communication between the data connectors 314 and the data ports 3140 is effected by insertion of the data connectors 314 into the data ports 3140.

In some embodiments, for example, the guide pins 312 of the first adapter counterpart 302 and the guide ports 3120 of the second adapter counterpart 350 are co-operatively configured to guide the relative displacement of the first adapter counterpart 302 and the second adapter counterpart 350 for effecting the coupling of the first adapter counterpart 302 and the second adapter counterpart 350, such that the first adapter counterpart 302 and the second adapter counterpart 350 become disposed in operable communication.

In some embodiments, for example, the screw 313 of the first adapter counterpart 302 and the screw port 3130 of the second adapter counterpart 350 are co-operatively configured to effectuate the retention of the releasable coupling of the first adapter counterpart 302 and the second adapter counterpart 350, such that defeating of the operable communication between the first adapter counterpart 302 and the second adapter counterpart 350 is resisted. While the screw 313 is received in the screw port 3130, rotation of the screw 313 effects coupling of the screw 313 with the screw port 3130 via engagement of the threads of the screw 313 with corresponding threading of the screw port 3130. In some embodiments, for example, the first adapter counterpart 302 includes an actuator, such as a motor, for driving rotation of the screw 313.

As depicted in FIG. 1 and FIG. 4 to FIG. 11, the dock 12 includes a guide 352. The guide 352 is mounted to the surface 11 of the dock 12, for example, the front surface 11 of the dock 12, which faces the towing vehicle 13, while the towing vehicle 13 and the dock 12 are coupled. In some embodiments, for example, while the guide 352 is mounted on the dock 12, an outermost surface of the guide 352 is aligned with the surface 11 of the dock 12. In some embodiments, for example, while the guide 352 is mounted on the dock 12, the outermost surface of the guide 352 is flush with the surface 11 of the dock 12. In some embodiments, for example, while the guide 352 is mounted on the dock 12, an inner surface 17 of the guide 352 is flush with the surface 11 of the dock 12. In some embodiments, for example, while the guide 352 is mounted on the dock 12, the inner surface 17 of the guide 352 is recessed relative to the surface 11 of the dock 12.

The guide 352 is mounted to the dock 12 such that an alignment relationship-obtaining displacement of the first adapter counterpart 302, relative to the second adapter counterpart 350, is guidable, by the guide 352, wherein the guided displacement is effective for emplacing the first adapter counterpart 302 in alignment with the second adapter counterpart 350, such that the first adapter counterpart 302 and the second adapter counterpart 350 become disposed in an alignment relationship for establishing connection between the first adapter counterpart 302 and the second adapter counterpart 350. In response to the emplacement of the first adapter counterpart 302 and the second adapter counterpart 350 in the alignment relationship, connection of the first adapter counterpart 302 and the second adapter counterpart 350 is effectuatable by displacement of the first adapter counterpart 302, relative to the second adapter counterpart 350, in a direction towards the second adapter counterpart 350.

As depicted in FIG. 4, the guide 352 defines a channel or funnel 354 that is configured to receive a housing 512 of the robotic apparatus. As depicted, the channel 354 is defined by channel walls 3542 that are inclined. Each one of the channel walls 3542, independently, defines a surface configuration counterpart. In some embodiments, for example, the surface configuration counterpart of the channel wall 3542 is defined by an inclined surface of the channel wall 3542. In some embodiments, for example, the inclined surface is an inclined planar surface. As depicted in FIG. 4, the channel 354 has a rectangular shape. In some embodiments, the channel 354 has a round shape, such as a circle or an oval, or a three-sided shape, four-sided shape, or a shape with more than four sides. In some embodiments, for example, the channel 354 defines a funnel. The inclined channel walls 3542 are configured to guide or funnel the insertion of the housing 512 into the channel 354 such that the first adapter counterpart 302 and the second adapter counterpart 350 become aligned for disposing the first adapter counterpart 302 and the second adapter counterpart 350 in operable communication.

In some embodiments, for example, the mounting of the second adapter counterpart 350 and the guide 352 to the dock 12 is such that the second adapter 350 is disposed, relative to the guide 352, such that the one or more electrical ports 3080, one or more fluid ports 3100, one or more data ports 3140, one or more guide ports 3120, and screw port 3130 are disposed between the channel walls 3542 of the guide 352.

In some embodiments, for example, the second adapter counterpart 350 is mounted to the guide 352, as depicted in FIG. 4, such that the one or more electrical ports 3080, one or more fluid ports 3100, one or more data ports 3140, one or more guide ports 3120, and the screw port 3130 are disposed between the channel walls 3542 of the guide 352.

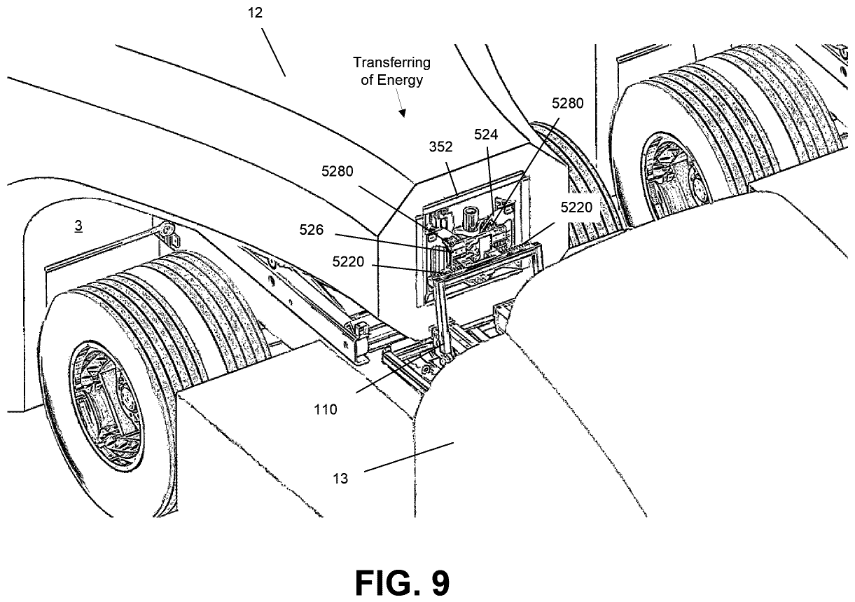

In some embodiments, for example, the dock 12 defines a space 3, as depicted in FIG. 4. As depicted, the fifth wheel guiding counterpart 14 of the dock 12 extends into the space 3. In some embodiments, for example, the space 3 is defined below the second adapter counterpart 350. In some embodiments, for example, the space 3 is defined below the guide 352. In some embodiments, for example, the space 3 is configured for receiving a frame of the towing vehicle 12, on which a robotic apparatus 100 is mounted, as depicted in FIG. 9.

In some embodiments, for example, the emplacement of the first adapter counterpart 302 and the second adapter counterpart 350 in the alignment relationship is obtainable while the frame of the towing vehicle 12 is received in the space 3, for example, while the fifth wheel 2 is coupled to the fifth wheel guiding counterpart 14 of the dock 12 (e.g. the kingpin), such that a fifth wheel coupling relationship is established.

In some embodiments, for example, the first adapter counterpart 302 and the second adapter counterpart 350 are compliant with ISO 13044-2 standard.

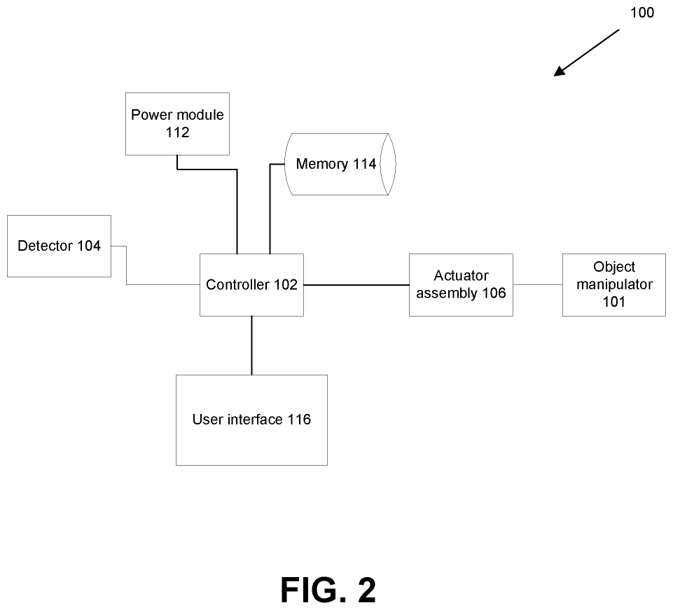

FIG. 2 depicts a block diagram of an example embodiment of an apparatus 100 that is configured to operably communicate, for example, connect, the first adapter counterpart 302 and the second adapter counterpart 350, to effect operable communication of a dock communicator 120 of the towing vehicle 13 to the towing vehicle communicator 130 of the dock 12. As depicted, in some embodiments, for example, the apparatus 100 includes a controller 102, a detector 104, an actuator assembly 106, and an object manipulator 101 including a robot arm 110 and an end effector 510, a power module 112, a memory 114, and a fixture or housing 512. In some embodiments, for example, the apparatus 100 further includes a user interface 116. The object manipulator 101 is configured to automatically connect the first adapter counterpart 302 and the second adapter counterpart 350 to establish operable communication between the first adapter counterpart 302 and the second adapter counterpart 350, thereby establishing connection, for example, operable communication, between the energy source 15 and the energy storage device 16, such that energy is transferrable from the energy source 15 to the energy storage device 16.

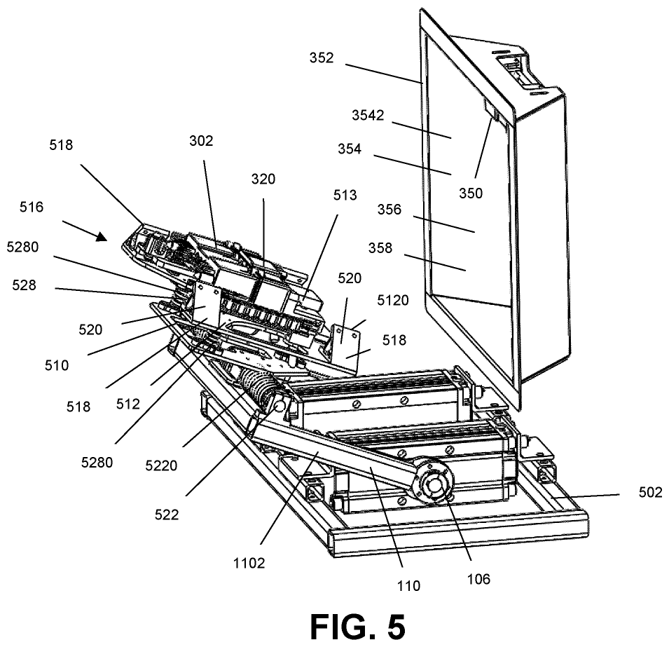

As depicted in FIG. 5 to FIG. 11, in some embodiments, for example, the apparatus 100 is a catapult-style apparatus.

In some embodiments, for example, the apparatus 100 is configured to displace the first adapter counterpart 302 towards the second adapter counterpart 350 for effecting an alignment relationship-obtaining displacement between the first adapter counterpart 302 and the second adapter counterpart 350, such that the first adapter counterpart 302 and the second adapter counterpart 350 become disposed in an alignment relationship, and for disposing the first adapter counterpart 302 and the second adapter counterpart 350 in operable communication. In some embodiments, for example, the displacement includes a rotational displacement about a pivot point of an arm segment 1102 of the apparatus 100. In some embodiments, for example, the displacement includes a displacement in a vertical direction. In some embodiments, for example, the displacement is a combination of a rotational displacement and a displacement in a vertical direction.

In some embodiments, for example, the apparatus 100 is configured to dispose the first adapter counterpart 302 and the second adapter counterpart 350 in operable communication. In some embodiments, for example, the disposition of the first adapter counterpart 302 and the second adapter counterpart 350 in operable communication is effected by insertion of the electrical, fluid, and data connectors 308, 310, and 314 of the first adapter counterpart 302 into the corresponding ports 3080, 3100, and 3140 of the second adapter counterpart 350.

In some embodiments, for example, the apparatus 100 is configured to decouple from the first adapter counterpart 302, and displace away from the first adapter counterpart 302 and the second adapter counterpart 350, after effecting the disposition of the first adapter counterpart 302 and the second adapter counterpart 350 in operable communication (e.g. after connecting the first adapter counterpart 302 and the second adapter counterpart 350). In some embodiments, for example, the displacement includes a rotational displacement about a pivot point of an arm segment 1102 of the apparatus 100. In some embodiments, for example, the displacement includes a displacement in a vertical direction. In some embodiments, for example, the displacement is a combination of a rotational displacement and a vertical displacement.

In some embodiments, the controller 102 includes a processor or a central processing unit (CPU), a memory 114 such as a ROM, RAM, persistent memory, or flash memory for storing data, and input or output peripherals. In some embodiments, for example, the controller 102 acts as a central controller for controlling all of the communications of the apparatus 100, and between the apparatus 100 and an external server or user equipment, such as a computer, laptop, smart device, a control panel in a control room, a control panel in the towing vehicle 13, a controller of the towing vehicle 13, and the like.

The controller 102 communicates with the detector 104, the actuator assembly 106, the user interface 116, the power module 112, and the memory 114. In some embodiments, the controller 102 receives data, saves the data to a memory, and processes the received data. The data may be real time data or historical data. In some embodiments, the controller 102 or detector 104 processes the data by, for example, comparing data with one or more preset thresholds. In some embodiments, the controller 102 or detector 104 processes the data to, for example, determine whether the towing vehicle 13 and dock 12 are coupled or decoupled, determine whether the first adapter counterpart 302 and the second adapter counterpart 350 are coupled or decoupled, determine whether the end effector 510 and the first adapter counterpart 302 are coupled or decoupled, determine whether the robot arm 110 is disposed in an actuation-ready position or actuation-ineffective position for coupling or uncoupling the first adapter counterpart 302 and the second adapter counterpart 350, determine whether the first adapter counterpart 302 and the second adapter counterpart 350 are disposed in operable communication, determine whether the coupler 513 and the first adapter counterpart 302 are coupled or decoupled, and determine the position or configuration of the object manipulator 101 for initiating the next step in the process for aligning and coupling the first adapter counterpart 302 and the second adapter counterpart 350 to establish operable communication between the first adapter counterpart 302 and the second adapter counterpart 350, or for decoupling the first adapter counterpart 302 and the second adapter counterpart 350 to defeat the operable communication between the first adapter counterpart 302 and the second adapter counterpart 350. Based on said determinations, in some embodiments, for example, the controller 102 is configured to activate the actuator assembly 106 to effect coupling of the coupler 513 with the first adapter counterpart 302, and to displace the first adapter counterpart 302 relative to the second adapter counterpart 350, to operably connect with the second adapter counterpart 350. In some embodiments, for example, the controller 102 determines that the towing vehicle 13 has stopped operating for a threshold period of time and that the towing vehicle 13 and the dock 12 are coupled, and then the controller 102 is configured to activate the actuator assembly 106 to effect coupling of the coupler 513 with the first adapter counterpart 302, and to displace the first adapter counterpart 302 to operably connect with the second adapter counterpart 350, and to displace the first adapter counterpart 302 relative to the second adapter counterpart 350, to operably connect the first adapter counterpart 302 with the second adapter counterpart 350. Based on said determinations, in some embodiments, for example, the controller 102 is configured to activate the actuator assembly 106 to effect coupling of the coupler 513 with the first adapter counterpart 302 that is operably connected with the second adapter counterpart 350, and to displace the first adapter counterpart 302, relative to the second adapter counterpart 350, to operably disconnect the first adapter counterpart 302 from the second adapter counterpart 350, such that operable communication between the first adapter counterpart 302 and the second adapter counterpart 350 becomes defeated. In some embodiments, for example, the controller 102 determines that the towing vehicle 13 has stopped operating for a threshold period of time and that the towing vehicle 13 and the dock 12 are coupled, and then the controller 102 is configured to activate the actuator assembly 106 to effect coupling of the coupler 513 and the first adapter counterpart 302 that is operably connected with the second adapter counterpart 350, and to displace the first adapter counterpart 302, relative to the second adapter counterpart 350, to operably disconnect from the second adapter counterpart 350, such that operable communication between the first adapter counterpart 302 and the second adapter counterpart 350 becomes defeated.

In some embodiments, the controller 102 is configured to control the functioning or operation of the apparatus 100. For example, based on the data from the detector 104 or the actuator assembly 106, the controller 102 sends a control command to the user interface 116 to render a graphic representative of the data, or sends a control command to the actuator assembly 106 to operate the object manipulator 101.

In some embodiments, for example, the controller 102 is mounted to the towing vehicle 13 such that the controller 102 is protected from the elements. In some embodiments, for example, the controller 102 is mounted under the cab of the towing vehicle 13. In some embodiments, for example, the controller 102 is mounted on the frame of the towing vehicle 13.

In some embodiments, for example, the detector 104 is operably coupled to the controller 102, for example, via wired or wireless communication, to transmit the detected data to the controller 102. In some embodiments, for example, the detector 104 includes a sensor subsystem, which includes one or more sensors. In some embodiments, for example, the detector 104 is configured to detect, independently: (i) the coupling or decoupling of the towing vehicle 13 and the dock 12, (ii) the coupling or decoupling of the end housing 512 and the first adapter counterpart 302, (iii) the coupling or decoupling of the first adapter counterpart 302 and the second adapter counterpart 350, (iv) the establishment or defeating of operable communication of the first adapter counterpart 302 and the second adapter counterpart 350, and (v) the capacity of the one or more energy storage devices 15 of the towing vehicle 13. In some embodiments, for example, the detector 104 is configured to detect whether the first adapter counterpart 302 and the second adapter counterpart 350 are disposed in operable communication. In some embodiments, for example, the detector 104 is configured to detect whether the coupler 513 of the apparatus 100 and the first adapter counterpart 302 are releasably coupled, for example, via the first connector counterpart 232 and the second connector counterpart 315. In some embodiments, for example, the detector 104 is configured to detect whether the housing 512 is disposed in abutting engagement with the surface 17 of the guide 352.

In some embodiments, one or more of the sensors of the detector 104 are wireless sensors that are configured for wireless communication with the controller 102.

In some embodiments, the apparatus 100 is configured to be in electrical communication with a power source, such as a battery or fuel cell. In some embodiments, the apparatus 100 is disposable in electrical communication with an external power source, such as a portable battery, portable generator, external battery, and the like. In some embodiments, for example, the apparatus 100 is wirelessly connectable to the external power source for wirelessly energizing the apparatus 100. In some embodiments, for example, the apparatus 100 is powered by the electrical reservoir of the towing vehicle 13, such as the battery of the towing vehicle 13.

In some embodiments, the apparatus 100 includes a user interface 116 that is configured to enable the controller 102 to interconnect with one or more input devices, such as user equipment, a keyboard, mouse, camera, touch screen and a microphone, or with one or more output devices such as a display screen and a speaker. In some embodiments, the controller 102 is configured to send a control command to the user interface 116 for displaying a graphical representation of data that is detected or sensed by the detector 104. In some embodiments, the user interface 116, via input from a user, is configured to send a control command to the controller 102 for controlling the apparatus 100. In some embodiments, for example, a user can input a control command to the controller 102 to via the user interface 116 to begin or end operation of the apparatus 100.

In some embodiments, for example, the controller 102 sends a control command to the user interface 116 to generate a graphical representation of the operating status of the apparatus 100. In some embodiments, for example, the controller 102 sends a control command to the user interface 116 to generate a graphical representation of a menu of options, and the user can input a control command using the user interface 116 to select an option from the menu, and the user interface 116 sends the control command to the controller 102 to control the operation of the apparatus 100.

The apparatus 100 includes an actuator assembly 106 that is disposed in operable communication with the controller 102. In some embodiments, for example, the actuator assembly 106 includes one or more actuators. The actuator assembly 106 is activatable to displace the robot arm 110 and to effect releasable coupling and releasing of the first adapter counterpart 302 by the end effector 510 of the object manipulator 101. In some embodiments, while the coupler 513 and the first adapter counterpart 302 are coupled, the actuator assembly 106 is activatable to displace the first adapter counterpart 302 via the robot arm 110 and the end effector 510. In some embodiments, for example, the controller 102 is configured to activate one or more of the actuators of the actuator assembly 106 to coordinate the displacement of the robot arm 110 and to effect the releasable coupling and releasing of the first adapter counterpart 302 by the coupler 513. In some embodiments, for example, the controller 102 is configured to activate one or more of the actuators of the actuator assembly 106 (e.g. the actuator 242) to releasably couple the first adapter counterpart 302 and the second adapter counterpart 350, and to defeat the releasable coupling of the first adapter counterpart 302 and the second adapter counterpart 350.

In some embodiments, for example, the actuator assembly 106 includes a linear actuator. In some embodiments, for example, the actuator assembly 106 includes a rotating actuator. In some embodiments, for example, the actuator assembly 106 includes an electrical actuator. In some embodiments, for example, the actuator assembly 106 includes a pneumatic actuator. In some embodiments, for example, the actuator assembly 106 includes a hydraulic actuator. In some embodiments, for example, the displacement of the robot arm 110 via activation of the actuator assembly 106 includes extension, retraction, displacement, rotation, and pivoting of the robot arm 110.

In some embodiments, for example, each one of the actuators of the actuator assembly 106, independently, is configured to send data representative of its operational state (e.g. activated, deactivated, or degree of activation) to the controller 102 for the controller 102 to control the operation of the robot arm 110.

In some embodiments, for example, the actuators of the actuator assembly 106 of the apparatus 100 are mounted on the robot arm 110 and are disposed in operable communication with the robot arm 110.

The apparatus 100 includes an object manipulator 101, which includes a robot arm 110 that is disposed in operable communication with the actuator assembly 106.

In some embodiments, for example, the object manipulator 101a base 502 that is connected to the robot arm 110. In some embodiments, for example, the base is mounted to the frame of the towing vehicle 13, such that the base is secured to the frame of the towing vehicle 13. In some embodiments, for example, the base is connected to the frame of the towing vehicle 13 such that the base is slidable, via the actuator assembly 106, along a direction that is parallel to a longitudinal axis of the towing vehicle 13 (e.g. axis extending from the front to back of the towing vehicle 13), a direction that is parallel to a lateral axis of the towing vehicle 13 (e.g. axis extending from one side of the towing vehicle 13 to the other), a direction that is parallel to a vertical axis, or a combination thereof.

In some embodiments, for example, the robot arm 110 is pivotable relative to the base 502, via the actuator assembly 106, about one or more degrees of freedom, for example, two or three degrees of freedom. In some embodiments, for example, the robot arm 110 is pivotable relative to the base about the longitudinal axis, the lateral axis, or the vertical axis, or a combination thereof.

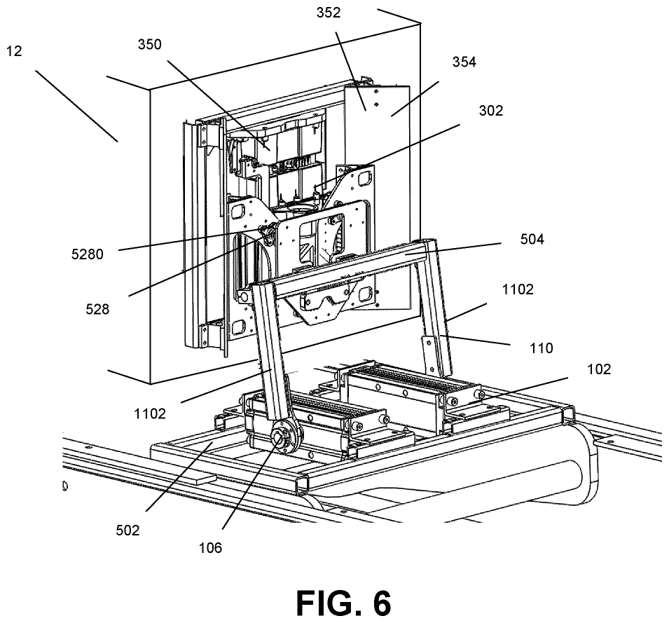

In some embodiments, for example, as depicted in FIG. 5 and FIG. 6, the robot arm 110 includes one or more robot arm segments 1102. In some embodiments, for example, the robot arm 110 includes a first arm segment 1102 and a second arm segment 1102 that are operably connected, for example, pivotably connected.

In some embodiments, for example, the actuator assembly 106 is activatable to displace the first arm segment 1102 relative to the second arm segment 1102, for example, extension, retraction, rotation, or pivoting, for displacing the robot arm 110.

In some embodiments, for example, the actuator assembly 106 is activatable to control the apparatus 100, for: i) releasably coupling the first adapter counterpart 302 and the second adapter counterpart 350, ii) releasing the first adapter counterpart 302 after the first adapter counterpart 302 is releasably coupled to the second adapter counterpart 350, iii) coupling with the first adapter counterpart 302 while the first adapter counterpart 302 is releasably coupled to the second adapter counterpart 350, or while there is an absence of coupling between the first adapter counterpart 302 and the second adapter counterpart 350, and iv) decoupling the first adapter counterpart 302 and the second adapter counterpart 350.

FIG. 5 to FIG. 11 depict an embodiment of the apparatus 100 for releasably coupling and uncoupling the first adapter counterpart 302 and the second adapter counterpart 350. As depicted, in some embodiments, for example, the apparatus 100 is a catapult-style apparatus. The apparatus 100 is configured to displace the first adapter counterpart 302 in an arcuate path, and then in a vertical direction, to releasably couple the first adapter counterpart 302 and the second adapter counterpart 350, such that the first adapter counterpart 302 and the second adapter counterpart 350 are disposed in operable communication. In some embodiments, for example, the apparatus 100 is mounted to the towing vehicle 13, for example, to the frame of the towing vehicle 13. In some embodiments, for example, the towing vehicle 13 includes the apparatus 100.

The object manipulator 101, which includes the robot arm 110 and the base 502, are co-operatively configured such that, while the towing vehicle 13 is releasably coupled to the dock 12 via the fifth wheel coupling 2 and the locking pin 14, the object manipulator 101 is displaceable, via the actuator assembly 106, between a actuation-ineffective position, wherein the first adapter counterpart 302 and the second adapter counterpart 350 are co-operatively disposed in a misaligned relationship, as depicted in FIG. 5, and an actuation-ready position, wherein the first adapter counterpart 302 and the second adapter counterpart 350 are co-operatively disposed in an aligned relationship, as depicted in FIG. 6.

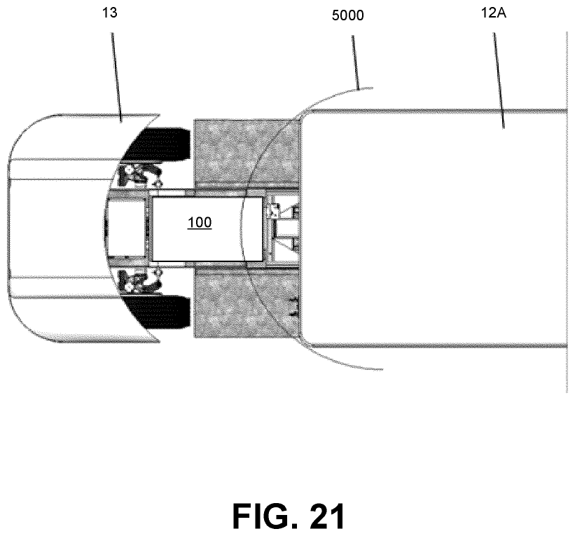

In some embodiments, for example, while the object manipulator 101 is disposed in the actuation-ineffective position, the robot arm 110 is disposed outside a swing radius 5000 of a trailer 12A that is couplable to the towing vehicle 13 via the fifth wheel coupling 2 and a locking pin of the trailer 12A, as depicted in FIG. 21. While the object manipulator 101 is disposed in the actuation-ineffective position, the coupler 513 and the second adapter counterpart 350 not disposed in alignment, such that releasably coupling or decoupling of the first adapter counterpart 302 and the second adapter counterpart 350 is not effectible. While the first adapter counterpart 302 is releasably coupled to the housing 512, and while the object manipulator 101 is disposed in the actuation-ineffective position, the first adapter counterpart 302 and the second adapter counterpart 350 are not disposed in alignment, such that releasably coupling or decoupling of the first adapter counterpart 302 and the second adapter counterpart 350 is not effectible.

In some embodiments, for example, while the object manipulator 101 is disposed in the actuation-ready position, the object manipulator 101 is disposed relative to the dock 12 such that the housing 512 and the second adapter counterpart 350 are disposed in alignment, such that releasably coupling or decoupling of the first adapter counterpart 302 and the second adapter counterpart 350 is effectible. While the first adapter counterpart 302 is releasably coupled to the housing 512, and while the object manipulator 101 is disposed in the actuation-ready position, the first adapter counterpart 302 and the second adapter counterpart 350 are disposed in alignment, such that releasably coupling of the first adapter counterpart 302 and the second adapter counterpart 350 is effectible, for example, via displacement of the first adapter counterpart 302, relative to the second adapter counterpart 350, in a direction towards the second adapter counterpart 350. In some embodiments, for example, the displacement of the first adapter counterpart 302, relative to the second adapter counterpart 350, in a direction towards the second adapter counterpart 350, is an axial displacement. While the first adapter counterpart 302 is releasably coupled to the second adapter counterpart 350, and while the object manipulator 101 is disposed in the actuation-ready position, the coupler 513 and the first adapter counterpart 350 are disposed in alignment, such that releasably coupling of the coupler 513 and the first adapter counterpart 302, for defeating the releasable coupling of the first adapter counterpart 302 and the second adapter counterpart 350, is effectible, for example, via displacement of the coupler 513, relative to the first adapter counterpart 302, in a direction towards the first adapter counterpart 302. In some embodiments, for example, the displacement of the coupler 513, relative to the first adapter counterpart 302, in a direction towards the first adapter counterpart 302, is an axial displacement. In some embodiments, for example, while the object manipulator 101 is disposed in the actuation-ready position, an outer surface 5120 of the housing 512, an outer surface 5120 of the housing 512 is configured in opposing relationship with the dock 12, and is engaged with an inner surface 17 of the guide 352, wherein the inner surface 17 is disposed between the inclined channel walls 3542 of the channel 354 . . . . In some embodiments, for example, while the object manipulator 101 is disposed in the actuation-ready position, the outer surface 5120 of the housing 512 is flush against the surface 17 of the guide 352.

In some embodiments, for example, the arm segments 1102 of the robot arm 110 of the object manipulator 101 are pivotably connected, at a first end, to the base 502. In some embodiments, for example, the controller 102 is configured to send a control command to the actuator assembly 106 to displace the robot arm 110, with effect that the arm segments 1102 pivot about the base 502. In some embodiments, for example, the displacement of the object manipulator 101 from the actuation-ineffective position to the actuation-ready position is displacement of the object manipulator 101 towards the dock 12. In some embodiments, for example, the displacement of the object manipulator 101 from the actuation-ready position to the actuation-ineffective position is displacement of the object manipulator 101 away from the dock 12. In some embodiments, for example, the displacement of the object manipulator 101 is along an arcuate path.

The robot arm 110 of the object manipulator 101 includes a crossbar 504 that connects the second ends of the arm segments 1102 of the robot arm 110. An end effector 510 of the object manipulator 101 is coupled to the crossbar 504.

In some embodiments, for example, the end effector 510 is configured to releasably couple with the first adapter counterpart 302, for example, via the coupler 513 that is housed in the housing 512. In some embodiments, for example, while the first adapter counterpart 302 is releasably coupled to the coupler 513, the first adapter counterpart 302 is releasably coupled to the end effector 510. While the first adapter counterpart 302 is releasably coupled to the end effector 510, the first adapter counterpart 302 is connectible to the second adapter counterpart 350 via the apparatus 100. In some embodiments, for example, while the first adapter counterpart 302 is being displaced relative to the second adapter counterpart 350 for disposing the first adapter counterpart 302 and the second adapter counterpart 350 in operable communication, if there is misalignment between the first adapter counterpart 302 and the second adapter counterpart 350, the end effector 510 and the housing 512 are co-operatively configured such that an alignment relationship-obtaining displacement of the first adapter counterpart 302, relative to the second adapter counterpart 350, is effectible, such that the first adapter counterpart 302 becomes aligned with the second adapter counterpart 350 for disposition in operable communication.

In some embodiments, for example, the apparatus 100 includes a first adapter counterpart housing 512. The housing 512 is coupled to the end effector 510, such that the housing 512 is displaceable relative to the robot arm 110, via the end effector 510. As depicted in FIG. 5 and FIG. 10, the housing 512 includes a coupler 513 that is configured to releasably couple with the first adapter counterpart 302. In some embodiments, for example, an actuator 514 of the actuator assembly 106 is mounted to the housing 512. In some embodiments, for example, the actuator 514 is housed in the housing 512.

The housing 512 includes the coupler 513. In some embodiments, for example, the coupler 513 is configured to releasably couple with the first adapter counterpart 302 such that the first adapter counterpart 302 is releasably couplable to the second adapter counterpart 350 via the apparatus 100. In some embodiments, for example, the coupler 513 includes the first connector counterpart 232 for releasably coupling with the second connector counterpart 315 of the first adapter counterpart 302.

In some embodiments, for example, the coupler 513 is configured to be displaced, relative to the housing 512, for example, displaced outwardly and displaced inwardly, relative to the housing 512. In this respect, in some embodiments, for example, the coupler 513 is operably coupled to the actuator 514. In some embodiments, for example, the actuator 514 is a linear actuator. In some embodiments, for example, while the coupler 513 is releasably coupled with the first adapter counterpart 302, the actuator 514 is operable coupled to the first adapter counterpart 302, via the operable coupling to the coupler 513. In some embodiments, for example, while the coupler 513 is releasably coupled with the first adapter counterpart 302, the actuator 514 is activatable to displace the coupler 513, relative to the housing 512, for example, a displacement out of the housing 512, or a displacement into the housing 512. In some embodiments, for example, while the first adapter counterpart 302 is releasably coupled to the coupler 513, the actuator 514 is activatable to displace the first adapter counterpart 302, relative to the housing 512, via displacement of the coupler 513, for example, a displacement out of the housing 512, or a displacement into the housing 512. In some embodiments, for example, in response to emplacement of the first adapter counterpart 302 and the second adapter counterpart 350 in the alignment relationship, the connection of the first adapter counterpart 302 with the second adapter counterpart 350 is effectuatable in response to displacement of the first adapter counterpart 302, relative to the second adapter counterpart 350, in a direction towards the second adapter counterpart 350, by the actuator 514.

In some embodiments, for example, the coupler 513 and the actuator 514 are activatable, for example, by the controller 102, to control the apparatus 100, for: i) releasably coupling the first adapter counterpart 302 and the second adapter counterpart 350, ii) releasing the first adapter counterpart 302 after the first adapter counterpart 302 is releasably coupled to the second adapter counterpart 350, iii) coupling with the first adapter counterpart 302, and iv) decoupling the first adapter counterpart 302 and the second adapter counterpart 350.

In some embodiments, the housing 512 defines an opening 516. In some embodiments, for example, the coupler 513 is extendible and retractable through the opening 516 to effect, for example, the releasable coupling of the first adapter counterpart 302 and the second counterpart, the releasing of the first adapter counterpart 302 after the first adapter counterpart 302 is releasably coupled to the second adapter counterpart 350, the coupling with the first adapter counterpart 302 while the first adapter counterpart 302 is releasably coupled to the second adapter counterpart 350, or while there is an absence of coupling between the first adapter counterpart 302 and the second adapter counterpart 350, and the decoupling the first adapter counterpart 302 and the second adapter counterpart 350.

In some embodiments, for example, as depicted in FIG. 6, after the housing 512 is displaced towards the dock 12 and in the object manipulator 101 is disposed in the actuation-ready configuration, the second adapter counterpart 350 is disposed in opposing relationship relative to the opening 516, such that the releasable coupling of the first adapter counterpart 302 and the second counterpart, the releasing of the first adapter counterpart 302 after the first adapter counterpart 302 is releasably coupled to the second adapter counterpart 350, the coupling with the first adapter counterpart 302, and the decoupling the first adapter counterpart 302 and the second adapter counterpart 350, are effectible.

In some embodiments, for example, while the robot arm 110 is displacing the housing 512 towards the dock 12, gravitational forces acting on the housing 512 effect pivoting of the housing 512 relative to the crossbar 504, with effect that the opening 516 is facing upwards. In some embodiments, for example, while the object manipulator 101 is in the actuation-ready position, the opening 516 is facing upwards.

As depicted in FIG. 5 to FIG. 8 and FIG. 11, the end effector 510 includes a first spring assembly 522 comprising springs 5220 disposed between the arm segments 1102 and extending in a direction parallel to the crossbar 504. As depicted, the spring assembly 522 comprises one or more springs 5220, for example, two springs 5220. The spring assembly 522 biases the housing 512 to a central position. As depicted, the two springs 5220 are disposed in the horizontal orientation. In response to a force applied to the housing 512 in the horizontal direction, the two springs 522 disposed in the horizontal orientation allow for the housing 512 and the arm segments 1102 to displace relative to each other in the horizontal direction. In some embodiments, for example, the relative displacement is the displacement of the housing 512 relative to the arm segments 1102. Accordingly, in some embodiments, for example, the spring assembly 522 allows for the housing 512 to displace relative to the arm segments 1102 about one degree of freedom, for example, in the horizontal direction (i.e. lateral direction).

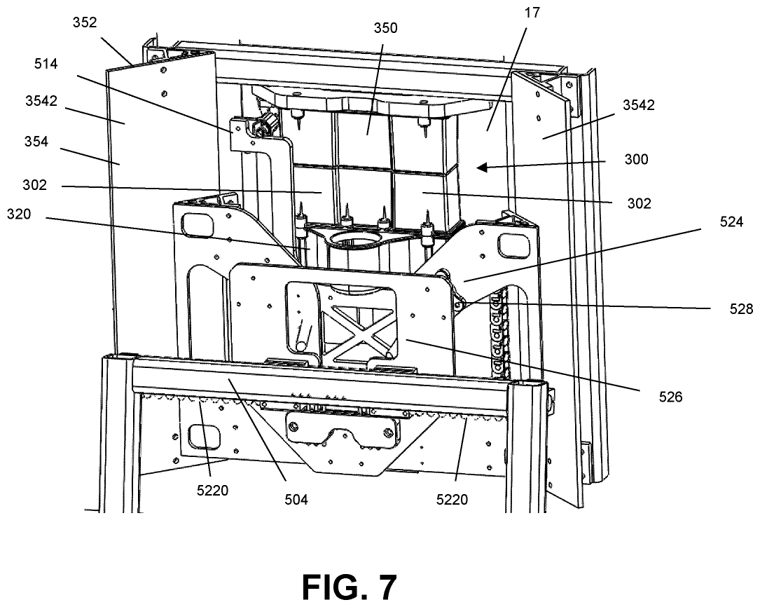

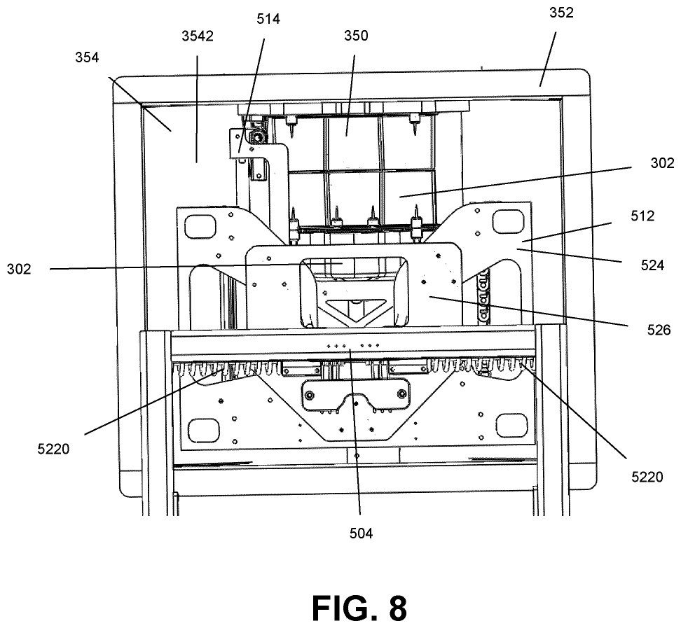

As depicted in FIG. 7 and FIG. 8, the housing 512 includes a first plate 524, and the end effector 510 includes a second plate 526. As depict, the second plate 526 is coupled to the crossbar 504, and pivotably coupled to the first plate 3224, such that pivoting of the housing 512, relative to the crossbar 3204, is effectible. In some embodiments, for example, as the robot arm 110 transitions from the actuation-ineffective positon to the actuation-ready position and the outer surface 5120 of the housing 512 becomes disposed in engagement with the inner surface 17 of the dock 12, the outer surface of the housing 512 applies a force to the inner surface 17. In response to application of the force by the outer surface 5120 of the housing 512 to the inner surface 17 of the guide 352, the inner surface 17 applies urging reaction force to the housing 512. In response to said reaction force, the housing 512 rotates, relative to the crossbar 504, due to the pivotable coupling of the housing 512 relative to the crossbar 504, such that the opening 516 becomes disposed in opposing relationship with the second adapter counterpart 350 for effecting coupling of the second adapter counterpart 350 and the first adapter counterpart 302. Accordingly, in some embodiments, for example, the pivotable coupling of the housing 512 relative to the crossbar 504 is such that the displacement of the housing 512, relative to the crossbar 504 about one degree of freedom, for example, rotation about an axis extending in a lateral direction, is effectible.

As depicted in FIG. 5, FIG. 6, and FIG. 11, the end effector 510 includes a second spring assembly 528 for connecting the end effector 510 and the housing 512. In some embodiments, for example the second spring assembly 528 connects the first plate 524 and the second plate 526. As depicted, the second spring assembly 528 comprises one or more springs 5280, for example, three springs 5280. While two springs 5280 are depicted, in some embodiments, for example, the third spring 5280 is disposed at a bottom end and middle of the housing 512, between the first plate 524 and the second plate 526. The spring assembly 528 biases the first plate 524 and the second plate 526 such that the first plate 524 and the second plate 526 are disposed in alignment. In response to a force applied to the housing 512, the springs 5280 allow the first plate 524 and the second plate 526 to rotate relative to each other, for example, rotate about a longitudinal axis (e.g. roll), a lateral axis (e.g. pitch), a vertical axis (e.g. yaw), or a combination thereof. In some embodiments, for example, the relative displacement is displacement of the first plate 524 relative to the second plate 526. In some embodiments, for example, the relative displacement is displacement of the second plate 526 relative to the first plate 524. In some embodiments, for example, the relative displacement is effected by displacement of both of the first plate 524 and the second plate 526. Accordingly, in some embodiments, for example, the spring assembly 528 allows for the housing 512 to displace relative to the arm segments 1102 about three degrees of freedom. In some embodiments, for example, the springs 5280 are sufficiently displaceable such that the springs 5280 such that they permit displacement of the housing 512 with six degrees of freedom, for example, displacement in a direction parallel to the longitudinal axis, the lateral axis, or the vertical axis, or rotation about the longitudinal axis, the lateral axis, or the vertical axis.

In some embodiments, for example, the end effector 510 allows the housing 512 and the first adapter counterpart 302, while the first adapter counterpart 302 is releasably coupled to the actuator 514, to displace about four degrees of freedom, via the spring assembly 522 and the spring assembly 528. In some embodiments, for example, the robot arm 110 effects displacement of the end effector 510 about one degree of freedom, namely, towards and away from the dock 12. In some embodiments, for example, the actuator 514 effects displacement of the first adapter counterpart 302 about one degree of freedom, namely, vertical displacement of the first adapter counterpart 302. Together, the apparatus 3200 allows the first adapter counterpart 302 to displace about six degrees of freedom.

The coupling of the end effector 510 to the robot arm 110, for example, via the crossbar 504, is with effect that the end effector 510 is displaceable relative to the robot arm 110, such that the coupling relationship between the end effector 510 and the robot arm 110 is a relative movement-permissive coupling relationship. In some embodiments, for example, the relative movement is permitted by the first spring assembly 522 and the second spring assembly 528.

In some embodiments, for example, the coupling of the housing 512 to the end effector 510 is with effect that the housing 512 is displaceable relative to the end effector 510, such that the coupling relationship between the housing 512 and the end effector 510 is a relative movement-permissive coupling relationship. In some embodiments, for example, the relative movement is permitted by the first spring assembly 522 and the second spring assembly 528.

In some embodiments, for example, the housing 512 is coupled to the end effector 510, and the housing 512, the end effector 514, and the robot arm 110 are co-operatively configured such that the displaceability of the housing 512, relative to the robot arm 110, is effectuated via the displaceability of the end effector 510 relative to the robot arm 110. In some embodiments, for example, the first adapter counterpart 302 is coupled to the end effector 510, for example, via the housing 512 and the coupler 513, and the first adapter counterpart 302, the end effector 514, and the robot arm 110 are co-operatively configured such that the displaceability of the first adapter counterpart 302, relative to the robot arm 110, is effectuated via the displaceability of the end effector 510 relative to the robot arm 110.

In some embodiments, for example, the housing 512 is coupled to the end effector 510, and the housing 512, the end effector 514, and the robot arm 110 are co-operatively configured such that the displaceability of the housing 512, relative to the robot arm 110, is effectuated via the displaceability of the housing 512 relative to the end effector 510.

In some embodiments, for example, the apparatus 100 is configured to align the first adapter counterpart 302 and the second adapter counterpart 350 to effect releasably coupling of the first adapter counterpart 302 and the second adapter counterpart 350 such that the first adapter counterpart 302 and the second adapter counterpart 350 are disposed in operable communication. In this respect, in some embodiments, for example, the housing 512 includes a first surface configuration counterpart, for example, two side walls 518, wherein each of the side walls 518, independently, includes an inclined surface 520, and the guide 352 for example, the channel 354, includes a second surface configuration counterpart, for example, the inclined channel walls 3542, each inclined channel wall 3542 defining an inclined surface. In some embodiments, for example, the inclined surface 520 is an inclined planar surface, and the inclined surface of the channel wall 3542 is an inclined planar surface.

In some embodiments, for example, the first surface configuration counterpart and the first adapter counterpart 302 are co-operatively configured such that guiding of the alignment relationship-obtaining displacement of the first adapter counterpart 302, and of the housing 512, is effectible by co-operation between the first surface configuration counterpart defined by the housing 512 and the second surface configuration counterpart defined by the guide 352.

As depicted in FIG. 5 to FIG. 9 and FIG. 11, the inclined surfaces 520 of the side walls 518 incline away from the center of the housing 512, and the inclined surfaces of the channel walls 3542 are inclined towards the second adapter counterpart 350. In some embodiments, for example, the inclined surfaces 520 of the side walls 518 and the inclined surfaces of the channel walls 3542 are co-operatively configured to align the first adapter counterpart 302 and the second adapter counterpart 350, for example, along a vertical axis, to effect, for example, the releasable coupling of the first adapter counterpart 302 and the second adapter counterpart 350. In some embodiments, for example, the inclined surfaces 520 of the side walls 518 and the inclined surfaces of the channel walls 3542 are co-operatively configured to center the first adapter counterpart 302 and the second adapter counterpart 350 to effect the releasable coupling of the first adapter counterpart 302 and the second adapter counterpart 350. In some embodiments, for example, the inclined surfaces 520 of the side walls 518 and the inclined surfaces of the channel walls 3542 are co-operatively configured to align the first adapter counterpart 302 and the second adapter counterpart 350, for example, along a linear axis, such as a vertical axis to effect, for example, the releasable coupling of the first adapter counterpart 302 and the second adapter counterpart 350. In some embodiments, for example, the inclined surfaces 520 of the side walls 518 and the inclined surfaces of the channel walls 3542 are co-operatively configured to center the housing 512, for example, the coupler 513, and the second adapter counterpart 350, to effect, for example, the releasable coupling of the first adapter counterpart 302 and the second adapter counterpart 350. In some embodiments, for example, the inclined surfaces 520 of the side walls 518 and the inclined surfaces of the channel walls 3542 are co-operatively configured to center the first adapter counterpart 302 and the second adapter counterpart 350 to effect, for example, the releasable coupling of the first adapter counterpart 302 and the second adapter counterpart 350.

In some embodiments, for example, while the towing vehicle 13 and the dock 12 are coupled (e.g. via the fifth wheel 2 is coupled to the fifth wheel guiding counterpart 14 of the dock 12 (e.g. the kingpin), and while the first adapter counterpart 302 is releasably coupled to the coupler 513, the first adapter counterpart 302 and the second adapter counterpart 350 are connectible, via the apparatus 100, for effecting disposition of the first adapter counterpart 302 and the second adapter counterpart 350 in operable communication. In some embodiments, for example, while the fifth wheel coupling relationship is established, the towing vehicle 13 and the dock 12 are aligned.

In such embodiments, for example, to couple the first adapter counterpart 302 and the second adapter counterpart 350, the detector 104 detects a signal for the apparatus 100 to initiate the coupling process, for example, a signal provided by an operator of the towing vehicle 13, or a signal representative of the coupling of the towing vehicle 13 and the dock 12 via the fifth wheel 2 and the fifth wheel guiding counterpart 14, or a signal representative of an absence of coupling between the first adapter counterpart 302 and the second adapter counterpart 350. While the object manipulator 101 is disposed in the actuation-ineffective position and releasably coupled with the first adapter counterpart 302 via the coupler 513 of the housing 512, wherein the first adapter counterpart 302 and the second adapter counterpart 350 are co-operatively disposed in the misaligned relationship, the controller 102 sends a control command to the actuator assembly 106 to pivot the robot arm 110, via the base 502, towards the dock 12, until the outer surface 5120 of the housing 512 engages the surface 17 of the guide 352. The detector 104 detects that the outer surface 5120 is engaged to the surface 17. In response to detection that the outer surface 5120 of the housing 512 is engaged to the surface 17, the controller 102 sends a control command to the actuator assembly 106 to stop displacement of the robot arm 110. At this point, the object manipulator 101 is disposed in the actuation-ready position.

In some embodiments, for example, in response to transition of the object manipulator 101 in the actuation-ineffective position to the actuation-ready position, the housing 512 is disposed between the channel walls 3542, and the first adapter counterpart 302 is disposed below the second adapter counterpart 350. In some embodiments, for example, while the object manipulator 101 is disposed in the actuation-ready position, the first adapter counterpart 302 and the second adapter counterpart 350 are disposed in alignment for effecting releasable coupling of the first adapter counterpart 302 and the second adapter counterpart 350, for establishing connection between the first adapter counterpart 302 and the second adapter counterpart 350. In some embodiments, for example, the first adapter counterpart 302 and the second adapter counterpart 350 are disposed in alignment along the axis 3600. In some embodiments, for example, the axis 3600 is parallel to a vertical axis.

At this point, the controller 102 sends a control command to the actuator 514 to displace the coupler 513 towards the second adapter counterpart 350, for example, in an upwardly direction, with effect that the first adapter counterpart 302 is displaced towards the second adapter counterpart 350, for example, in an upwardly direction. In some embodiments, for example, the displacement is an axial displacement. In some embodiments, for example, the displacement is along a displacement axis. In some embodiments, for example, the displacement axis is a linear axis. In response to displacement of the first adapter counterpart 302 towards the second adapter counterpart 350 by the actuator 514, the guide pins 312 of the first adapter counterpart 302 are received into the guide ports 3120 of the second adapter counterpart 350 to guide the displacement of the first adapter counterpart 302 towards the second adapter counterpart 350. In response to further displacement, for example, axial displacement, of the first adapter counterpart 302 towards the second adapter counterpart 350, the electrical connectors 308 become disposed in the electrical ports 3080, the fluid connectors 310 become disposed in the fluid ports 3100, and the data connectors 314 become disposed in the data ports 3140, as depicted in FIG. 7 to FIG. 10, which effects: (i) electrical communication between the one or more dock communicator-defined electrical conductors 1204 and the one or more towing vehicle communicator-defined electrical conductors 1304, (ii) fluid communication between the one or more dock communicator-defined fluid conductors 1202 and the corresponding one or more towing vehicle communicator-defined fluid conductors 1302, and (iii) data communication between the one or more dock communicator-defined data conductors 1205 and the corresponding one or more towing vehicle communicator-defined data conductors 1305. At this point, the first adapter counterpart 350 and the second adapter counterpart 350 are connected. This effects establishment of: (i) electrical communication between the one or more electrical energy storage devices 16 of the towing vehicle 13 and the corresponding one or more electrical energy sources 15 of the dock 12, (ii) fluid communication between the one or more fluid energy storage devices 16 of the towing vehicle 13 and the corresponding one or more fluid energy sources 15 of the dock 12, and (iii) data communication between the data communication devices of the towing vehicle 13 and the data communication devices of the dock 12, for replenishing the energy storage devices of the towing vehicle 13.

In some embodiments, for example, while the guide pins 312 of the first adapter counterpart 302 are received into the guide ports 3120 of the second adapter counterpart 350, in response to the further displacement of the first adapter counterpart 302 towards the second adapter counterpart 350, the screw 313 is received in the screw port 3130. While the screw 313 is received in the screw port 3130, the controller 102 sends a control command to an actuator of the first adapter counterpart 302 to drive rotation of the screw 313, for engaging with the screw port 3130, with effect that the connection of the first adapter counterpart 302 and the second adapter counterpart 350 is retained.

In some embodiments, for example, the controller 102, the detector 104, the actuator assembly 106, the adapter 300, and the robot arm 110 are co-operatively configured such that, in response to the releasable coupling of the first adapter counterpart 302 and the second adapter counterpart 350, the controller 102 activates the actuator 242 to uncouple the coupler 513 from the first adapter counterpart 302, and the controller 102 activates the actuator 514 to retract the coupler 513, for example, in a downward direction, such that the coupler 513 is displaced towards the base 502. The retraction of the coupler 513 is with effect that the coupler 513 is received in the housing 512. At this point, as depicted in FIG. 11, the controller 102 activates the actuator assembly 106 to pivot the robot arm 110, via the base 502, away from the dock 12, such that the object manipulator 101 is disposed in the actuation-ineffective position.

In some embodiments, for example, the detector 104 detects a signal representative of the releasable coupling of the first adapter counterpart 302 and the second adapter counterpart 350, and, in response to the detection, the controller 102 stops further displacement of the coupler 513 towards the second adapter counterpart 350. Then, the controller 102 activates the actuator 242 to uncouple the coupler 513 from the first adapter counterpart 302, and the controller 102 activates the actuator assembly 106 to retract the coupler 513 and displace the object manipulator 101 to the actuation-ineffective position.

In some embodiments, for example, after the first adapter counterpart 302 and the second adapter counterpart 350 are connected, for example, releasably coupled, operable communication between the energy sources 15 and data communication devices of the dock 12 and the energy storage devices 16 and data communication devices of the towing vehicle 13, is established, via the adapter 300, such that energy is transferrable from the energy source to the energy storage device. In this respect, in some embodiments, for example, the towing vehicle 13 and the dock 12 are disposed in operable communication via the adapter 300. While operable communication between the energy sources 15 and data communication devices of the dock 12 and the energy storage devices 16 and data communication devices of the towing vehicle 13, via the adapter 300, is established, the controller 102 sends a control command to the energy sources 15 and data communication devices of the dock 12, via the one or more dock communicator-defined data conductors 1205 and the one or more towing vehicle communicator-defined data conductors 1305, to effect the transfer of one or more kinds of energy (e.g. diesel, hydrogen, natural gas, pneumatic gas, electricity) from the energy source 15 to the energy storage device 16 of the towing vehicle 13 via the adapter 300, the one or more dock communicator-defined fluid conductors 1202, the one or more towing vehicle communicator-defined fluid conductors 1302, the one or more dock communicator-defined electrical conductors 1204, and the one or more towing vehicle communicator-defined fluid conductors 1304, to replenish the energy storage devices of the towing vehicle 13. In some embodiments, for example, it is a controller of the towing vehicle that sends the control command to the to the energy sources 15 and data communication devices of the dock 12 to effect the transfer of one or more kinds of energy (e.g. diesel, hydrogen, natural gas, pneumatic gas, electricity, etc.) from the energy source 15 to the energy storage device 16 of the towing vehicle 13. In some embodiments, for example, the energy storage devices of the towing vehicle 13 are replenished while the first adapter counterpart 302 and the second adapter counterpart 350 are releasably coupled, and also while the coupler 513 is releasably coupled to the first adapter counterpart 302. In some embodiments, for example, after the first adapter counterpart 302 and the second adapter counterpart 350 are releasably coupled, the coupler 513 is retracted and the object manipulator 101 is displaced to the actuation-ineffective position, and then the energy storage devices 16 of the towing vehicle 13 are replenished.

In some embodiments, for example, the emplacement of the first adapter counterpart 302 and the second adapter counterpart 350 in the alignment relationship is obtained while the fifth wheel 2 is coupled to the fifth wheel guiding counterpart 14 of the dock 12 (e.g. the kingpin), such that a fifth wheel coupling relationship is established.

After it is determined by the controller 102 or the controller of the towing vehicle 13, for example, that the energy storage devices 16 of the towing vehicle 13 are replenished, for example, via detection of the capacity of the energy storage devices 16, it is desirable to decouple the first adapter counterpart 302 from the second adapter counterpart 350.

To disconnect or decouple the first adapter counterpart 302 from the second adapter counterpart 350, the detector 104 detects a signal for the apparatus 100 to initiate the decoupling process, for example, a signal provided by an operator of the towing vehicle 13, or a signal representative of the coupling of the towing vehicle 13 and the dock 12, or a signal representative of the connection between the first adapter counterpart 302 and the second adapter counterpart 350, or a signal that the one or more energy storage devices of the towing vehicle 13 are replenished. The robot arm 110 is pivoted to transition the object manipulator 101 from the actuation-ineffective position to the actuation-ready position, wherein the housing 512 is engaged with the surface 17 and the coupler 513 is aligned with the first adapter counterpart 302, which is coupled to the second adapter counterpart 350. The controller 102 sends a control command to the actuator 514 to displace the coupler 513 towards the first adapter counterpart 302, such that the guide pins 316 of the second connector counterpart 315 are inserted into the receiving ports 236 of the first connector counterpart 232. Further displacement of the coupler 513 towards the first adapter counterpart 302 is with effect that the spring-loaded latch is actuated, with effect that the coupler 513 is coupled to the first adapter counterpart 302. In some embodiments, for example, the displacement of the coupler 513 is an axial displacement. In some embodiments, for example, the displacement is along a displacement axis. In some embodiments, for example, the displacement axis is a linear axis. Then, the controller 102 sends a control command to the actuator of the first adapter counterpart 302 to rotate the screw 313, relative to the screw port 3130, to defeat the retention of the releasable coupling of the first adapter counterpart 302 and the second adapter counterpart 350. While the retention of the releasable coupling of the first adapter counterpart 302 and the second adapter counterpart 350 is defeated, the controller 102 sends a control command to the actuator 514 to displace the coupler 513 away from the second adapter counterpart 350 to displace the first adapter counterpart 302 away from the second adapter counterpart 350, with effect that the first adapter counterpart 302 and the second adapter counterpart 350 is disconnected, such that the operable communication between the first adapter counterpart 302 and the second adapter counterpart 350 is defeated, and with further effect the first adapter counterpart 302 is received in the housing 512. At this point, the controller 102 sends a control command to the actuator assembly 106 to pivot the robot arm 110 to transition the object manipulator 101 to the actuation-ineffective position. At this point, in some embodiments, for example, the connection between the fifth wheel coupling 2 and the kingpin 14 is defeated, such that the towing vehicle 13 is decoupled from the dock 12, and the towing vehicle 13 can be operated to displace away from the dock 12.

In some embodiments, for example, while the towing vehicle 13 is releasably coupled to the dock 12, for example, via the fifth wheel 2 and the fifth wheel guiding counterpart 14 of the dock 12 (e.g. the kingpin), such that the fifth wheel coupling relationship is established, the towing vehicle 13 and the dock 12 are misaligned, for example, due to the gradient of the ground on which the towing vehicle 13 and the dock 12 are supported. In such embodiments, for example, while the first adapter counterpart 302 is releasably coupled to the coupler 513, the first adapter counterpart 302 and the second adapter counterpart 350 are connectible, via the apparatus 100, for effecting disposition of the first adapter counterpart 302 and the second adapter counterpart 350 in operable communication.

In such embodiments, for example, in response to displacement of the robot arm 110 towards the dock 12, to transition the object manipulator 101 from the actuation-ineffective position to the actuation-ready position, due to the misalignment of the towing vehicle 13 and the dock 12, the displacement of the object manipulator 101 towards the dock 12 is with effect that one of the side walls 518 of the housing 512 becomes disposed proximate to, or becomes disposed in engagement with, a corresponding inclined surface of one of the channel walls 3542 instead of the housing 512 being received between the channel walls 3542. In some embodiments, for example, while the housing 512 becomes disposed proximate to, or becomes disposed in engagement with, the guide 352, for example, the channel 354, the housing 512 is disposed in a guiding-effective relationship with the guide 352. In some embodiments, for example, the housing 512 is disposed in a guiding-effective relationship with the guide 352 while the displacement of the housing 512 is guidable, by the guide 352. In some embodiments, for example, while the housing 512 is disposed in the guiding-effective relationship with the guide 352, and the first adapter counterpart 302 is releasably coupled to the coupler 513, the first adapter counterpart 302 is disposed in a guiding-effective relationship with the guide 352. In some embodiments, for example, the first adapter counterpart 302 is disposed in a guiding-effective relationship with the guide 352 while the displacement of the first adapter counterpart 302 is guidable, by the guide 352.

In some embodiments, for example, while the housing 512 is disposed in engagement with the guide 352, a surface configuration counterpart of the housing 512 is disposed in engagement with a surface configuration counterpart of the guide 352. In some embodiments, for example, the surface configuration counterpart of the housing 512 is defined by a surface of the housing 512, for example, by the inclined surfaces 520 of the side walls 518.

In some embodiments, for example, the surface configuration counterpart of the guide 352 is defined by a surface of one or more of the inclined surfaces of the channel wall 3542.

In response to further displacement of the object manipulator 101 towards the dock 12, the inclined surface 520 of the side wall 518 applies a force on the inclined surface of the channel wall 3542, and the inclined surface of the channel wall 3542 applies a reaction force to the inclined surface 520. Due to the inclination of the inclined surface 520 of the side wall 518 that are inclined away from the center of the housing 512, and the inclination of the inclined surface of the channel wall 3542 that are inclined towards the second adapter counterpart 350, the reaction force applied by the inclined surface of the channel wall 3542 on the inclined surface 520 has a direction towards the second adapter counterpart 350. In some embodiments, for example, the reaction force applied by the inclined surface of the channel wall 3542 on the inclined surface 520 has a direction towards the surface 17. In some embodiments, for example, the reaction force applied by the inclined surface of the channel wall 3542 on the inclined surface 520 has a direction towards the center of the guide 352. In response to the reaction force from the inclined surface of the channel wall 3542, the housing 512 and the first adapter counterpart 302 are displaced in the direction of the reaction force, for example, a direction towards the second adapter counterpart 350. In some embodiments, for example, the alignment relationship-obtaining displacement of the housing 512 includes said displacement of the housing 512, relative to the second adapter counterpart 350. In some embodiments, for example, the alignment relationship-obtaining displacement of the first adapter counterpart 302 includes said displacement of the first adapter counterpart 302, relative to the second adapter counterpart 350. In some embodiments, for example, the alignment relationship-obtaining displacement is guidable, by the guide 352, for example, the channel 354. In some embodiments, for example, the guided displacement is effective for emplacing the first adapter counterpart 302 in alignment with the second adapter counterpart 350, such that the first adapter counterpart 302 and the second adapter counterpart 350 become disposed in an alignment relationship for establishing connection between the first adapter counterpart 302 and the second adapter counterpart 350. In some embodiments, for example, the alignment relationship-obtaining displacement includes vertical displacement, horizontal displacement, displacement about a longitudinal axis, rotation about the longitudinal axis, displacement about a lateral axis, rotation about the lateral axis, displacement about a vertical axis, rotation about the vertical axis, or a combination thereof. The alignment relationship-obtaining displacement is effectible due to the spring assembly 522 and the spring assembly 528 of the end effector 510. In some embodiments, for example, the first surface configuration counterpart and the first adapter counterpart 302 are co-operatively configured such that guiding of the alignment relationship-obtaining displacement of the housing 512 and the first adapter counterpart 302 is effectible by co-operation between the first surface configuration counterpart and the second surface configuration counterpart defined by the guide 352.

In response to the alignment relationship-obtaining displacement of the housing 512 and the first adapter counterpart 302, the object manipulator 101 becomes disposed in the actuation-ready position, wherein the housing 512 is received between the channel walls 3542, the housing 512 is disposed in engagement with the surface 17, and the first adapter counterpart 302 and the second adapter counterpart 350 are disposed in alignment. In some embodiments, for example, the first adapter counterpart 302 and the second adapter counterpart 350 are disposed in alignment along the axis 3600. In some embodiments, for example, the axis 3600 is parallel to a linear axis, such as a vertical axis.

In some embodiments, for example, while the housing 512 is disposed in a guiding-effective relationship with the guide 352, for example, the channel 354, the alignment relationship-obtaining displacement of the housing 512 relative to the second adapter connection counterpart 350, is effectuated in response to urging by the robot arm 110.

In some embodiments, for example, while the first adapter counterpart 302 is disposed in a guiding-effective relationship with the guide 352, for example, the channel 354, the alignment relationship-obtaining displacement of the first adapter counterpart 302 relative to the second adapter connection counterpart 350, is effectuated in response to urging by the robot arm 110.

While the housing 512 is received between the channel walls 3542, in some embodiments, for example, the first adapter counterpart 302 and the second adapter counterpart 350 are aligned, and the first adapter counterpart 302 and the second adapter counterpart 350 are disposed in operable communication in response to further displacement of the first adapter counterpart 302 towards the second adapter counterpart 350 by the actuator 514.

In some embodiments, for example, the first adapter counterpart 302 and the second adapter counterpart 350 are co-operatively configured such that, in response to emplacement of the first adapter counterpart 302 and the second adapter counterpart 350 in the alignment relationship, the first adapter counterpart 302 and the second adapter counterpart 350 become connected. In some embodiments, for example, the connection, obtained in response to the emplacement of the first adapter counterpart 302 and the second adapter counterpart 350 in the alignment relationship, is obtained autonomously.

In some embodiments for example, the actuator 514, the first adapter counterpart 302, and the second adapter counterpart 350 are co-operatively configured such that, in response to emplacement of the first adapter counterpart 302 and the second adapter counterpart 350 in the alignment relationship, the actuator 514 urges connection of the first adapter counterpart 302 and the second adapter counterpart 350. In some embodiments for example, the connection is obtained autonomously.

While the first adapter counterpart 302 and the second adapter counterpart 350 are disposed alignment, in response to further displacement of the first adapter counterpart 302 towards the second adapter counterpart 350, for example, via the actuator 514, the guide pins 312 of the first adapter counterpart 302 are received into the guide ports 3120 of the second adapter counterpart 350 to guide further displacement of the first adapter counterpart 302 towards the second adapter counterpart 350. In response to further displacement of the first adapter counterpart 302 towards the second adapter counterpart 350, the electrical connectors 308 are received in the electrical ports 3080, the fluid connectors 310 are received in the fluid ports 3100, and the data connectors 314 are received in the data ports 3140, which effects: (i) electrical communication between the dock communicator-defined electrical conductor 1204 and the towing vehicle communicator-defined electrical conductor 1304, (ii) fluid communication between the one or more dock communicator-defined fluid conductors 1202 and the corresponding one of the towing vehicle communicator-defined fluid conductors 1302, and (iii) data communication between the one or more dock communicator-defined data conductors 1205 and the corresponding one of the towing vehicle communicator-defined data conductors 1305. At this point, the first adapter counterpart 350 and the second adapter counterpart 350 are connected. At this point, operable communication between the energy sources 15 and data communication devices of the dock 12 and the energy storage devices 16 and data communication devices of the towing vehicle 13, is established, via the adapter 300, such that: (i) electrical communication between the one or more electrical energy storage devices 16 of the towing vehicle 13 and the corresponding one or more electrical energy sources 15 of the dock 12, (ii) fluid communication between the one or more fluid energy storage devices 16 of the towing vehicle 13 and the corresponding one or more of the fluid energy sources 15 of the dock 12, and (iii) data communication between the data communication devices of the towing vehicle 13 and the data communication devices of the dock 12, for replenishing the energy storage devices of the towing vehicle 13.

In some embodiments, for example, while the guide pins 312 of the first adapter counterpart 302 are received into the guide ports 3120 of the second adapter counterpart 350, in response to the further vertical displacement of the first adapter counterpart 302 towards the second adapter counterpart 350, the screw 313 is received in the screw port 3130. While the screw 313 is received in the screw port 3130, the controller 102 sends a control command to an actuator of the first adapter counterpart 302 to drive rotation of the screw 313, for engaging with the screw port 3130, with effect that the connection of the first adapter counterpart 302 and the second adapter counterpart 350 is retained.

In some embodiments, for example, the emplacement of the first adapter counterpart 302 and the second adapter counterpart 350 in the alignment relationship is obtained while the fifth wheel 2 is coupled to the fifth wheel guiding counterpart 14 of the dock 12 (e.g. the kingpin), such that a fifth wheel coupling relationship is established.

At this point, the controller 102 activates the actuator 242 to uncouple the coupler 513 from the first adapter counterpart 302 and activates the actuator 514 to retract the coupler 513 into the housing 512, and the controller 102 activates the actuator assembly 106 to pivot the robot arm 110 to transition the object manipulator 101 to the actuation-ineffective position.

At this point, as noted above, while operable communication between the energy sources 15 and data communication devices of the dock 12 and the energy storage devices 16 and data communication devices of the towing vehicle 13, via the adapter 300, is established, the controller 102 or controller of the towing vehicle 13 sends a control command to the energy sources 15 and the data communication devices of the dock 12, via the one or more dock communicator-defined data conductors 1205 and the one or more towing vehicle communicator-defined data conductors 1305, to effect the transfer of one or more kinds of energy (e.g. diesel, hydrogen, natural gas, pneumatic gas, electricity) from the energy source 15 to the energy storage device 16 of the towing vehicle 13 via the adapter 300, the one or more dock communicator-defined fluid conductors 1202, the one or more towing vehicle communicator-defined fluid conductors 1302, the one or more dock communicator-defined electrical conductors 1204, and the one or more towing vehicle communicator-defined fluid conductors 1304, to replenish the energy storage devices of the towing vehicle 13.

After it is determined by the controller 102 or the controller of the towing vehicle 13, for example, that the energy storage devices 16 of the towing vehicle 13 are replenished, for example, via detection of the capacity of the energy storage devices 16, it is desirable to decouple the first adapter counterpart 302 from the second adapter counterpart 350.

To disconnect the first adapter counterpart 302 from the second adapter counterpart 350 while the towing vehicle 13 and the dock 12 are misaligned, the detector 104 detects a signal for the apparatus 100 to initiate the disconnection process. The controller 102 sends a control command to the actuator assembly 106 to pivot the robot arm 110 to transition the object manipulator 101 to the actuation-ready configuration. The channel walls 3542 and the side walls 518 are co-operatively configured to effect the alignment relationship-obtaining displacement of the housing 512 to dispose the housing 512 between the guide channel walls 3542 and engaged with the surface 17, such that the coupler 513 and the first adapter counterpart 302 are aligned. Then, the controller 102 sends a control command to the actuator 514 to displace the coupler 513 towards the first adapter counterpart 302. In response to the displacement of the coupler 513 towards the first adapter counterpart 302, the guide pins 316 of the second connector counterpart 315 are inserted into the receiving ports 234 of the first connector counterpart 232. Further displacement of the coupler 513 towards the first adapter counterpart 302 is with effect that the coupler 513 becomes coupled to the first adapter counterpart 302, via the first connector counterpart 232 of the gripper 513 and the second connector counterpart 315 of the first adapter counterpart 302 (e.g. of the bottom configuration 320), for example, via the spring-loaded latch. Then, the controller 102 sends a control command to the actuator of the first adapter counterpart 302 to rotate the screw 313, relative to the screw port 3130, to defeat the retention of the releasable coupling of the first adapter counterpart 302 and the second adapter counterpart 350. While the retention of the releasable coupling of the first adapter counterpart 302 and the second adapter counterpart 350 is defeated, the controller 102 sends a control command to the actuator 514 to displace the coupler 513 away from the second adapter counterpart 350 to displace the first adapter counterpart 302 away from the second adapter counterpart 350, with effect that the first adapter counterpart 302 and the second adapter counterpart 350 is disconnected, such that the operable communication between the first adapter counterpart 302 and the second adapter counterpart 350 is defeated, and with further effect the first adapter counterpart 302 is decoupled from the second adapter counterpart 350 and received in the housing 512. At this point, the controller 102 sends a control command to the actuator assembly 106 to pivot the robot arm 110 to transition the object manipulator 101 to the actuation-ineffective position. At this point, in some embodiments, for example, the connection between the fifth wheel coupling 2 and the kingpin 14 is defeated, such that the towing vehicle 13 is decoupled from the dock 12, and the towing vehicle 13 can be operated to displace away from the dock 12.

While the towing vehicle 13 is decoupled from the dock 12, and while the energy storage devices 16 of the towing vehicle 13 are replenished, the towing vehicle 13 can operably couple with a trailer, such as the trailer 12A as depicted in FIG. 21, to tow the trailer and actuate a vehicle operation. In some embodiments, for example, the fifth wheel 2 of the towing vehicle 13 is couplable to a fifth wheel guiding counterpart 14 of the towing vehicle 12A (e.g. the kingpin), such that a fifth wheel coupling relationship is established. In some embodiments, for example, the trailer 12A is towable by the towing vehicle 13 while the fifth wheel coupling relationship is established. The adapter counterpart 302 of the towing vehicle 13 is connectible with an adapter counterpart of the trailer 12A, which substantially corresponds to the second adapter counterpart 350, such that the adapter counterpart 302 is disposable in operable communication with the adapter counterpart of the trailer 12A. In some embodiments, for example, the adapter counterpart 302 of the towing vehicle 13 is connectible with the adapter counterpart of the trailer 12A while the fifth wheel coupling relationship is established. In some embodiments, for example, the trailer 12A includes a guide that is substantially similar to the guide 352, for aligning the adapter counterpart 302 of the towing vehicle 13 and the adapter counterpart of the trailer 12A. In some embodiments, for example, the guide of the trailer 12A is mounted to a front surface of the trailer 12A. In some embodiments, for example, the connection of the first adapter counterpart 302 and the adapter counterpart of the trailer 12A is in a manner substantially similar to the manner in which the first and second adapter counterparts 302 and 350 are connected for disposition of the first adapter counterpart 302 and the second adapter counterpart 350 in operable communication, to establish operable communication between the energy storage devices 16 and data communication devices of the towing vehicle 13 and the electrical and pneumatic systems and data communication devices of the trailer 12A (e.g. service brakes, parking brakes, ABS brakes, turn signals, etc.). While operable communication between the energy storage devices 16 and data communication devices of the towing vehicle 13 and the electrical and pneumatic systems and data communication devices of the trailer 12A is established, the controller 102 or the controller of the towing vehicle 13 can send a control command to the energy sources 16 and data communication devices of the towing vehicle 13, to supply the energy to the electrical and pneumatic systems of the trailer 12A to actuate the vehicular operation, and to control the actuation of the vehicular operation.

In some embodiments, for example, the towing vehicle 13 is configured to co-operate with the trailer 12A such that:
while: (i) the first adapter counterpart 302, for example, the towing vehicle-defined connection counterpart 302 and the adapter counterpart of the trailer 12A, for example, the trailer-defined connection counterpart, are co-operatively disposed in a misaligned relationship, wherein, in the misaligned relationship, there is an absence of alignment between the towing vehicle-defined connection counterpart and the trailer-defined connection counterpart, and (ii) the towing vehicle-defined connection counterpart is disposed in a guiding-effective relationship with the guide 352 of the trailer 12A:
an alignment relationship-obtaining displacement of the towing vehicle-defined connection counterpart, relative to the trailer-defined connection counterpart, is guidable, by the guide 352, wherein the guided displacement is effective for emplacing the towing vehicle-defined connection counterpart in alignment with the trailer-defined connection counterpart, such that the towing vehicle-defined connection counterpart and the trailer-defined connection counterpart become disposed in an alignment relationship for establishing connection between the towing vehicle-defined connection counterpart and the trailer-defined connection counterpart.

In response to the emplacement of the towing vehicle-defined connection counterpart and the trailer-defined connection counterpart in the alignment relationship, connection of the towing vehicle-defined connection counterpart and the trailer-defined connection counterpart is effectuatable by displacement of the towing vehicle-defined connection counterpart, relative to the trailer-defined connection counterpart, in a direction towards the trailer-defined connection counterpart.

In some embodiments, for example, the connection of the towing vehicle-defined connection counterpart with the trailer-defined connection counterpart effectuates connection between the energy storage device 16 of the towing vehicle 13 and the electrical and pneumatic systems and data communication devices of the trailer 12A (e.g. service brakes, parking brakes, ABS brakes, turn signals, etc.), for actuating a vehicular operation (e.g. brakes, turn signals, etc.)

The towing of the trailer 12A by the towing vehicle 13, the guiding of the alignment relationship-obtaining displacement of the towing vehicle-defined connection counterpart, relative to the trailer-defined connection counterpart, and the effectuation of an actuation of a vehicle operation, while the towing vehicle-defined connection counterpart and the trailer-defined connection counterpart are connected, are described in paragraphs to and FIGS. 32 to 50 of the as-filed US non-provisional application Ser. No. 17/724,101, the contents of which are incorporated herein by reference in its entirety.

In some embodiments, for example, while the towing vehicle 13 and the dock 12 are releasably coupled such that the towing vehicle 13 and the dock 12 are disposed in the interaction-effective configuration, and while the robot arm 100 is displaced for transitioning the object manipulator 101 from the actuation-ineffective position to the actuation-ready position for disposing the first adapter counterpart 302 and the second adapter counterpart 350 in operable communication, if there is misalignment between the towing vehicle 13 and the dock 12, such that the first adapter counterpart 302 and the second adapter counterpart 350 are misaligned, the dock 12 is configured for displacement of the second adapter counterpart 350 relative to the first adapter counterpart 302 such that the first adapter counterpart 302 becomes aligned with the second adapter counterpart 350 for disposition in operable communication.

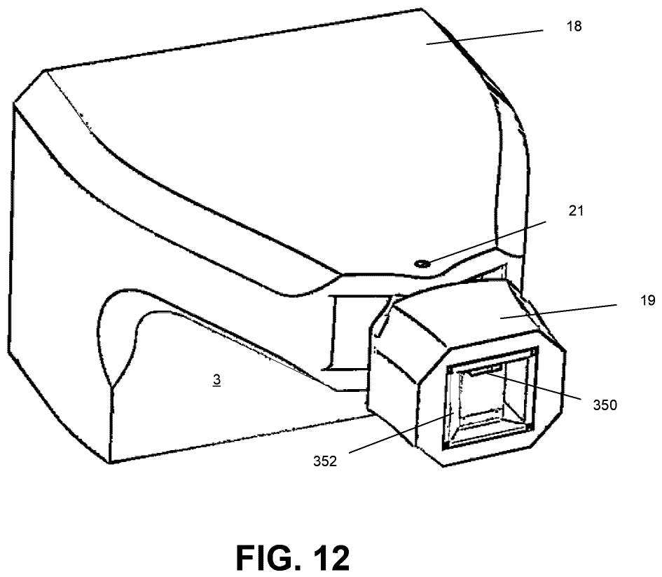

In some embodiments, as depicted in FIG. 12, the dock 12 includes a dock body 18 and a dock head 19, and the dock head 19 is coupled to the dock body 18. In some embodiments, for example, the guide 352 is coupled to the dock head 19, and the second adapter counterpart 350 is coupled to the guide 352. The coupling of the dock head 19 to the dock body 18 is with effect that the dock head 19 is displaceable, relative to the dock body 18, such that the coupling relationship between the dock head 19 and the dock body 18 is a relative movement-permissive coupling relationship. In some embodiments, for example, the dock head 19 is pivotably connected to the dock body 18 via a rotating mechanism 21. In some embodiments, for example, the rotating mechanism 21 includes a bearing for effecting the rotation of the dock head 19 relative to the dock body 18. In some embodiments, for example, the guide 352 is displaceable, relative to the dock body 18, due to the relative movement-permissive coupling relationship of the dock head 19 and dock body 18.

In some embodiments, for example, as the robot arm 110 is displaced to transition the object manipulator 101 from the actuation-ineffective positon to the actuation-ready position and the outer surface 5120 of the housing 512 becomes disposed in engagement with the inner surface 17 or to the channel walls 354 of the guide 352, the outer surface 5120 of the housing 512 applies a force to the inner surface 17 or to the channel walls 354. In response to the applied force, the dock head 19 rotates, relative to the dock body 18, due to the relative movement-permissive coupling relationship of the dock head 19 and the dock body 18, such that the coupler 513 and opening 516 becomes disposed in opposing relationship with the second adapter counterpart 350 for effecting coupling of the second adapter counterpart 350 and the first adapter counterpart 302. Accordingly, in some embodiments, for example, the relative movement-permissive coupling relationship of the dock head 19 and the dock body 18 is configured for the dock head 19 to displace relative to the dock body 18 about one degree of freedom, for example, rotation about an axis extending in a vertical direction.

In this respect, in some embodiments, for example, the towing vehicle-defined connection counterpart 302, the guide 352, the dock head 19, and the dock body 18 are co-operatively configured such that displaceability of the guide 352, relative to the towing vehicle-defined connection counterpart 302, is effectuated via the displaceability of the dock head 19, relative to the dock body 18, and while the towing vehicle-defined connection counterpart 302 is disposed in the guiding-effective relationship with the guide 352, an alignment relationship-obtaining displacement of the dock-defined connection counterpart 350, relative to the towing vehicle-defined connection counterpart 302, wherein the displacement is effective for emplacing the dock-defined connection counterpart 350 in alignment with the towing vehicle-defined connection counterpart 302, is effectuatable, in response to urging by the towing vehicle-defined connection counterpart 302 while the towing vehicle-defined connection counterpart 302 is guided for displacement via the guide 352.

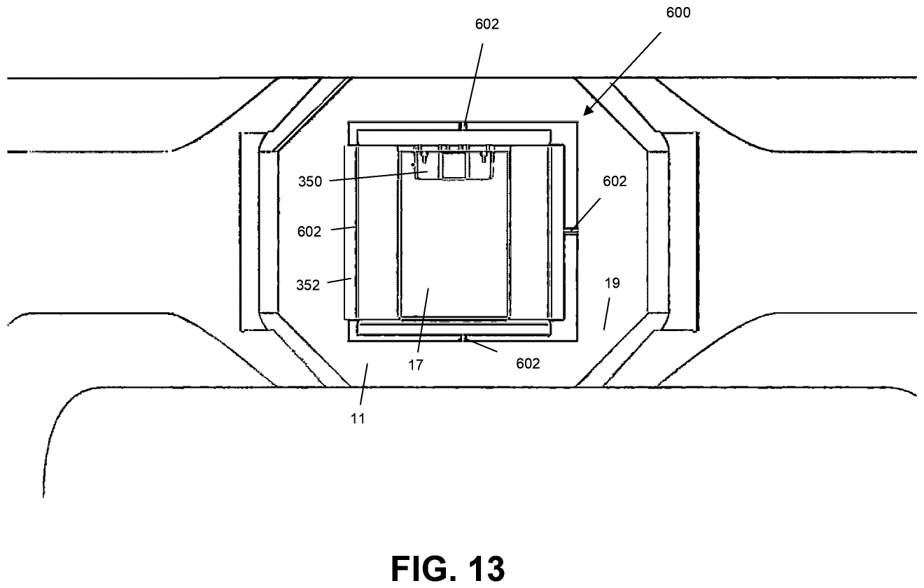

In some embodiments, for example, as depicted in FIG. 13, the dock 12 includes a spring assembly 600 comprising springs 602. The spring assembly 600 connects the guide 352 to a dock structure, for example, the surface 11 of the dock, or the dock head 19. The coupling of the guide 352 to the dock structure is with effect that the guide 352 is displaceable, relative to the dock structure, such that the coupling relationship between the guide 352 and the dock structure is a relative movement-permissive coupling relationship. In some embodiments, for example, the second adapter counterpart 350 is coupled to the guide 352, such that the second adapter counterpart 350 displaces with the guide 352. As depicted, the spring assembly 600 comprises one or more springs 602, for example, four springs 602. The spring assembly 600 biases the guide 352 to a central position. As depicted in FIG. 13, the guide 352 is urged to the left, relative to the central position. As depicted, two springs 602 are disposed in the vertical orientation, and two springs 602 are disposed in the horizontal orientation. In response to a force applied to the guide 352 in the vertical direction, for example, in response to a vertical component of the force applied by the outer surface 5120 of the housing 512 to the inner surface 17 or to the channel walls 354 as the robot arm 110 is displaced to transition the object manipulator 101 from the actuation-ineffective position into the actuation-effective position, the two springs 602 disposed in the vertical orientation allow for the guide 352 and the dock head 19 to displace relative to each other in the vertical direction, for example, upward or downward direction. In some embodiments, for example, the relative displacement is the displacement of the guide 352 relative to the dock head 19. In some embodiments, for example, the relative displacement is the displacement of the dock head 19 relative to the guide 352. In response to a force applied to the guide 352 in the horizontal direction, for example, in response to a horizontal component of the force applied by the outer surface of the housing 512 to the inner surface 17 or to the channel walls 354 as the robot arm 110 is displaced to transition the object manipulator 101 from the actuation-ineffective position into the actuation-effective position, the two springs 602 disposed in the horizontal orientation allow for the guide 352 and the dock head 19 to displace relative to each other in the horizontal direction. In some embodiments, for example, the relative displacement is the displacement of the guide 352 relative to the dock head 19. In some embodiments, for example, the relative displacement is the displacement of the dock head 19 relative to the guide 352. Accordingly, in some embodiments, for example, the spring assembly 600 allows for the guide 352 to displace relative to the dock head 19 about two degrees of freedom, for example, about a two-dimensional plane that is parallel to the surface 11 of the dock 12.

In some embodiments, for example, as the robot arm 110 is displaced to transition the object manipulator 101 from the actuation-ineffective positon to the actuation-ready position and the outer surface 5120 of the housing 512 becomes disposed in engagement with the inner surface 17 or to the channel walls 354 of the guide 352, the outer surface 5120 of the housing 512 applies a force to the inner surface 17 or to the channel walls 354. In response to applied force, the guide 352 is displaced, relative to the dock structure, due to the relative movement-permissive coupling relationship of the guide 352 and the dock structure, such that the first adapter counterpart 302, the coupler 513, and opening 516 becomes disposed in an alignment relationship with the second adapter counterpart 350 for effecting coupling of the second adapter counterpart 350 and the first adapter counterpart 302.

In some embodiments, for example, the towing vehicle-defined connection counterpart 302, the guide 352, and the dock structure are co-operatively configured such that: displaceability of the guide 352, relative to the towing vehicle-defined connection counterpart 302, is effectuated via the displaceability of the guide 352, relative to the dock structure; and while the towing vehicle-defined connection counterpart 302 is disposed in the guiding-effective relationship with the guide 352, an alignment relationship-obtaining displacement of the dock-defined connection counterpart 350, relative to the towing vehicle-defined connection counterpart 302, wherein the displacement is effective for emplacing the dock-defined connection counterpart 350 in alignment with the towing vehicle-defined connection counterpart 302, is effectuatable, in response to urging by the towing vehicle-defined connection counterpart 302 while the towing vehicle-defined connection counterpart 302 is guided for displacement via the guide 512.

In some embodiments, for example, the adapter 300 is configured to transfer energy from the dock 12 to the towing vehicle 13, for example, from the energy source 15 of the dock 12 to the energy reservoirs of the towing vehicle 13.

In some embodiments, for example, as depicted in FIG. 1, the dock 12 includes a solar panel 700 to recharge its one or more electrical energy sources 15. In some embodiments, for example, the solar panel 700 is configured to convert solar energy to electrical energy to supplement the electrical energy from the power grid.

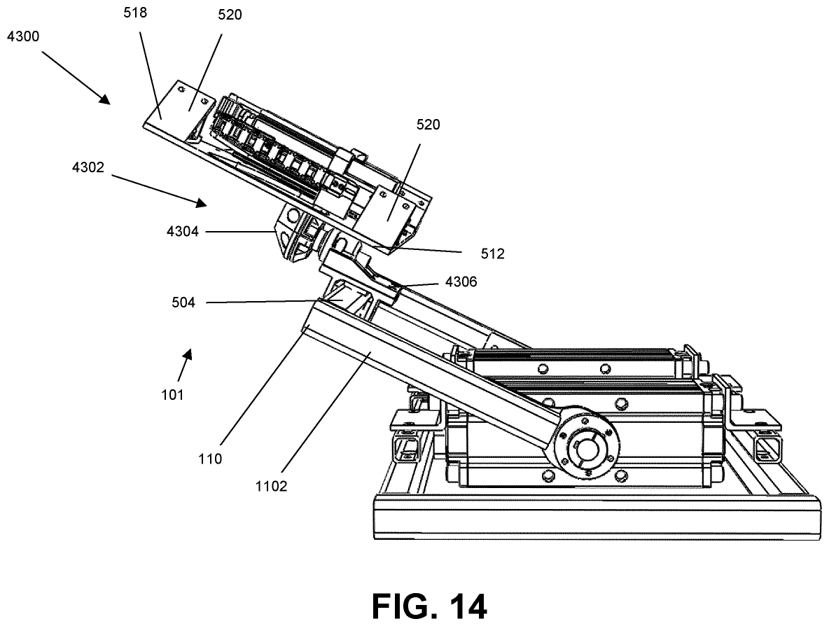

FIG. 14 to FIG. 18 depict an apparatus 4300 that is an alternate embodiment of the apparatus 500. The apparatus 4300 is similar to the apparatus 100 as described herein, except, instead of the first spring assembly 522, the second spring assembly 528, and the second plate 526, the end effector 510 includes a ball joint assembly 4302 that is slidably connected to the crossbar 504 to effect the displacement of the housing 512, for example, the displacement relative to the robot arm 110, and to effect the alignment relationship-obtaining displacement of the housing 512, relative to the second adapter counterpart 350.

As depicted, the ball joint assembly 4302 includes a ball joint 4304, a slider 4306, and a mounting bracket 4308.

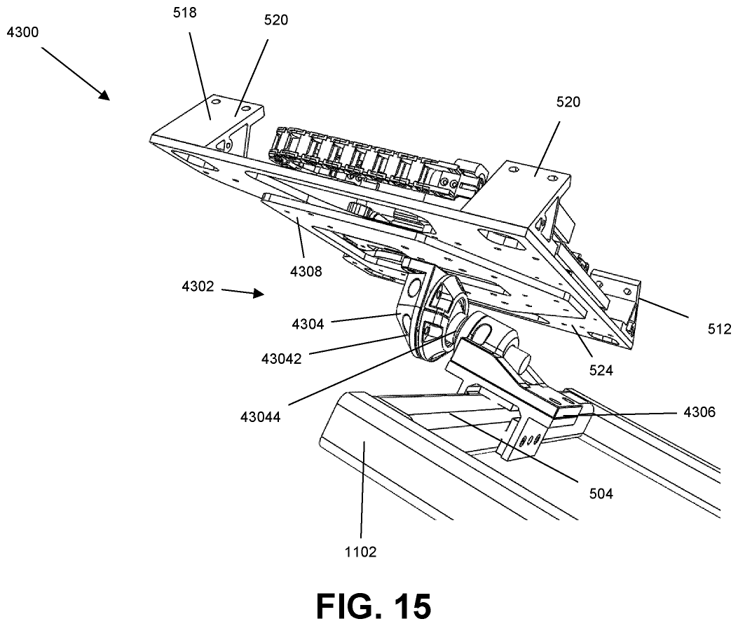

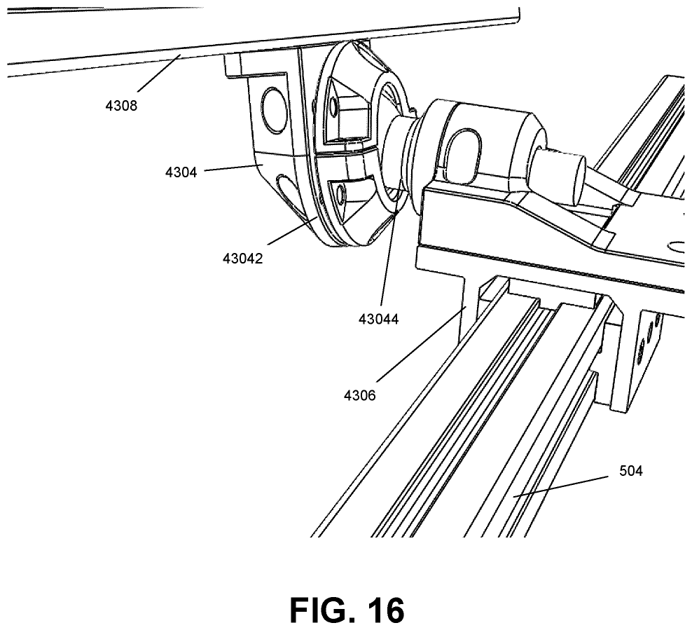

As depicted in FIG. 15 and FIG. 16, the ball joint 4304 includes a head 43042 that is pivotably connected to a base 43044. As depicted in FIG. 14 to FIG. 18, the base 43044 is further connected to the slider 4306, which is slidably connected to the crossbar 504, and the head 43042 is further connected to the mounting bracket 4308, which is connected to the housing 512, for example, to the plate 524 of the housing.

In response to a force applied to the housing 512 in the horizontal direction, the ball joint assembly 4302, for example, the slider 4306, is configured for the housing 512 and the arm segments 1102 to displace relative to each other in the horizontal direction. In some embodiments, for example, the relative displacement is the displacement of the housing 512 relative to the arm segments 1102. In some embodiments, for example, the relative displacement is sliding of the housing 512 in a direction that is parallel to the longitudinal axis of the crossbar 504. In some embodiments, for example, the relative displacement is sliding of the housing 512 along the crossbar 504. Accordingly, in some embodiments, for example, the ball joint assembly 4302 is configured for the housing 512 to displace relative to the arm segments 1102 about one degree of freedom, for example, in the horizontal direction (i.e. lateral direction).

In response to a force applied to the housing 512, the ball joint assembly 4302, for example, the mounting bracket 4308 that is connected to the housing 512 and also connected to the pivoting head 43042, is configured such that the housing 512 and the robot arm 110 are rotatable relative to each other, for example, rotate about a longitudinal axis (e.g. roll), a lateral axis (e.g. pitch), a vertical axis (e.g. yaw), or a combination thereof. In some embodiments, for example, the relative rotation is rotation of the housing 512 relative to the robot arm 110. Accordingly, in some embodiments, for example, the ball joint assembly 4302 allows for the housing 512 to rotate relative to the arm segments 1102 about three degrees of freedom. Accordingly, In some embodiments, for example, the ball joint assembly 4302 of the end effector 510 allows the housing 512, and the first adapter counterpart 302, while the first adapter counterpart 302 is releasably coupled to the actuator 514, to displace about four degrees of freedom, in particular, sliding displacement relative to the crossbar 504 along a lateral axis, and rotation about a longitudinal axis (e.g. roll), a lateral axis (e.g. pitch), and a vertical axis (e.g. yaw).

In some embodiments, for example, wherein the towing vehicle 13 and the dock 12 are coupled via fifth wheel coupling 2 and the kingpin 14, and the towing vehicle 13 and the dock 12 are aligned, and the first adapter counterpart 302 is coupled to the coupler 513, as the robot arm 110 is displaced to transition the object manipulator 101 from the actuation-ineffective positon to the actuation-ready position and the outer surface 5120 of the housing 512 becomes disposed in engagement with the inner surface 17 of the guide 352, the outer surface 5120 of the housing 512 applies a force to the inner surface 17. In response to application of the force by the outer surface 5120 of the housing 512 to the inner surface 17 of the guide 352, the inner surface 17 applies a reaction force to the housing 512. In response to said reaction force, the housing 512 and the first adapter counterpart 302 are displaced by the alignment relationship-obtaining displacement. In some embodiments, for example, said displacement includes, sliding, rotation, or a combination thereof, of the housing 512, relative to the crossbar 504, which is effectible to the coupling of the housing 512 relative to the crossbar 504 effected via the ball joint assembly 4302, such that the opening 516 and coupler 513 becomes disposed in opposing relationship with the second adapter counterpart 350, for example, for effecting alignment of the first adapter counterpart 302 and the second adapter counterpart 350 for coupling of the first adapter counterpart 302 and the second adapter counterpart 350.

In some embodiments, for example, while the towing vehicle 13 is releasably coupled to the dock 12 via fifth wheel coupling 2 and the kingpin 14, the towing vehicle 13 and the dock 12 are misaligned.

In such embodiments, for example, while the first adapter counterpart 302 is coupled to the coupler 513, in response to displacement of the object manipulator 101 towards the dock 12 from the actuation-ineffective position to the actuation-ready position, due to the misalignment of the towing vehicle 13 and the dock 12, the displacement of the object manipulator 101 towards the dock 12 is with effect that one of the side walls 518 of the housing 512 and the first adapter counterpart 302 become disposed in the guiding effective relationship with a corresponding inclined surface of one of the channel walls 3542, rather than the housing 512 being received between the channel walls 3542 of the guide 352. In response to further displacement of the object manipulator 101 towards the dock 12, the inclined surface 520 of the side wall 518 applies a force on the inclined surface of the channel wall 3542, and the inclined surface of the channel wall 3542 applies a reaction force to the inclined surface 520. Due to the inclination of the inclined surface 520 of the side wall 518 that are inclined away from the center of the housing 512, and the inclination of the inclined surface of the channel wall 3542 that are inclined towards the second adapter counterpart 350, the reaction force applied by the inclined surface of the channel wall 3542 on the inclined surface 520 has a direction towards the second adapter counterpart 350. In some embodiments, for example, the reaction force applied by the inclined surface of the channel wall 3542 on the inclined surface 520 has a direction towards the surface 17. In some embodiments, for example, the reaction force applied by the inclined surface of the channel wall 3542 on the inclined surface 520 has a direction towards the center of the guide 352. In response to the reaction force from the inclined surface of the channel wall 3542, the housing 512 and the first adapter counterpart 302 are displaced in the direction of the reaction force, for example, a direction towards the second adapter counterpart 350. In some embodiments, for example, the alignment relationship-obtaining displacement of the housing 512 includes said displacement of the housing 512, relative to the second adapter counterpart 302. In some embodiments, for example, the alignment relationship-obtaining displacement of the first adapter counterpart 302 includes said displacement of the first adapter counterpart 302, relative to the second adapter counterpart 302. In some embodiments, for example, the alignment relationship-obtaining displacement includes displacement along a lateral axis, rotation about the longitudinal axis, rotation about the lateral axis, rotation about the vertical axis, or a combination thereof. The alignment relationship-obtaining displacement is effectible due to the ball joint assembly 4302 of the end effector 510.

In response to the alignment relationship-obtaining displacement of the housing 512 and the first adapter counterpart 302, the object manipulator 101 becomes disposed in the actuation-ready position, wherein the housing 512 is received between the channel walls 3542 and disposed in alignment with the second adapter counterpart 350, and the first adapter counterpart 302 and the second adapter counterpart 350 are disposed in alignment.

In some embodiments, for example, while the housing 512 is disposed in a guiding-effective relationship with the guide 352, for example, the channel 354, the alignment relationship-obtaining displacement of the housing 512 relative to the second adapter connection counterpart 350, is effectuated in response to urging by the robot arm 110.

In some embodiments, for example, while the first adapter counterpart 302 is disposed in a guiding-effective relationship with the guide 352, for example, the channel 354, the alignment relationship-obtaining displacement of the first adapter counterpart 302 relative to the second adapter connection counterpart 350, is effectuated in response to urging by the robot arm 110.

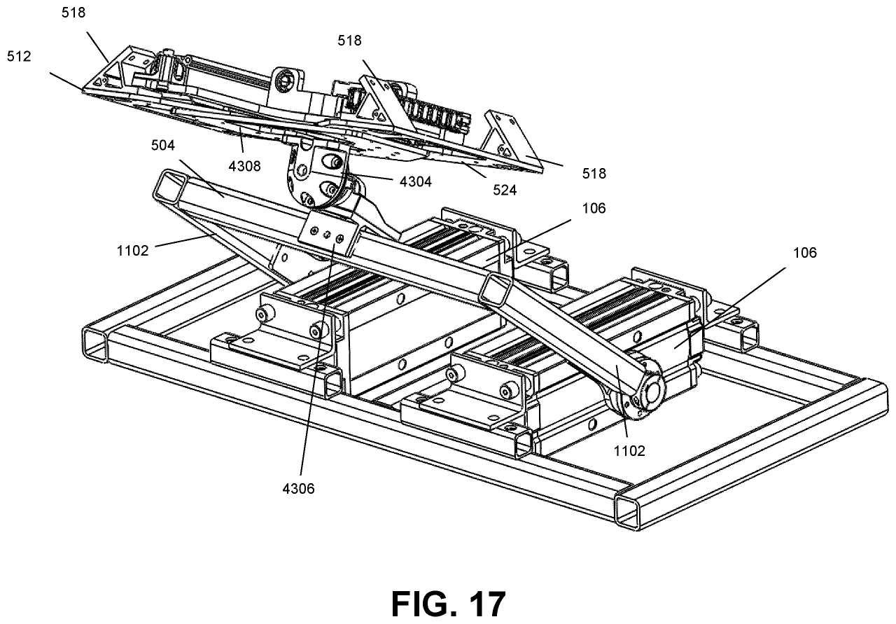

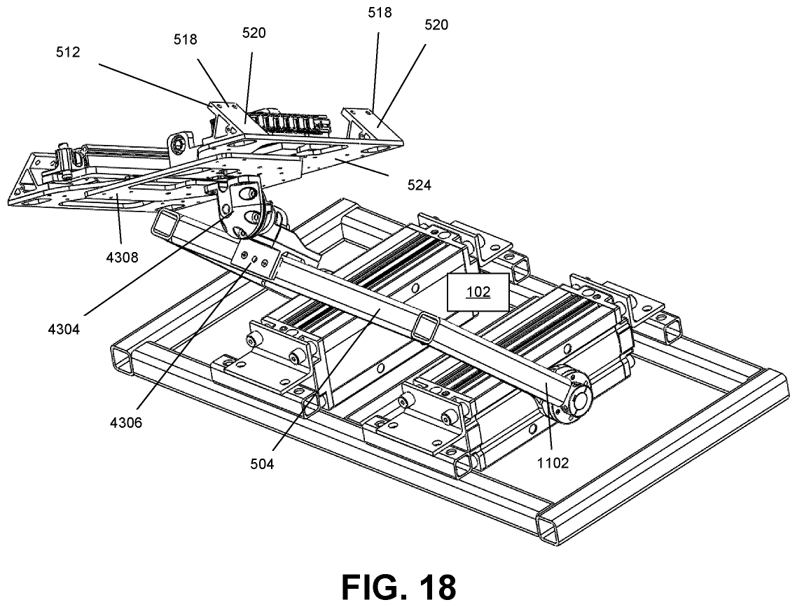

As depicted in FIG. 17, the housing 512 is pivoted to the left, relative to the crossbar 504. As depicted in FIG. 18, the housing 512 is pivoted further to the left, relative to the crossbar 504.

While the housing 512 is received between the channel walls 3542, in some embodiments, for example, the first adapter counterpart 302 and the second adapter counterpart 350 are aligned, and the first adapter counterpart 302 and the second adapter counterpart 350 are disposed in operable communication in response to further displacement of the first adapter counterpart 302 towards the second adapter counterpart 350 by the actuator 514.

In some embodiments, for example, while the towing vehicle 13 is releasably coupled to the dock 12 via fifth wheel coupling 2 and the kingpin 14, the first adapter counterpart 302 and the second adapter counterpart 350 are releasably coupled, and the towing vehicle 13 and the dock 12 are misaligned, the housing 512 and the coupler 513 are aligned relative to the first adapter counterpart 302, via the ball joint assembly 4302, in the manner as described herein, to couple the coupler 513 with the first adapter counterpart 302 for decoupling the first adapter counterpart 302 from the second adapter counterpart 350.

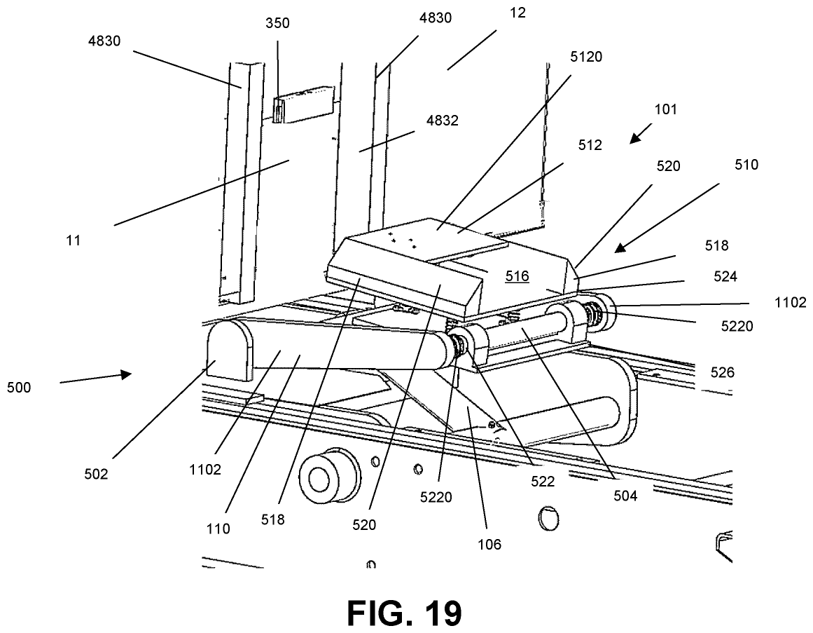

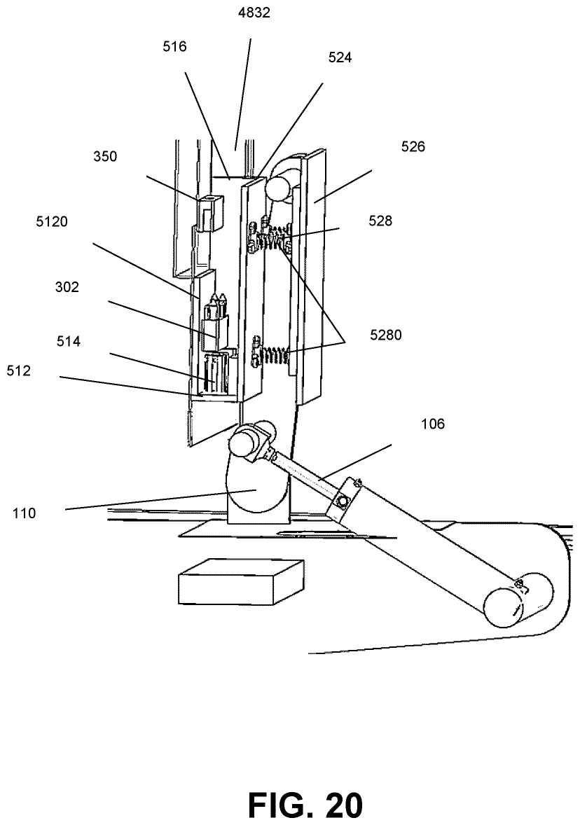

FIG. 19 and FIG. 20 depict an alternate embodiment of the guide 352, which is defined by two guide beams 4830. As depicted, the second adapter counterpart 350 is mounted to the surface 11 of the dock 12, with the electrical ports 3080, fluid ports 3100, screw port 3130 and guide ports 3120 oriented in a downward direction, and the second adapter counterpart 350 is further disposed between the two guide beams 4830 that are mounted to the surface 11 of the dock 12. As depicted, each guide beam 4830, independently, defines a surface configuration counterpart, for example, an inclined surface 4832, and the second adapter counterpart 350 is disposed between the inclined surfaces 4832. In some embodiments, for example, the inclined surface 4832 is an inclined planar surface.

Similar to the inclined surfaces 520 of the side walls 518 and the inclined surfaces of the channel walls 3542, as depicted in FIG. 19 and FIG. 20, the inclined surfaces 520 of the side walls 518 incline away from the center of the housing 512, and the inclined surfaces 4832 of the guide beams 4830 are inclined towards the second adapter counterpart 350. In some embodiments, for example, the inclined surfaces 520 of the side walls 518 and the inclined surfaces 4832 of the guide beams 4830 are co-operatively configured to align the housing 512 and the second adapter counterpart 350, for example, along a linear axis, for example, vertical axis, to effect, for example, the releasable coupling of the first adapter counterpart 302 and the second adapter counterpart 350. In some embodiments, for example, the inclined surfaces 520 of the side walls 518 and the inclined surfaces 4832 of the guide beams 4830 are co-operatively configured to align the first adapter counterpart 302 and the second adapter counterpart 350, for example, along a linear axis, for example, vertical axis, to effect the releasable coupling of the first adapter counterpart 302 and the second adapter counterpart 350. In some embodiments, for example, the inclined surfaces 520 of the side walls 518 and the inclined surfaces 4832 of the guide beams 4830 are co-operatively configured to center the coupler 513 and the second adapter counterpart 350 to effect, for example, the releasable coupling of the first adapter counterpart 302 and the second adapter counterpart 350. In some embodiments, for example, the inclined surfaces 520 of the side walls 518 and the inclined surfaces 4832 of the guide beams 4830 are co-operatively configured to center the first adapter counterpart 302 and the second adapter counterpart 350 to effect, for example, the releasable coupling of the first adapter counterpart 302 and the second adapter counterpart 350.

In some embodiments, for example, the towing vehicle 13 and the dock 12 are coupled via the fifth wheel coupling 2 and the kingpin 14 and are disposed in alignment. In such embodiments, for example, while the first adapter counterpart 302 is releasably coupled to the coupler 513, the first adapter counterpart 302 and the second adapter counterpart 350 are connectible, via the apparatus 100, for effecting disposition of the first adapter counterpart 302 and the second adapter counterpart 350 in operable communication.

To couple the first adapter counterpart 302 and the second adapter counterpart 350, the detector 104 detects a signal for the apparatus 100 to initiate the coupling process, for example, a signal provided by an operator of the towing vehicle 13, or a signal representative of the coupling of the towing vehicle 13 and the dock 12, or a signal representative of an absence of coupling between the first adapter counterpart 302 and the second adapter counterpart 350. While the object manipulator 101 is disposed in the actuation-ineffective position and releasably coupled with the first adapter counterpart 302 via the coupler 513 of the housing 512, wherein the first adapter counterpart 302 and the second adapter counterpart 350 are co-operatively disposed in the misaligned relationship, the controller 102 sends a control command to the actuator assembly 106 to pivot the robot arm 110, via the base 502, towards the dock 12, until the outer surface 5120 of the housing 512 engages the surface 11 of the dock 12 that is disposed between the guide beams 4830. The detector 104 detects that the outer surface 5120 of the housing 510 is engaged to the surface 11 disposed between the guide beams 4830. In response to detection that the outer surface 5120 is engaged to the surface 11 disposed between the guide beams 4830, the controller 102 sends a control command to the actuator assembly 106 to stop further displacement of the object manipulator 101. At this point, the object manipulator 101 is disposed in the actuation-ready position.

In some embodiments, for example, in response to disposition of the object manipulator 101 in the actuation-ready position, the housing 512 is disposed between the guide beams 4830, and the first adapter counterpart 302 is disposed below the second adapter counterpart 350. In some embodiments, for example, while the object manipulator 101 is disposed in the actuation-ready position, the first adapter counterpart 302 and the second adapter counterpart 350 are disposed in alignment for effecting releasable coupling of the first adapter counterpart 302 and the second adapter counterpart 350 for establishing connection between the first adapter counterpart 302 and the second adapter counterpart 350. In some embodiments, for example, the first adapter counterpart 302 and the second adapter counterpart 350 are disposed in alignment along the axis 3600. In some embodiments, for example, the axis 3600 is parallel to a vertical axis.

At this point, the controller 102 sends a control command to the actuator 514 to displace the coupler 513 towards the second adapter counterpart 350, for example, in an upwardly direction, with effect that the first adapter counterpart 302 is displaced towards the second adapter counterpart 350, for example, in an upwardly direction, for effecting connection of the first adapter counterpart 302 and the second adapter counterpart 350. In response to displacement of the first adapter counterpart 302 towards the second adapter counterpart 350 by the actuator 514, the guide pins 312 of the first adapter counterpart 302 are received into the guide ports 3120 of the second adapter counterpart 350 to guide the displacement of the first adapter counterpart 302 towards the second adapter counterpart 350. In response to further displacement of the first adapter counterpart 302 towards the second adapter counterpart 350, the electrical connectors 308 become disposed in the electrical ports 3080, the fluid connectors 310 become disposed in the fluid ports 3100, and the data connectors 314 become disposed in the data ports 3140, as depicted in FIG. 7 and FIG. 8, which effects: (i) electrical communication between the dock communicator-defined electrical conductor 1204 and the towing vehicle communicator-defined electrical conductor 1304, (ii) fluid communication between the dock communicator-defined fluid conductor 1202 and the towing vehicle communicator-defined fluid conductor 1302, and (iii) data communication between the one or more dock communicator-defined data conductors 1205 and the corresponding one or more towing vehicle communicator-defined data conductors 1305. At this point, the first adapter counterpart 350 and the second adapter counterpart 350 are connected. This effects establishment of: (i) electrical communication between the one or more electrical energy storage devices 16 of the towing vehicle 13 and the corresponding one or more electrical energy sources 15 of the dock 12, (ii) fluid communication between the one or more fluid energy storage devices 16 of the towing vehicle 13 and the corresponding one or more fluid energy sources 15 of the dock 12, and (iii) data communication between the data communication devices of the towing vehicle 13 and the data communication devices of the dock 12, for replenishing the energy storage devices of the towing vehicle 13.

In some embodiments, for example, while the guide pins 312 of the first adapter counterpart 302 are received into the guide ports 3120 of the second adapter counterpart 350, in response to the further displacement of the first adapter counterpart 302 towards the second adapter counterpart 350, the screw 313 is received in the screw port 3130. While the screw 313 is received in the screw port 3130, the controller 102 sends a control command to an actuator of the first adapter counterpart 302 to drive rotation of the screw 313, for engaging with the screw port 3130, with effect that the connection of the first adapter counterpart 302 and the second adapter counterpart 350 is retained.

In some embodiments, for example, the controller 102, the detector 104, the actuator assembly 106, the adapter 300, and the robot arm 110 are co-operatively configured such that, in response to the releasable coupling of the first adapter counterpart 302 and the second adapter counterpart 350, the controller 102 activates the actuator 242 to decouple from the first adapter counterpart 302, and the controller 102 activates the actuator 514 to retract the coupler 513, for example, in a downward direction, such that the coupler 513 is displaced towards the housing 512. The retraction of the coupler 513 is with effect that the coupler 513 is received in the housing 512. At this point, as depicted in FIG. 11, the controller 102 activates the actuator assembly 106 to pivot the robot arm 110, via the base 502, away from the dock 12, such that the object manipulator 101 is disposed in the actuation-ineffective position.

In some embodiments, for example, the detector 104 detects a signal representative of the releasable coupling of the first adapter counterpart 302 and the second adapter counterpart 350, and, in response to the detection, the controller 102 stops further displacement of the coupler 513 towards the second adapter counterpart 350. Then, the controller 102 activates the actuator 242 to decouple the coupler 513 from the first adapter counterpart 302, and the controller 102 activates the actuator assembly 106 to retract the coupler 513 and displace the object manipulator 101 to the actuation-ineffective position.

In some embodiments, for example, after the first adapter counterpart 302 and the second adapter counterpart 350 are connected, for example, releasably coupled, operable communication between the energy sources 15 and data communication devices of the dock 12 and the energy storage devices 16 and data communication devices of the towing vehicle 13, is established, via the adapter 300, such that energy is transferrable from the energy source to the energy storage device. While operable communication between the energy sources 15 and data communication devices of the dock 12 and the energy storage devices 16 and data communication devices of the towing vehicle 13, via the adapter 300, is established, the controller 102 or controller of the towing vehicle 13 sends a control command to the energy sources 15 and data communication devices of the dock 12, via the one or more dock communicator-defined data conductors 1205 and the one or more towing vehicle communicator-defined data conductors 1305, to effect the transfer of one or more kinds of energy (e.g. diesel, hydrogen, natural gas, pneumatic gas, electricity) from the energy source 15 to the energy storage device 16 of the towing vehicle 13 via the adapter 300, the one or more dock communicator-defined fluid conductors 1202, the one or more towing vehicle communicator-defined fluid conductors 1302, the one or more dock communicator-defined electrical conductors 1204, and the one or more towing vehicle communicator-defined fluid conductors 1304, to replenish the energy storage devices of the towing vehicle 13. In some embodiments, for example, the energy storage devices of the towing vehicle 13 are replenished while the first adapter counterpart 302 and the second adapter counterpart 350 are releasably coupled, and also while the coupler 513 is releasably coupled to the first adapter counterpart 302. In some embodiments, for example, after the first adapter counterpart 302 and the second adapter counterpart 350 are releasably coupled, the coupler 513 is retracted and the object manipulator 101 is displaced to the actuation-ineffective position, and then the energy storage devices 16 of the towing vehicle 13 are replenished.

In some embodiments, for example, the emplacement of the first adapter counterpart 302 and the second adapter counterpart 350 in the alignment relationship is obtained while the fifth wheel 15 is coupled to the fifth wheel guiding counterpart of the dock (e.g. the kingpin), such that a fifth wheel coupling relationship is established.

After it is determined by the controller 102 or the controller of the towing vehicle 13, for example, that the energy storage devices 16 of the towing vehicle 13 are replenished, for example, via detection of the capacity of the energy storage devices 16, it is desirable to decouple the first adapter counterpart 302 from the second adapter counterpart 350.

To disconnect the first adapter counterpart 302 from the second adapter counterpart 350, the detector 104 detects a signal for the apparatus 100 to initiate the decoupling process, for example, a signal provided by an operator of the towing vehicle 13, or a signal representative of the connection of the towing vehicle 13 and the dock 12, or a signal representative of the coupling between the first adapter counterpart 302 and the second adapter counterpart 350 or a signal that the one or more energy storage devices of the towing vehicle 13 are replenished. The robot arm 110 is pivoted to transition the object manipulator 101 from the actuation-ineffective position to the actuation-ready position, wherein the housing 512 is engaged with the surface 11 and the coupler 513 is aligned with the first adapter counterpart 302, which is coupled to the second adapter counterpart 350. The controller 102 sends a control command to the actuator 514 to displace the coupler 513 towards the first adapter counterpart 302, such that the guide pins 316 of the second connector counterpart 315 are inserted into the receiving ports 236 of the first connector counterpart 25. Further displacement of the coupler 513 towards the first adapter counterpart 302 is with effect that the spring-loaded latch is actuated, with effect that the coupler 503 is coupled to the first adapter counterpart 302. Then, the controller 102 sends a control command to the actuator of the first adapter counterpart 302 to rotate the screw 313, relative to the screw port 3130, to defeat the releasable coupling of the first adapter counterpart 302 and the second adapter counterpart 350. While the retention of the releasable coupling of the first adapter counterpart 302 and the second adapter counterpart 350 is defeated, the controller 102 sends a control command to the actuator 514 to displace the coupler 513 away from the second adapter counterpart 350 to displace the first adapter counterpart 302 away from the second adapter counterpart 350, with effect that the first adapter counterpart 302 and the second adapter counterpart 350 is disconnected, such that the operable communication between the first adapter counterpart 302 and the second adapter counterpart 350 is defeated, and with further effect that the first adapter counterpart 302 is received in the housing 512. At this point, the controller 102 sends a control command to the actuator assembly 106 to transition the object manipulator 101 to the actuation-ineffective position. At this point, in some embodiments, for example, the connection between the fifth wheel coupling 15 and the kingpin is defeated, such that the towing vehicle 13 is decoupled from the dock 12, and the towing vehicle 13 can be operated to displace away from the dock 12.

At this point, as noted above, while the towing vehicle 13 is decoupled from the dock 12, and while the energy storage devices of the towing vehicle 13 are replenished, the towing vehicle 13 can couple with a trailer 12A to tow the trailer 12A and actuate a vehicle operation.

In some embodiments, for example, while the towing vehicle 13 is releasably coupled to the dock 12, for example, via the fifth wheel 2 and the fifth wheel guiding counterpart 14 of the dock 12 (e.g. the kingpin), such that the fifth wheel coupling relationship is established, the towing vehicle 13 and the dock 12 are misaligned. In such embodiments, for example, while the first adapter counterpart 302 is releasably coupled to the coupler 513, the first adapter counterpart 302 and the second adapter counterpart 350 are connectible, via the apparatus 100, for effecting disposition of the first adapter counterpart 302 and the second adapter counterpart 350 in operable communication.

In such embodiments, for example, in response to displacement of the object manipulator 101 towards the dock 12 from the actuation-ineffective position to the actuation-ready position, due to the misalignment of the towing vehicle 13 and the dock 12, the displacement of the object manipulator 101 towards the dock 12 is with effect that one of the side walls 518 of the housing 512 becomes disposed proximate to, or becomes disposed in engagement with, a corresponding inclined surface 4832 of one of the guide beams 4830 instead of the housing 512 being received between the inclined surfaces 4832 of the guide beams 4830. At this point, in some embodiments, for example, the housing 512 and the first adapter counterpart 302 disposed in the guiding-effective relationship with the guide 352.

In some embodiments, for example, while the housing 512 is disposed in engagement with the guide 352, for example, one of the guide beams 4830, a surface configuration counterpart of the housing 512 is disposed in engagement with a surface configuration counterpart of the guide 352. In some embodiments, for example, the surface configuration counterpart of the housing 512 is defined by a surface of the housing 512, for example, by the inclined surfaces 520 of the side walls 518. In some embodiments, for example, the surface configuration counterpart of the guide 352 is defined by an inclined surface 4832 of a guide beam 4830.

In response to further displacement of the object manipulator 101 towards the dock 12, the inclined surface 520 of the side wall 518 applies a force on the inclined surface 4832 of the guide beam 4830, and the inclined surface 4832 of the guide beam 4830 applies a reaction force to the inclined surface 520. Due to the inclination of the inclined surface 520 of the side wall 518 that are inclined away from the center of the housing 512, and the inclination of the inclined surface 4832 of the guide beam 4830 that are inclined towards the second adapter counterpart 350, the reaction force applied by the inclined surface 4832 of the guide beam 4830 on the inclined surface 520 has a direction towards the second adapter counterpart 350. In some embodiments, for example, the reaction force applied by the inclined surface 4832 of the guide beam 4830 on the inclined surface 520 has a direction towards the surface 11 that is disposed between the guide beams 4830. In some embodiments, for example, the reaction force applied by the inclined surface 4832 of the guide beam 4830 on the inclined surface 520 has a direction towards the center of the guide 352. In response to the reaction force from the inclined surface 4832 of the guide beam 4830, the housing 512 and the first adapter counterpart 302 are displaced in the direction of the reaction force, for example, a direction towards the second adapter counterpart 350. In some embodiments, for example, the alignment relationship-obtaining displacement of the housing 512 includes said displacement of the housing 512, relative to the second adapter counterpart 350. In some embodiments, for example, the alignment relationship-obtaining displacement of the first adapter counterpart 302 includes said displacement of the first adapter counterpart 302, relative to the second adapter counterpart 350. In some embodiments, for example, the displacement is guidable, by the guide 352, for example, the guide beams 4830. In some embodiments, for example, the guided displacement is effective for emplacing the first adapter counterpart 302 in alignment with the second adapter counterpart 350, such that the first adapter counterpart 302 and the second adapter counterpart 350 become disposed in an alignment relationship for establishing connection between the first adapter counterpart 302 and the second adapter counterpart 350. In some embodiments, for example, the alignment relationship-obtaining displacement includes vertical displacement, horizontal displacement, displacement along a longitudinal axis, rotation about the longitudinal axis, displacement about a lateral axis, rotation about the lateral axis, displacement about a vertical axis, rotation about the vertical axis, or a combination thereof. The alignment relationship-obtaining displacement is effectible due to the spring assembly 522 and the spring assembly 528 of the end effector 510. In some embodiments, for example, the first surface configuration counterpart and the first adapter counterpart 302 are co-operatively configured such that guiding of the alignment relationship-obtaining displacement of the housing 512 and the first adapter counterpart 302 are effectible by co-operation between the first surface configuration counterpart and the second surface configuration counterpart defined by the guide beams 4830.

In response to the alignment relationship-obtaining displacement of the housing 512, the object manipulator 101 becomes disposed in the actuation-ready position, wherein the housing 512 is received between the guide beams 4830, the housing 512 is disposed in engagement with the surface 11, and the first adapter counterpart 302 and the second adapter counterpart 350 are disposed in alignment. In some embodiments, for example, the first adapter counterpart 302 and the second adapter counterpart 350 are disposed in alignment along the axis 3600. In some embodiments, for example, the axis 3600 is parallel to a linear axis, for example, a vertical axis.

In some embodiments, for example, while the housing 512 is disposed in a guiding-effective relationship with the guide beam 4830, the alignment relationship-obtaining displacement of the housing 512 relative to the second adapter connection counterpart 350, is effectuated in response to urging by the robot arm 110.

In some embodiments, for example, while the first adapter counterpart 302 is disposed in a guiding-effective relationship with the guide beam 4830, the alignment relationship-obtaining displacement of the first adapter counterpart 302 relative to the second adapter connection counterpart 350, is effectuated in response to urging by the robot arm 110.

While the housing 512 is received between the guide beams 4830, in some embodiments, for example, the first adapter counterpart 302 and the second adapter counterpart 350 are aligned, and the first adapter counterpart 302 and the second adapter counterpart 350 are disposed in operable communication in response to further displacement of the first adapter counterpart 302 towards the second adapter counterpart 350 by the actuator 514.

In some embodiments, for example, the first adapter counterpart 302 and the second adapter counterpart 350 are co-operatively configured such that, in response to emplacement of the first adapter counterpart 302 and the second adapter counterpart 350 in the alignment relationship, the first adapter counterpart 302 and the second adapter counterpart 350 become connected. In some embodiments, for example, the connection, obtained in response to the emplacement of the first adapter counterpart 302 and the second adapter counterpart 350 in the alignment relationship, is obtained autonomously.

In some embodiments for example, the actuator 514, the first adapter counterpart 302, and the second adapter counterpart 350 are co-operatively configured such that, in response to emplacement of the first adapter counterpart 302 and the second adapter counterpart 350 in the alignment relationship, the actuator 514 urges connection of the first adapter counterpart 302 and the second adapter counterpart 350. In some embodiments for example, the connection is obtained autonomously.

While the first adapter counterpart 302 and the second adapter counterpart 350 are disposed alignment, in response to further displacement of the first adapter counterpart 302 towards the second adapter counterpart 350, for example, via the actuator 514, the guide pins 312 of the first adapter counterpart 302 are received into the guide ports 3120 of the second adapter counterpart 350 to guide further displacement of the first adapter counterpart 302 towards the second adapter counterpart 350. In response to further displacement of the first adapter counterpart 302 towards the second adapter counterpart 350, the electrical connectors 308 are received in the electrical ports 3080, the fluid connectors 310 are received in the fluid ports 3100, and the data connectors 314 are received in the data ports 3140, which effects: (i) electrical communication between the dock communicator-defined electrical conductor 1204 and the towing vehicle communicator-defined electrical conductor 1304, (ii) fluid communication between the dock communicator-defined fluid conductor 1202 and the towing vehicle communicator-defined fluid conductor 1302, and (iii) data communication between the one or more dock communicator-defined data conductors 1205 and the corresponding one of the towing vehicle communicator-defined data conductors 1305. At this point, the first adapter counterpart 350 and the second adapter counterpart 350 are connected. At this point, operable communication between the energy sources 15 and the data communication devices of the dock 12 and the energy storage devices 16 and data communication devices of the towing vehicle 13, is established, via the adapter 300, such that: (i) electrical communication between the one or more electrical energy storage devices 16 of the towing vehicle 13 and the corresponding one or more electrical energy sources 15 of the dock 12, (ii) fluid communication between the one or more fluid energy storage devices 16 of the towing vehicle 13 and the corresponding one or more of the fluid energy sources 15 of the dock 12, and (iii) data communication between the data communication devices of the towing vehicle 13 and the data communication devices of the dock 12, for replenishing the energy storage devices of the towing vehicle 13.

In some embodiments, for example, while the guide pins 312 of the first adapter counterpart 302 are received into the guide ports 3120 of the second adapter counterpart 350, in response to the further vertical displacement of the first adapter counterpart 302 towards the second adapter counterpart 350, the screw 313 is received in the screw port 3130. While the screw 313 is received in the screw port 3130, the controller 102 sends a control command to an actuator of the first adapter counterpart 302 to drive rotation of the screw 313, for engaging with the screw port 3130, with effect that the connection of the first adapter counterpart 302 and the second adapter counterpart 350 is retained.

In some embodiments, for example, the emplacement of the first adapter counterpart 302 and the second adapter counterpart 350 in the alignment relationship is obtained while the fifth wheel 15 is coupled to the fifth wheel guiding counterpart of the dock (e.g. the kingpin), such that a fifth wheel coupling relationship is established.

At this point, the controller 102 activates the actuator 242 to decouple the coupler 513 from the first adapter counterpart 302 and activates the actuator 514 to retract the coupler 513 into the housing 512, and the controller 102 activates the actuator assembly 106 to pivot the robot arm 110 to transition the object manipulator 101 to the actuation-ineffective position.

At this point, as noted above, while operable communication between the energy sources 15 and data communication devices of the dock 12 and the energy storage devices 16 and data communication devices of the towing vehicle 13, is established, via the adapter 300, the controller 102 sends a control command to the energy sources 15 and data communication devices of the dock 12, via the one or more dock communicator-defined data conductors 1205 and the one or more towing vehicle communicator-defined data conductors 1305, to effect the transfer of one or more kinds of energy (e.g. diesel, hydrogen, natural gas, pneumatic gas, electricity) from the energy source 15 to the energy storage device 16 of the towing vehicle 13 via the adapter 300, the one or more dock communicator-defined fluid conductors 1202, the one or more towing vehicle communicator-defined fluid conductors 1302, the one or more dock communicator-defined electrical conductors 1204, and the one or more towing vehicle communicator-defined fluid conductors 1304, to replenish the energy storage devices of the towing vehicle 13.

After it is determined by the controller 102 or the controller of the towing vehicle 13, for example, that the energy storage devices 16 of the towing vehicle 13 are replenished, for example, via detection of the capacity of the energy storage devices 16, it is desirable to decouple the first adapter counterpart 302 from the second adapter counterpart 350.

To disconnect the first adapter counterpart 302 from the second adapter counterpart 350 while the towing vehicle 13 and the dock 12 are misaligned, the detector 104 detects a signal for the apparatus 100 to initiate the disconnection process. The controller 102 sends a control command to the actuator assembly 106 to pivot the robot arm 110 to transition the object manipulator 101 to the actuation-ready position. The guide beams 4830 and the side walls 518 are co-operatively configured to effect the alignment relationship-obtaining displacement of the housing 512 to dispose the housing 512 between the guide beams 4830 and engaged with the surface 11, such that the coupler 513 and the first adapter counterpart 302 (which is coupled to the second adapter counterpart 350) are aligned. Then, the controller 102 sends a control command to the actuator 514 to displace the coupler 513 towards the first adapter counterpart 302. In response to the displacement of the coupler 513 towards the first adapter counterpart 302, the guide pins 316 of the second connector counterpart 315 are inserted into the receiving ports 234 of the first connector counterpart 232. Further displacement of the coupler 513 towards the first adapter counterpart 302 is with effect that the coupler 513 becomes coupled to the first adapter counterpart 302, via the first connector counterpart 232 of the gripper 513 and the second connector counterpart 315 of the first adapter counterpart 302 (e.g. of the bottom configuration 320), for example, via the spring-loaded latch. Then, the controller 102 sends a control command to the actuator of the first adapter counterpart 302 to rotate the screw 313, relative to the screw port 3130, to defeat the retention of the releasable coupling of the first adapter counterpart 302 and the second adapter counterpart 350. While the retention of the releasable coupling of the first adapter counterpart 302 and the second adapter counterpart 350 is defeated, the controller 102 sends a control command to the actuator 514 to displace the coupler 513 away from the second adapter counterpart 350 to displace the first adapter counterpart 302 away from the second adapter counterpart 350, with effect that the first adapter counterpart 302 and the second adapter counterpart 350 is disconnected, such that the operable communication between the first adapter counterpart 302 and the second adapter counterpart 350 is defeated, and with further effect that first adapter counterpart 302 is received in the housing 512. At this point, the controller 102 sends a control command to the actuator assembly 106 to pivot the robot arm 110 to transition the object manipulator 101 to the actuation-ineffective position, outside of the swing radius 5000 of the dock 12. At this point, in some embodiments, for example, the connection between the fifth wheel coupling 15 and the kingpin 14 is defeated, such that the towing vehicle 13 is decoupled from the dock 12, and the towing vehicle 13 can be operated to displace away from the dock 12.

At this point, as noted above, while the towing vehicle 13 is decoupled from the dock 12, and while the energy storage devices of the towing vehicle 13 are replenished, the towing vehicle 13 can couple with a trailer 12A to tow the trailer 12A and actuate a vehicular operation.

In some embodiments, for example, a kit for modifying a towing vehicle 13 and a dock 12 includes towing vehicle adaptor components and dock adaptor components. The towing vehicle adaptor components includes a towing vehicle-defined connection counterpart, for example, the first adapter counterpart 302. The dock adaptor components include a dock-defined connection counterpart, for example, the second adapter counterpart 350, and a guide, for example, the guide 352.

While: (i) the towing vehicle adaptor components are installed within a towing vehicle, with effect that a modified towing vehicle is established, such that the modified towing vehicle includes the towing vehicle-defined connection counterpart, and (ii) the dock adaptor components are installed within a dock with effect that a charging dock is established, such that the charging dock includes the dock-defined connection counterpart and the guide, the towing vehicle-defined connection counterpart is connectible to the dock-defined connection counterpart, for example, as described with respect to the apparatuses disclosed herein.

In some embodiments, for example, the towing vehicle adaptor components further comprises the housing 512. In some embodiments, for example, the towing vehicle adaptor components further comprises the object manipulator 101. In some embodiments, for example, the towing vehicle adaptor components further comprises the fifth wheel. In some embodiments for example, the dock adaptor components further comprises a fifth wheel guiding counterpart.

In some embodiments, for example, a system includes the towing vehicle 13 and charging dock 12.

In some embodiments, for example, the dock 12 is included in a dock assembly 1, as depicted in FIG. 1, the dock assembly 1 including at least one dock 12. As depicted, the dock assembly 1 includes four docks 12. In some embodiments, for example, each one of the docks 12 of the dock assembly 1, independently, includes an energy source and data communication devices that are disposed in operable communication with the second adapter counterpart 350. In some embodiments, for example, the dock assembly 1 includes the energy source and data communication devices, and each one of the second adapter counterparts 350 of the one or more docks 12 of the dock assembly 1, independently, is disposed in operable communication with the energy source and data communication devices of the dock assembly 1.

In some embodiments, for example, wherein a towing vehicle includes an object manipulator 110 for coupling with a first adapter counterpart 302, and the towing vehicle 13 is coupled to a dock 12 without a second adapter counterpart 350, operable communication between the towing vehicle 13 and the dock 12 is effectible for transferring energy from the energy source 15 of the dock to the energy storage device 16 of the towing vehicle 13.

As described above, in some embodiments, for example, the towing vehicle 13 comprises a first adapter counterpart 302, an energy storage device 16, and a towing vehicle-defined communicator 120 that is disposed in communication with the energy storage device 16. The towing vehicle-defined communicator 120 is configured for connection with the first adapter counterpart 302, such that a communicating counterpart is established, with effect that communication is established between the first adapter counterpart 302 and the energy storage device 16.

The towing vehicle 13 is configured to co-operate with a counterpart-present dock 12, for example, the dock 12 as depicted in FIG. 1. The counterpart-present dock comprises a second adapter counterpart 350 and an energy source 15 that is disposed in communication with the second adapter counterpart 350. The co-operation of the towing vehicle 13 and the counterpart-present dock 12 is such that while: (i) the communicating counterpart is established, and (ii) the first adapter counterpart 302 is connected to the second adapter counterpart 350, communication between the energy storage device 16 and the energy source 15 is established for transferring energy from the energy source 15 of the dock 12 to the energy storage device 16 of the towing vehicle 13.

The towing vehicle 13 is further configured to co-operate with a counterpart-absent dock 12, wherein the second adapter counterpart 350 is absent from the counterpart-absent dock 12. The counterpart-absent dock 12 further comprises an energy source and a counterpart-absent dock-defined connector that is disposed in communication with the energy source 15. The co-operation of the towing vehicle 13 and the counterpart-absent dock 12 is such that, while there is an absence of connection between the towing vehicle-defined communicator 120 and the first adapter counterpart 302, the towing vehicle-defined communicator 120 is connectible with the counterpart-absent dock-defined connector, with effect that communication between the energy storage device 16 and the energy source 15 is established for transferring energy from the energy source 15 of the dock 12 to the energy storage device 16 of the towing vehicle 13. In some embodiments, for example, the absence of connection between the towing vehicle-defined communicator 120 and the first adapter counterpart 302 is in response to defeating of the connection between the towing vehicle-defined communicator 12 and the first adapter counterpart 302.

In some embodiments, for example, the energy storage device 16 is a fluid energy storage device, the towing vehicle-defined communicator 120 includes a towing vehicle-defined fluid conductor 1202, the counterpart-absent dock-defined connector is a fluid connector 20 (e.g. glad hand), as depicted in FIG. 4, and the energy source 15 is a fluid energy source, wherein the fluid energy source is disposed in fluid communication with the fluid connector 20. In some embodiments, for example, while there is an absence of connection between the towing vehicle-defined fluid conductor 1202 and the first adapter counterpart 302, the towing vehicle-defined fluid conductor 1202 is connectible with the fluid connector 20, with effect that fluid communication between the fluid energy storage device 16 and the fluid energy source 15 is established for transferring fluid energy from the fluid energy source 15 of the dock 12 to the fluid energy storage device 16 of the towing vehicle 13. In some embodiments, for example, the fluid energy includes pneumatic gas. In some embodiments, for example, the fluid energy includes natural gas. In some embodiments, for example, the fluid energy includes hydrogen.

In some embodiments, for example, the energy storage device 16 is a fuel storage device, the towing vehicle-defined communicator 120 includes a towing vehicle-defined fluid conductor 1202, the counterpart-absent dock-defined connector is a fuel connector 21, as depicted in FIG. 4, and the energy source 15 is a fuel source, wherein the fuel source is disposed in fluid communication with the fuel connector 21. In some embodiments, for example, while there is an absence of connection between the towing vehicle-defined fluid conductor 1202 and the first adapter counterpart 302, the towing vehicle-defined fluid conductor 1202 is connectible with the fuel connector 21, with effect that fluid communication between the fuel storage device 16 and the fuel source 15 is established for transferring fuel from the fuel energy source 15 of the dock 12 to the fuel storage device 16 of the towing vehicle 13. In some embodiments, for example, the fuel includes diesel.

In some embodiments, for example, the energy storage device 16 is an electrical energy storage device, the towing vehicle-defined communicator 120 includes a towing vehicle-defined electrical conductor 1204, the counterpart-absent dock-defined connector is an electrical connector 30 (e.g. a 7-pin connector), as depicted in FIG. 4, and the energy source 15 is electrical energy source 15, wherein the electrical energy source 15 is disposed in electrical communication with the electrical connector 30. In some embodiments, for example, while there is an absence of connection between the towing vehicle-defined electrical conductor 1204 and the first adapter counterpart 302, the towing vehicle-defined electrical conductor 1204 is connectible with the electrical connector 30, with effect that electrical communication between the electrical energy storage device 16 and the electrical energy source 15 is established for transferring electrical energy from the electrical energy source 15 of the dock 12 to the electrical energy storage device 16 of the towing vehicle 13.

In some embodiments, for example, the towing vehicle 13 includes one or more data communication devices, the towing vehicle-defined communicator 120 includes a towing vehicle-defined data conductor 1205 disposed in data communication with the data communication devices, for example, via a data communication system (e.g. databus), the counterpart-absent dock-defined connector is a data connector 40 (e.g. a data port), as depicted in FIG. 4, and the dock 12 includes one or more data communication devices, wherein the data communication devices is disposed in data communication with the data connector 40. In some embodiments, for example, while there is an absence of connection between the towing vehicle-defined data conductor 1205 and the first adapter counterpart 302, the towing vehicle-defined data conductor 1205 is connectible with the data connector 40, with effect that data communication between the data communication devices of the towing vehicle 13 and the data communication devices of the dock 12 is established for controlling the transferring of energy from the energy source 15 of the dock 12 to the energy storage device 16 of the towing vehicle 13.

In some embodiments, for example, the second adapter counterpart 350 is disposed in fluid communication with a fluid connector 20 (e.g. glad hand) that is mounted to the dock 12, for example, the front wall 11 of the dock 12, via a parallel circuit. The fluid connector 20 is disposed in fluid communication with a fluid energy source of the dock 12. In some embodiments, for example, wherein the object manipulator 110 is unable to effect operable communication between the first adapter counterpart 302 and the second adapter counterpart 350, such that the fluid energy storage device 16 of the towing vehicle 13 and the fluid energy source 15 of the dock 12 do not become disposed in fluid communication, an operator can manually establish said fluid communication. In some embodiments, for example, an operator can decouple the dock communicator-defined fluid conductor 1202 from the first adapter counterpart 302 via the dock communicator-defined fluid communication counterpart 1206. Then, the operator can couple the dock communicator-defined fluid communication counterpart 1206 with the fluid connector 20, with effect that the fluid energy storage device 16 of the towing vehicle 13 and the fluid energy source 15 of the dock 12 become disposed in fluid communication.

In some embodiments, for example, the second adapter counterpart 350 is disposed in fluid communication with a fuel connector 21 that is mounted to the dock 12, for example, the front wall 11 of the dock 12, via a parallel circuit. The fuel connector 21 is disposed in fluid communication with a fuel source of the dock 12. In some embodiments, for example, wherein the object manipulator 110 is unable to effect operable communication between the first adapter counterpart 302 and the second adapter counterpart 350, such that the fuel storage device 16 of the towing vehicle 13 and the fuel source 15 of the dock 12 do not become disposed in fluid communication, an operator can manually establish said fluid communication. In some embodiments, for example, an operator can decouple the dock communicator-defined fluid conductor 1202 from the first adapter counterpart 302 via the dock communicator-defined fluid communication counterpart 1206. Then, the operator can couple the dock communicator-defined fluid communication counterpart 1206 with the fuel connector 21, with effect that the fuel storage device 16 of the towing vehicle 13 and the fuel source 15 of the dock 12 become disposed in fluid communication.

In some embodiments, for example, the second adapter counterpart 350 is disposed in electrical communication with an electrical connector 30 (e.g. 7-pin electrical connector) that is mounted to the dock 12, for example, the front wall 11 of the dock 12, via a parallel circuit. The electrical connector is disposed in electrical communication with the electrical energy source 15 of the dock 12. In some embodiments, for example, wherein the object manipulator 110 is unable to effect operable communication between the first adapter counterpart 302 and the second adapter counterpart 350, such that the electrical energy storage system of the towing vehicle 13 and the electrical energy source 16 of the dock 12 do not become disposed in electrical communication, an operator can manually establish said electrical communication. In some embodiments, for example, an operator can decouple the dock communicator-defined electrical conductor 1204 from the first adapter counterpart 302 via the dock communicator-defined electrical communication counterpart 1208. Then, the operator can couple the dock communicator-defined electrical communication counterpart 1208 with the electrical connector 30, with effect that the electrical energy storage system 16 of the towing vehicle 13 and the electrical energy source 15 of the dock 12 become disposed in electrical communication.

In some embodiments, for example, the second adapter counterpart 350 is disposed in data communication with a data connector 40 (e.g. a data port) that is mounted to the dock 12, for example, the front wall 11 of the dock 12, via a parallel circuit. The data connector 40 is disposed in data communication with the data communication devices of the dock 12. In some embodiments, for example, wherein the object manipulator 110 is unable to effect operable communication between the first adapter counterpart 302 and the second adapter counterpart 350, such that the data communication devices of the towing vehicle 13 and the data communication devices of the dock 12 do not become disposed in data communication, an operator can manually establish said data communication. In some embodiments, for example, an operator can decouple the dock communicator-defined data conductor 1205 from the first adapter counterpart 302 via the dock communicator-defined data communication counterpart 1209. Then, the operator can couple the dock communicator-defined data communication counterpart 1209 with the data connector 40, with effect that the data communication devices of the towing vehicle 13 and the data communication devices of the dock 12 become disposed in data communication.

In some embodiments, for example, the towing vehicle 13, including the object manipulator 110, is coupled to a dock 12, for example, via the fifth wheel 15 and kingpin 14, wherein the dock 12 does not have a second adapter counterpart 350 mounted thereon, but includes the fluid connector 20, fuel connector 21, electrical connector 30, and data connector 40.

In such embodiments, for example, an operator can decouple the dock communicator-defined fluid conductor 1202 from the first adapter counterpart 302 via the dock communicator-defined fluid communication counterpart 1206. Then, the operator can couple the dock communicator-defined fluid communication counterpart 1206 with the fluid connector 20, with effect that the fluid energy storage device 16 of the towing vehicle 13 and the fluid energy source 15 of the dock 12 become disposed in fluid communication. Similarly, an operator can decouple the dock communicator-defined fluid conductor 1202 from the first adapter counterpart 302 via the dock communicator-defined fluid communication counterpart 1206. Then, the operator can couple the dock communicator-defined fluid communication counterpart 1206 with the fuel connector 21, with effect that the fuel storage device 16 of the towing vehicle 13 and the fuel source 15 of the dock 12 become disposed in fluid communication. Similarly, an operator can decouple the dock communicator-defined electrical conductor 1204 from the first adapter counterpart 302 via the dock communicator-defined electrical communication counterpart 1208. Then, the operator can couple the dock communicator-defined electrical communication counterpart 1208 with the electrical connector 30, with effect that the electrical energy storage device 16 of the towing vehicle 13 and the electrical energy source 15 of the dock 12 become disposed in electrical communication. Similarly, an operator can decouple the dock communicator-defined data conductor 1205 from the first adapter counterpart 302 via the dock communicator-defined data communication counterpart 1209. Then, the operator can couple the dock communicator-defined data communication counterpart 1209 with the data connector 40, with effect that the data communication devices of the towing vehicle 13 and the data communication devices of the dock 12 become disposed in data communication.

Similarly, wherein a dock 12 includes the second adapter counterpart 350, the fluid connector 20, fuel connector 21, the electrical connector 30, and the data connector 40, and the dock 12 is coupled to a towing vehicle 13 wherein the first adapter counterpart 302 is absent from the towing vehicle 13 (e.g. the object manipulator 110 is not installed on the towing vehicle 13), the operator can: (i) operably couple the towing vehicle-defined fluid conductor 1202 with the fluid connector 20 of the dock 12, with effect that the fluid energy storage device 16 of the towing vehicle 13 and the fluid energy source 15 of the dock 12 become disposed in fluid communication, (ii) operably couple the towing vehicle-defined fluid conductor 1202 with the fuel connector 21 of the dock 12, with effect that the fuel storage device 16 of the towing vehicle 13 and the fuel source 15 of the dock 12 become disposed in fluid communication, (iii) operably couple the towing vehicle-defined electrical conductor 1204 with the electrical connector 30, with effect that the electrical energy storage device 16 of the towing vehicle 13 and the electrical energy source 15 of the dock 12 become disposed in electrical communication, and (iv) operably couple the towing vehicle-defined data conductor 1205 with the data connector 40, with effect that the data communication devices of the towing vehicle 13 and the data communication devices of the dock 12 become disposed in data communication.

In the preceding description, for purposes of explanation, numerous details are set forth in order to provide a thorough understanding of the embodiments; however the specific details are not necessarily required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

The steps and/or operations in the flowcharts and drawings described herein are for purposes of example only. There may be many variations to these steps and/or operations without departing from the teachings of the present disclosure. For instance, the steps may be performed in a differing order, or steps may be added, deleted, or modified.

The coding of software for carrying out the above-described methods described for execution by a controller (or processor) of the apparatus is within the scope of a person of ordinary skill in the art having regard to the present disclosure. Machine readable code executable by one or more processors of one or more respective devices to perform the above-described method may be stored in a machine readable medium such as the memory of the data manager. The terms “software” and “firmware” are interchangeable within the present disclosure and comprise any computer program stored in memory for execution by a processor, comprising RAM memory, ROM memory, erasable programmable ROM (EPROM) memory, electrically EPROM (EEPROM) memory, and non-volatile RAM (NVRAM) memory. The above memory types are example only, and are thus not limiting as to the types of memory usable for storage of a computer program.

All values and sub-ranges within disclosed ranges are also disclosed. Also, although the systems, devices and processes disclosed and shown herein may comprise a specific plurality of elements/components, the systems, devices and assemblies may be modified to comprise additional or fewer of such elements/components. For example, although any of the elements/components disclosed may be referenced as being singular, the embodiments disclosed herein may be modified to comprise a plurality of such elements/components. The subject matter described herein intends to cover and embrace all suitable changes in technology.

Although the present disclosure is described, at least in part, in terms of methods, a person of ordinary skill in the art will understand that the present disclosure is also directed to the various components for performing at least some of the aspects and features of the described methods, be it by way of hardware (DSPs, ASIC, or FPGAs), software or a combination thereof. Accordingly, the technical solution of the present disclosure may be embodied in a non-volatile or non-transitory machine readable medium (e.g., optical disk, flash memory, etc.) having stored thereon executable instructions tangibly stored thereon that enable a processing device (e.g., a data manager) to execute examples of the methods disclosed herein.

The term “processor” may comprise any programmable system comprising systems using micro- or nano-processors/controllers, reduced instruction set circuits (RISC), application specific integrated circuits (ASICs), logic circuits, and any other circuit or processor capable of executing the functions described herein. The term “database” may refer to either a body of data, a relational database management system (RDBMS), or to both. As used herein, a database may comprise any collection of data comprising hierarchical databases, relational databases, flat file databases, object-relational databases, object oriented databases, and any other structured collection of records or data that is stored in a computer system. The above examples are example only, and thus are not intended to limit in any way the definition and/or meaning of the terms “processor” or “database”.

The present disclosure may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1.-60. (canceled)

61. A towing vehicle, comprising:
an energy storage device;
a towing vehicle-defined connection counterpart; and
wherein:
the towing vehicle-defined connection counterpart is configured for connection to a dock-defined connection counterpart of a charging dock, the dock further comprising:
a guide; and
an energy source;
the towing vehicle is co-operable with the dock such that:
the connection of the towing vehicle-defined connection counterpart with the dock-defined connection counterpart effectuates connection between the energy source and the energy storage device, such that energy is transferrable from the energy source to the energy storage device;
while: (i) the towing vehicle-defined connection counterpart and the dock-defined connection counterpart are co-operatively disposed in a misaligned relationship, wherein, in the misaligned relationship, there is an absence of alignment between the towing vehicle-defined connection counterpart and the dock-defined connection counterpart, and (ii) the towing vehicle-defined connection counterpart is disposed in a guiding-effective relationship with the guide:
an alignment relationship-obtaining displacement of the towing vehicle-defined connection counterpart, relative to the dock-defined connection counterpart, is guidable, by the guide, wherein the guided displacement is effective for emplacing the towing vehicle-defined connection counterpart in alignment with the dock-defined connection counterpart, such that the towing vehicle-defined connection counterpart and the dock-defined connection counterpart become emplaced in an alignment relationship for establishing connection between the towing vehicle-defined connection counterpart and the dock-defined connection counterpart;
in response to the emplacement of the towing vehicle-defined connection counterpart and the dock-defined connection counterpart in the alignment relationship, connection of the towing vehicle-defined connection counterpart and the dock-defined connection counterpart is effectuatable by displacement of the towing vehicle-defined connection counterpart, relative to the dock-defined connection counterpart, in a direction towards the dock-defined connection counterpart.

62. The towing vehicle as claimed in claim 61;
further comprising:
a first surface configuration counterpart that includes an inclined surface;
wherein:
the first surface configuration counterpart and the towing vehicle-defined connection counterpart are co-operatively configured such that guiding of the alignment relationship-obtaining displacement of the towing vehicle-defined connection counterpart is effectible by co-operation between the inclined surface of the first surface configuration counterpart and an inclined surface of a second surface configuration counterpart defined by the guide of the dock.

63. The towing vehicle as claimed in claim 61;
further comprising:
an object manipulator including:
a robot arm;
an end effector coupled to the robot arm;
wherein:
the coupling of the end effector to the robot arm is with effect that the end effector is displaceable relative to the robot arm, such that the coupling relationship between the end effector and the robot arm is a relative movement-permissive coupling relationship;
wherein:
the towing vehicle-defined connection counterpart is coupled to the end effector; and
the towing vehicle-defined connection counterpart, the end effector, and the robot arm are co-operatively configured such that:
the displaceability of the towing vehicle-defined connection counterpart, relative to the robot arm, is effectuated via the displaceability of the end effector relative to the robot arm; and
while the towing vehicle-defined connection counterpart is disposed in the guiding-effective relationship with the guide, the alignment relationship-obtaining displacement of the towing vehicle-defined connection counterpart, relative to the dock-defined connection counterpart, is effectuated in response to urging by the robot arm.

64. The towing vehicle as claimed in claim 61;
wherein:
the energy source of the dock is an electrical energy source;
the energy storage device of the towing vehicle is an electrical energy storage device; and
the connection of the towing vehicle-defined connection counterpart and the dock-defined connection counterpart effectuates electrical communication between the electrical energy source of the dock and the electrical energy storage device of the towing vehicle, such that electrical energy is transferrable from the electrical energy source of the dock to the electrical energy storage device of the towing vehicle.

65. The towing vehicle as claimed in claim 61;
wherein:
the energy source of the dock is a fluid energy source;
the energy storage device of the towing vehicle is a fluid energy storage device; and
the connection of the towing vehicle-defined connection counterpart and the dock-defined connection counterpart effectuates fluid communication between the fluid energy source of the dock and the fluid energy storage device of the towing vehicle, such that fluid energy is transferrable from the fluid energy source of the dock to the fluid energy storage device of the towing vehicle.

66. The towing vehicle as claimed in claim 61;
further comprising:
a fifth wheel;
wherein:
the fifth wheel is configured for slidably receiving a fifth wheel guiding counterpart of the dock such that a fifth wheel coupling relationship is established; and
the emplacement of the towing vehicle-defined connection counterpart and the dock-defined connection counterpart in the alignment relationship is obtainable while the fifth wheel coupling relationship is established.

67. A charging dock comprising:
a guide;
a dock-defined connection counterpart; and
an energy source;
wherein:
the dock-defined connection counterpart is configured for connection to a towing vehicle-defined connection counterpart of a towing vehicle,
the towing vehicle further comprising:
an energy storage device;
the dock is co-operable with the towing vehicle such that:
the connection of the towing vehicle-defined connection counterpart with the dock-defined connection counterpart effectuates connection between the energy source and the energy storage device, such that energy is transferrable from the energy source to the energy storage device;
while: (i) the towing vehicle-defined connection counterpart and the dock-defined connection counterpart are co-operatively disposed in a misaligned relationship, wherein, in the misaligned relationship, there is an absence of alignment between the towing vehicle-defined connection counterpart and the dock-defined connection counterpart, and (ii) the towing vehicle-defined connection counterpart is disposed in a guiding-effective relationship with the guide:
an alignment relationship-obtaining displacement of the towing vehicle-defined connection counterpart, relative to the dock-defined connection counterpart, is guidable, by the guide, wherein the guided displacement is effective for emplacing the towing vehicle-defined connection counterpart in alignment with the dock-defined connection counterpart, such that the towing vehicle-defined connection counterpart and the dock-defined connection counterpart become emplaced in an alignment relationship for establishing connection between the towing vehicle-defined connection counterpart and the dock-defined connection counterpart;
in response to the emplacement of the towing vehicle-defined connection counterpart and the dock-defined connection counterpart in the alignment relationship, connection of the towing vehicle-defined connection counterpart and the dock-defined connection counterpart is effectuatable by displacement of the towing vehicle-defined connection counterpart, relative to the dock-defined connection counterpart, in a direction towards the dock-defined connection counterpart.

68. The charging dock as claimed in claim 67,
further comprising:
a dock structure, wherein:
the guide is coupled to the dock structure;
the coupling of the guide to the dock structure is with effect that the guide is displaceable, relative to the dock structure, such that the coupling relationship between the guide and the dock structure is a relative movement-permissive coupling relationship;
wherein:
the dock-defined connection counterpart is coupled to the guide; and
the towing vehicle-defined connection counterpart, the guide, and the dock structure are co-operatively configured such that:
displaceability of the guide, relative to the towing vehicle-defined connection counterpart, is effectuated via the displaceability of the guide, relative to the dock structure; and
while the towing vehicle-defined connection counterpart is disposed in the guiding-effective relationship with the guide, an alignment relationship-obtaining displacement of the dock-defined connection counterpart, relative to the towing vehicle-defined connection counterpart, wherein the displacement is effective for emplacing the dock-defined connection counterpart in alignment with the towing vehicle-defined connection counterpart, is effectuatable, in response to urging by the towing vehicle-defined connection counterpart while the towing vehicle-defined connection counterpart is guided for displacement via the guide.

69. The charging dock as claimed in claim 67;
further comprising:
a dock body; and
a dock head, wherein:
the dock head is coupled to the dock body;
the guide is coupled to the dock head;
the coupling of the dock head to the dock body is with effect that the dock head is displaceable, relative to the dock body, such that the coupling relationship between the dock head and the dock body is a relative movement-permissive coupling relationship;
wherein:
the dock-defined connection counterpart is coupled to the guide; and
the towing vehicle-defined connection counterpart, the guide, the dock head, and
the dock body are co-operatively configured such that:
displaceability of the guide, relative to the towing vehicle-defined connection counterpart, is effectuated via the displaceability of the dock head, relative to the dock body; and
while the towing vehicle-defined connection counterpart is disposed in the guiding-effective relationship with the guide, an alignment relationship-obtaining displacement of the dock-defined connection counterpart, relative to the towing vehicle-defined connection counterpart, wherein the displacement is effective for emplacing the docking vehicle-defined connection counterpart in alignment with the towing vehicle-defined connection counterpart, is effectuatable, in response to urging by the towing vehicle-defined connection counterpart while the towing vehicle-defined connection counterpart is guided for displacement via the guide.

70. The charging dock as claimed in claim 67;
wherein the guide comprises:
a first surface configuration counterpart that includes an inclined surface;
wherein:
the first surface configuration counterpart and the towing vehicle-defined connection counterpart are co-operatively configured such that guiding of the alignment relationship-obtaining displacement of the towing vehicle-defined connection counterpart is effectible by co-operation between the inclined surface of the first surface configuration counterpart and an inclined surface of a second surface configuration counterpart defined by the towing vehicle.

71. The charging dock as claimed in claim 67;
further comprising:
a fifth wheel guiding counterpart;
wherein:
the fifth wheel fifth wheel guiding counterpart is configured to be received by a fifth wheel of the towing vehicle such that a fifth wheel coupling relationship is established; and
the emplacement of the towing vehicle-defined connection counterpart and the dock-defined connection counterpart in the alignment relationship is obtainable while the fifth wheel coupling relationship is established.

72. A kit for modifying a towing vehicle and a dock, the towing vehicle comprising an energy storage device, the dock comprising an energy source, the kit comprising:
towing vehicle adaptor components including:
a towing vehicle-defined connection counterpart; and
dock adaptor components including:
a dock-defined connection counterpart; and
a guide;
wherein:
while: (i) the towing vehicle adaptor components are installed within a towing vehicle, with effect that a modified towing vehicle is established, such that the modified towing vehicle includes the towing vehicle-defined connection counterpart and (ii) the dock adaptor components are installed within a dock with effect that a charging dock is established, such that the charging dock includes the dock-defined connection counterpart, and the guide:
the towing vehicle-defined connection counterpart is connectible to the dock-defined connection counterpart; and
the modified towing vehicle and the charging dock are co-operatively configured such that:
the connection of the towing vehicle-defined connection counterpart with the dock-defined connection counterpart effectuates connection between the energy source and the energy storage device, such that energy is transferrable from the energy source to the energy storage device;
while: (i) the towing vehicle-defined connection counterpart and the dock-defined connection counterpart are co-operatively disposed in a misaligned relationship, wherein, in the misaligned relationship, there is an absence of alignment between the towing vehicle-defined connection counterpart and the dock-defined connection counterpart, and (ii) the towing vehicle-defined connection counterpart is disposed in a guiding-effective relationship with the guide:
an alignment relationship-obtaining displacement of the towing vehicle-defined connection counterpart, relative to the dock-defined connection counterpart, is guidable, by the guide, wherein the guided displacement is effective for emplacing the towing vehicle-defined connection counterpart in alignment with the dock-defined connection counterpart, such that the towing vehicle-defined connection counterpart and the dock-defined connection counterpart become emplaced in an alignment relationship for establishing connection between the towing vehicle-defined connection counterpart and the dock-defined connection counterpart;
in response to emplacement of the towing vehicle-defined connection counterpart and the dock-defined connection counterpart in the alignment relationship, connection of the towing vehicle-defined connection counterpart and the dock-defined connection counterpart is effectuatable by displacement of the towing vehicle-defined connection counterpart, relative to the dock-defined connection counterpart, in a direction towards the dock-defined connection counterpart.

73. The kit as claimed in claim 72, wherein:
the towing vehicle adaptor components further comprises a first surface configuration counterpart that includes an inclined surface, such that the modified towing vehicle includes the first surface configuration counterpart;
the guide further comprises a second surface configuration counterpart that includes an inclined surface, such that the charging dock includes the second surface configuration counterpart;
wherein the modified towing vehicle and the charging dock are co-operatively configured such that:
guiding of the alignment relationship-obtaining displacement of the towing vehicle-defined connection counterpart is effectible by co-operation between the inclined surface of the first surface configuration counterpart and the inclined surface of the second surface configuration counterpart.

74. The kit as claimed in claim 72, wherein:
the towing vehicle adaptor components further comprise:
an object manipulator including:
a robot arm;
an end effector coupled to the robot arm;
wherein:
the coupling of the end effector to the robot arm is with effect that the end effector is displaceable relative to the robot arm, such that the coupling relationship between the end effector and the robot arm is a relative movement-permissive coupling relationship;
the installation of the towing vehicle adaptor components within the towing vehicle, for establishing the modified towing vehicle, is such that the modified towing vehicle includes the object manipulator;
wherein:
the towing vehicle-defined connection counterpart is couplable to the end effector; and
the modified towing vehicle and the charging dock are co-operatively configured such that:
the displaceability of the towing vehicle-defined connection counterpart, relative to the robot arm, is effectuated via the displaceability of the end effector relative to the robot arm; and
while: (i) the towing vehicle-defined connection counterpart is coupled to the end effector, and (ii) the towing vehicle-defined connection counterpart is disposed in the guiding-effective relationship with the guide, the alignment relationship-obtaining displacement of the towing vehicle-defined connection counterpart, relative to the dock-defined connection counterpart, is effectuatable in response to urging by the robot arm.

75. The kit as claimed in claim 72;
wherein:
the energy source of the dock is an electrical energy source;
the energy storage device of the towing vehicle is an electrical energy storage device; and
the connection of the towing vehicle-defined connection counterpart and the dock-defined connection counterpart effectuates electrical communication between the electrical energy source of the dock and the electrical energy storage device of the towing vehicle, such that electrical energy is transferrable from the electrical energy source of the dock to the electrical energy storage device of the towing vehicle.

76. The kit as claimed in claim 72;
wherein:
the energy source of the dock is a fluid energy source;
the energy storage device of the towing vehicle is a fluid energy storage device; and
the connection of the towing vehicle-defined connection counterpart and the dock-defined connection counterpart effectuates fluid communication between the fluid energy source of the dock and the fluid energy storage device of the towing vehicle, such that fluid energy is transferrable from the fluid energy source of the dock to the fluid energy storage device of the towing vehicle.

77. The kit as claimed in claim 72, wherein:
the towing vehicle adapter components further comprises a fifth wheel, such that the modified towing vehicle includes the fifth wheel;
the dock adaptor components further comprises a fifth wheel guiding counterpart, such that the charging dock includes the fifth wheel guiding counterpart;
wherein the modified towing vehicle and the charging dock are co-operatively configured such that:
the fifth wheel is configured for slidably receiving the fifth wheel guiding counterpart such that a fifth wheel coupling relationship is established; and
the emplacement of the towing vehicle-defined connection counterpart and the dock-defined connection counterpart in the alignment relationship is obtainable while the fifth wheel coupling relationship is established.

78. The kit as claimed in claim 72, wherein:
the dock further comprises a dock structure;
the installation of the dock adapter components within the dock, for establishing the charging dock, is such that:
the guide is coupled to the dock structure; and
the dock-defined connection counterpart is coupled to the guide;
the coupling of the guide to the dock structure is with effect that the guide is displaceable, relative to the dock structure, such that the coupling relationship between the guide and the dock structure is a relative movement-permissive coupling relationship;
wherein:
the modified towing vehicle and the charging dock are co-operatively configured such that:
displaceability of the guide, relative to the towing vehicle-defined connection counterpart, is effectuated via the displaceability of the guide, relative to the dock structure; and
while the towing vehicle-defined connection counterpart is disposed in the guiding-effective relationship with the guide, an alignment relationship-obtaining displacement of the docking vehicle-defined connection counterpart, relative to the towing vehicle-defined connection counterpart, wherein the displacement is effective for emplacing the dock-defined connection counterpart in alignment with the towing vehicle-defined connection counterpart, is effectuatable, in response to urging by the towing vehicle-defined connection counterpart while the towing vehicle-defined connection counterpart is guided for displacement via the guide.

79. The kit as claimed in claim 72, wherein:
the dock further comprises:
a dock body; and
a dock head, wherein the dock head is coupled to the dock body;
the installation of the dock adapter components within the dock, for establishing the charging dock, is such that:
the guide is coupled to the dock head; and
the dock-defined connection counterpart is coupled to the guide;
the coupling of the dock head to the dock body is with effect that the dock head is displaceable, relative to the dock body, such that the coupling relationship between the dock head and the dock body is a relative movement-permissive coupling relationship;
wherein:
the modified towing vehicle and the charging dock are co-operatively configured such that:
displaceability of the guide, relative to the towing vehicle-defined connection counterpart, is effectuated via the displaceability of the dock head, relative to the dock body; and
while the towing vehicle-defined connection counterpart is disposed in the guiding-effective relationship with the guide, an alignment relationship-obtaining displacement of the docking vehicle-defined connection counterpart, relative to the towing vehicle-defined connection counterpart, wherein the displacement is effective for emplacing the docking vehicle-defined connection counterpart in alignment with the towing vehicle-defined connection counterpart, is effectuatable, in response to urging by the towing vehicle-defined connection counterpart while the towing vehicle-defined connection counterpart is guided for displacement via the guide.

80. A system comprising:
a towing vehicle including:
an energy storage device;
a towing vehicle-defined connection counterpart; and
a charging dock including:
an energy source;
a dock-defined connection counterpart; and
a guide;
wherein:
the towing vehicle-defined connection counterpart is connectible to the dock-defined connection counterpart; and
the towing vehicle and the dock are co-operatively configured such that:
the connection of the towing vehicle-defined connection counterpart with the dock-defined connection counterpart effectuates connection between the energy source and the energy storage device, such that energy is transferrable from the energy source to the energy storage device;
while: (i) the towing vehicle-defined connection counterpart and the dock-defined connection counterpart are co-operatively disposed in a misaligned relationship, wherein, in the misaligned relationship, there is an absence of connection between the towing vehicle-defined connection counterpart and the dock-defined connection counterpart, and (ii) the towing vehicle-defined connection counterpart is disposed in a guiding-effective relationship with the guide:
an alignment relationship-obtaining displacement of the towing vehicle-defined connection counterpart, relative to the dock-defined connection counterpart, is guidable, by the guide, wherein the guided displacement is effective for emplacing the towing vehicle-defined connection counterpart in alignment with the dock-defined connection counterpart, such that the towing vehicle-defined connection counterpart and the dock-defined connection counterpart become emplaced in an alignment relationship for establishing connection between the towing vehicle-defined connection counterpart and the dock-defined connection counterpart;
in response to emplacement of the towing vehicle-defined connection counterpart and the dock-defined connection counterpart in the alignment relationship, connection of the towing vehicle-defined connection counterpart and the dock-defined connection counterpart is effectuatable by displacement of the towing vehicle-defined connection counterpart, relative to the dock-defined connection counterpart, in a direction towards the dock-defined connection counterpart.

81. The system as claimed in claim 80, wherein:
the towing vehicle further comprises a first surface configuration counterpart that includes an inclined surface;
the guide further comprises a second surface configuration counterpart that includes an inclined surface;
wherein the towing vehicle and the dock are co-operatively configured such that:
guiding of the alignment relationship-obtaining displacement of the towing vehicle-defined connection counterpart is effectible by co-operation between the inclined surface of the first surface configuration counterpart and the inclined surface of the second surface configuration counterpart.

82. The system as claimed in claim 80, wherein:
the towing vehicle further comprises:
an object manipulator including:
a robot arm;
an end effector coupled to the robot arm;
wherein:
the coupling of the end effector to the robot arm is with effect that the end effector is displaceable relative to the robot arm, such that the coupling relationship between the end effector and the robot arm is a relative movement-permissive coupling relationship;
wherein:
the towing vehicle-defined connection counterpart is coupled to the end effector; and
the towing vehicle and the dock are co-operatively configured such that:
the displaceability of the towing vehicle-defined connection counterpart, relative to the robot arm, is effectuated via the displaceability of the end effector relative to the robot arm; and
while the towing vehicle-defined connection counterpart is disposed in the guiding-effective relationship with the guide, the alignment relationship-obtaining displacement of the towing vehicle-defined connection counterpart, relative to the dock-defined connection counterpart, is effectuatable in response to urging by the robot arm.

83. The system as claimed in claim 80;
wherein:
the energy source of the dock is an electrical energy source;
the energy storage device of the towing vehicle is an electrical energy storage device; and
the connection of the towing vehicle-defined connection counterpart and the dock-defined connection counterpart effectuates electrical communication between the electrical energy source of the dock and the electrical energy storage device of the towing vehicle, such that electrical energy is transferrable from the electrical energy source of the dock to the electrical energy storage device of the towing vehicle.

84. The system as claimed in claim 80;
wherein:
the energy source of the dock is a fluid energy source;
the energy storage device of the towing vehicle is a fluid energy storage device; and
the connection of the towing vehicle-defined connection counterpart and the dock-defined connection counterpart effectuates fluid communication between the fluid energy source of the dock and the fluid energy storage device of the towing vehicle, such that fluid energy is transferrable from the fluid energy source of the dock to the fluid energy storage device of the towing vehicle.

85. The system as claimed in claim 80, wherein:
the towing vehicle further comprises a fifth wheel;
the dock further comprises a fifth wheel guiding counterpart;
wherein the towing vehicle and the dock are co-operatively configured such that:
the fifth wheel is configured for slidably receiving the fifth wheel guiding counterpart such that a fifth wheel coupling relationship is established; and
the emplacement of the towing vehicle-defined connection counterpart and the dock-defined connection counterpart in the alignment relationship is obtainable while the fifth wheel coupling relationship is established.

86. The system as claimed in claim 80, wherein:
the dock further comprises a dock structure, wherein:
the guide is coupled to the dock structure; and
the coupling of the guide to the dock structure is with effect that the guide is displaceable, relative to the dock structure, such that the coupling relationship between the guide and the dock structure is a relative movement-permissive coupling relationship;
wherein:
the dock-defined connection counterpart is coupled to the guide;
the towing vehicle and the dock are co-operatively configured such that:
displaceability of the guide, relative to the towing vehicle-defined connection counterpart, is effectuated via the displaceability of the guide, relative to the dock structure; and
while the towing vehicle-defined connection counterpart is disposed in the guiding-effective relationship with the guide, an alignment relationship-obtaining displacement of the dock-defined connection counterpart, relative to the towing vehicle-defined connection counterpart, wherein the displacement is effective for emplacing the dock-defined connection counterpart in alignment with the towing vehicle-defined connection counterpart, is effectuatable, in response to urging by the towing vehicle-defined connection counterpart while the towing vehicle-defined connection counterpart is guided for displacement via the guide.

87. The system as claimed in claim 80, wherein:
the dock further comprises:
a dock body; and
a dock head, wherein:
the dock head is coupled to the dock body;
the guide is coupled to the dock head; and
the coupling of the dock head to the dock body is with effect that the dock head is displaceable, relative to the dock body, such that the coupling relationship between the dock head and the dock body is a relative movement-permissive coupling relationship;
wherein:
the dock-defined connection counterpart is coupled to the guide;
the towing vehicle and the dock are co-operatively configured such that:
displaceability of the guide, relative to the towing vehicle-defined connection counterpart, is effectuated via the displaceability of the dock head, relative to the dock body; and
while the towing vehicle-defined connection counterpart is disposed in the guiding-effective relationship with the guide, an alignment relationship-obtaining displacement of the dock-defined connection counterpart, relative to the towing vehicle-defined connection counterpart, wherein the displacement is effective for emplacing the docking vehicle-defined connection counterpart in alignment with the towing vehicle-defined connection counterpart, is effectuatable, in response to urging by the towing vehicle-defined connection counterpart while the towing vehicle-defined connection counterpart is guided for displacement via the guide.
